(19) United States
(12) Patent Application Publication
(10) Pub. No.: US 2025/0386336 A1
(43) Pub. Date: Dec. 18, 2025

(54) COMMUNICATION WITH DYNAMIC SUB-CHANNEL OPERATION

(71) Applicant: QUALCOMM Incorporated, San Diego, CA (US)

(72) Inventors: Jialing Li CHEN, San Diego, CA (US); Alfred ASTERJADHI, San Diego, CA (US); Eugene BAIK, Sunnyvale, CA (US); Bin TIAN, San Diego, CA (US)

(21) Appl. No.: 18/742,670

(22) Filed: Jun. 13, 2024

(51) Int. Cl. H04W 72/12; H04W 72/0446; H04W 72/0453

(52) U.S. Cl. CPC H04W 72/12; H04W 72/044

(57) ABSTRACT

This disclosure provides methods, components, devices and systems for communication with dynamic sub-channel operation (DSO). Some aspects more specifically relate to aggregated physical layer protocol data units (PPDUs) of different PPDU formats. Some aspects more specifically relate to transmission of a first PPDU of a first PPDU format on the secondary frequency band and a second PPDU of a second PPDU format on the primary frequency band in the same time resource. For example, the first PPDU format may be an ultra-high reliability (UHR) format and the second PPDU format may be a high efficiency (HE) format. In some examples, to aggregate PPDUs in the same time resource on the primary and secondary frequency bands, the data symbol boundaries of the PPDUs may be aligned in time, and accordingly the preambles of the PPDUs may be designed to achieve alignment of the data symbol boundaries.

### TECHNICAL FIELD

This disclosure relates generally to wireless communication and, more specifically, to communication with dynamic sub-channel operation.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless node. The method may include outputting first information signaling that indicates a primary frequency band, outputting second information signaling that indicates the primary frequency band, outputting one or more frames that indicate first scheduling information for a first physical layer protocol data unit (PPDU) associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band, obtaining the first PPDU via the time resource and the secondary frequency band, and obtaining the second PPDU via the time resource and the primary frequency band.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to output first information signaling that indicates a primary frequency band, output second information signaling that indicates the primary frequency band, output one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band, obtain the first PPDU via the time resource and the secondary frequency band, and obtain the second PPDU via the time resource and the primary frequency band.

Another innovative aspect of the subject matter described in this disclosure can be implemented in an apparatus for wireless communications. The apparatus may include means for outputting first information signaling that indicates a primary frequency band, means for outputting second information signaling that indicates the primary frequency band, means for outputting one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band, means for obtaining the first PPDU via the time resource and the secondary frequency band, and means for obtaining the second PPDU via the time resource and the primary frequency band.

Another innovative aspect of the subject matter described in this disclosure can be implemented in a non-transitory computer-readable medium storing code for wireless communications. The code may include instructions executable by one or more processors to output first information signaling that indicates a primary frequency band, output second information signaling that indicates the primary frequency band, output one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band, obtain the first PPDU via the time resource and the secondary frequency band, and obtain the second PPDU via the time resource and the primary frequency band.

In some examples of the method, apparatus, and non-transitory computer-readable medium described herein, the one or more frames includes a single frame that indicates the first scheduling information and the second scheduling information and one or more fields of the single frame indicates that the first PPDU may have the first PPDU format.

In some examples of the method, apparatus, and non-transitory computer-readable medium described herein, a first frame of the one or more frames may be output for transmission via the primary frequency band and the secondary frequency band, the first frame indicates the first scheduling information, and the first frame includes an indication of a first identifier associated with the second wireless node and a second frame of the one or more frames may be output for transmission via the primary frequency band and the secondary frequency band, the second frame indicates the second scheduling information, and the second frame includes an indication of a second identifier associated with the third wireless node.

In some examples of the method, apparatus, and non-transitory computer-readable medium described herein, a first frame of the one or more frames may be output for transmission via the secondary frequency band and a second time resource, the first frame indicates the first scheduling information, and the first information signaling includes an indication of the secondary frequency band and a second frame of the one or more frames may be output for transmission via the primary frequency band and the second time resource, and the second frame indicates the second scheduling information.

Another innovative aspect of the subject matter described in this disclosure can be implemented in a method for wireless communications by a wireless node. The method may include obtaining first information signaling that indicates a primary frequency band, obtaining one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second apparatus, where the first scheduling information indicates a time resource and a secondary frequency band, where the secondary frequency band does not overlap with the primary frequency band, and where the second scheduling information indicates the time resource and the primary frequency band, and outputting the first PPDU via the time resource and the secondary frequency band.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to obtain first information signaling that indicates a primary frequency band, obtain one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second apparatus, where the first scheduling information indicates a time resource and a secondary frequency band, where the secondary frequency band does not overlap with the primary frequency band, and where the second scheduling information indicates the time resource and the primary frequency band, and output the first PPDU via the time resource and the secondary frequency band.

Another innovative aspect of the subject matter described in this disclosure can be implemented in an apparatus for wireless communications. The apparatus may include means for obtaining first information signaling that indicates a primary frequency band, means for obtaining one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second apparatus, where the first scheduling information indicates a time resource and a secondary frequency band, where the secondary frequency band does not overlap with the primary frequency band, and where the second scheduling information indicates the time resource and the primary frequency band, and means for outputting the first PPDU via the time resource and the secondary frequency band.

Another innovative aspect of the subject matter described in this disclosure can be implemented in a non-transitory computer-readable medium storing code for wireless communications. The code may include instructions executable by one or more processors to obtain first information signaling that indicates a primary frequency band, obtain one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second apparatus, where the first scheduling information indicates a time resource and a secondary frequency band, where the secondary frequency band does not overlap with the primary frequency band, and where the second scheduling information indicates the time resource and the primary frequency band, and output the first PPDU via the time resource and the secondary frequency band.

In some examples of the method, apparatus, and non-transitory computer-readable medium described herein, the one or more frames includes a single frame that indicates the first scheduling information and the second scheduling information and one or more fields of the single frame indicates that the first PPDU may have the first PPDU format.

In some examples of the method, apparatus, and non-transitory computer-readable medium described herein, a first frame of the one or more frames may be obtained via the primary frequency band and the secondary frequency band, the first frame indicates the first scheduling information, and the first frame includes an indication of a first identifier associated with the apparatus and a second frame of the one or more frames may be obtained via the primary frequency band and the secondary frequency band, the second frame indicates the second scheduling information, and the second frame includes an indication of a second identifier associated with the second apparatus.

In some examples of the method, apparatus, and non-transitory computer-readable medium described herein, a first frame of the one or more frames may be obtained via the secondary frequency band and a second time resource, the first frame indicates the first scheduling information, and the first information signaling includes an indication of the secondary frequency band and a second frame of the one or more frames may be obtained via the primary frequency band and the second time resource, and the second frame indicates the second scheduling information.

Another innovative aspect of the subject matter described in this disclosure can be implemented in a method for wireless communications by a wireless node. The method may include outputting first information signaling that indicates a primary frequency band and that indicates a secondary frequency band, where the secondary frequency band is outside of the primary frequency band, outputting second information signaling that indicates the primary frequency band, outputting a first PPDU associated with a first PPDU format via a time resource and the secondary frequency band, where a first preamble of the first PPDU indicates that the first PPDU is intended for a second wireless node, and outputting a second PPDU associated with a second PPDU format via the time resource and the primary frequency band, where a second preamble of the second PPDU indicates that the second PPDU is intended for a third wireless node.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to output first information signaling that indicates a primary frequency band and that indicates a secondary frequency band, where the secondary frequency band is outside of the primary frequency band, output second information signaling that indicates the primary frequency band, output a first PPDU associated with a first PPDU format via a time resource and the secondary frequency band, where a first preamble of the first PPDU indicates that the first PPDU is intended for a second wireless node, and output a second PPDU associated with a second PPDU format via the time resource and the primary frequency band, where a second preamble of the second PPDU indicates that the second PPDU is intended for a third wireless node.

Another innovative aspect of the subject matter described in this disclosure can be implemented in an apparatus for wireless communications. The apparatus may include means for outputting first information signaling that indicates a primary frequency band and that indicates a secondary frequency band, where the secondary frequency band is outside of the primary frequency band, means for outputting second information signaling that indicates the primary frequency band, means for outputting a first PPDU associated with a first PPDU format via a time resource and the secondary frequency band, where a first preamble of the first PPDU indicates that the first PPDU is intended for a second wireless node, and means for outputting a second PPDU associated with a second PPDU format via the time resource and the primary frequency band, where a second preamble of the second PPDU indicates that the second PPDU is intended for a third wireless node.

Another innovative aspect of the subject matter described in this disclosure can be implemented in a non-transitory computer-readable medium storing code for wireless communications. The code may include instructions executable by one or more processors to output first information signaling that indicates a primary frequency band and that indicates a secondary frequency band, where the secondary frequency band is outside of the primary frequency band, output second information signaling that indicates the primary frequency band, output a first PPDU associated with a first PPDU format via a time resource and the secondary frequency band, where a first preamble of the first PPDU indicates that the first PPDU is intended for a second wireless node, and output a second PPDU associated with a second PPDU format via the time resource and the primary frequency band, where a second preamble of the second PPDU indicates that the second PPDU is intended for a third wireless node.

In some examples of the method, apparatus, and non-transitory computer-readable medium described herein, a first legacy signal length field in the first preamble indicates a same value as a second legacy signal length field in the second preamble.

In some examples of the method, apparatus, and non-transitory computer-readable medium described herein, the first information signaling includes an indication to the second wireless node to refrain from combining legacy signal length fields associated with the primary frequency band and the secondary frequency band, the first preamble includes a first legacy signal length field that indicates a first value associated with the first PPDU format, and the second preamble includes a second legacy signal length field that indicates a second value associated with the second PPDU format.

In some examples of the method, apparatus, and non-transitory computer-readable medium described herein, the first PPDU format includes an extremely high-throughput PPDU format, the second PPDU format includes a high-efficiency multi-user PPDU format, a signal field B of the second preamble may be associated with a compression mode 1, and the second preamble indicates a quantity of one or more users may be equal to one.

In some examples of the method, apparatus, and non-transitory computer-readable medium described herein, the first PPDU format includes an extremely high-throughput PPDU format, a universal signal field of the first preamble indicates that a modulation and coding scheme 0 may be applicable for a signal field of the first PPDU, the second PPDU format includes a high-efficiency multi-user PPDU format, and a signal field B of the second preamble may be associated with a compression mode.

In some examples of the method, apparatus, and non-transitory computer-readable medium described herein, the second PPDU format may be a high-efficiency single-user PPDU, the first preamble includes a signal field that spans two symbols, or, and the signal field includes a first subset of information associated with a universal signal field format associated with an extremely high throughput PPDU format.

Another innovative aspect of the subject matter described in this disclosure can be implemented in a method for wireless communications by a wireless node. The method may include obtaining first information signaling that indicates a primary frequency band and that indicates a secondary frequency band, where the secondary frequency band is outside of the primary frequency band, obtaining a first PPDU associated with a first PPDU format via a time resource and the secondary frequency band, where a first preamble of the first PPDU indicates that the first PPDU is intended for the apparatus, and obtaining at least a second preamble of a second PPDU associated with a second PPDU format via the time resource and the primary frequency band, where the second preamble indicates that the second PPDU is intended for a second apparatus.

Another innovative aspect of the subject matter described in this disclosure can be implemented in an apparatus for wireless communications. The apparatus may include a processing system that includes processor circuitry and memory circuitry that stores code. The processing system may be configured to cause the apparatus to obtain first information signaling that indicates a primary frequency band and that indicates a secondary frequency band, where the secondary frequency band is outside of the primary frequency band, obtain a first PPDU associated with a first PPDU format via a time resource and the secondary frequency band, where a first preamble of the first PPDU indicates that the first PPDU is intended for the apparatus, and obtain at least a second preamble of a second PPDU associated with a second PPDU format via the time resource and the primary frequency band, where the second preamble indicates that the second PPDU is intended for a second apparatus.

Another innovative aspect of the subject matter described in this disclosure can be implemented in an apparatus for wireless communications. The apparatus may include means for obtaining first information signaling that indicates a primary frequency band and that indicates a secondary frequency band, where the secondary frequency band is outside of the primary frequency band, means for obtaining a first PPDU associated with a first PPDU format via a time resource and the secondary frequency band, where a first preamble of the first PPDU indicates that the first PPDU is intended for the apparatus, and means for obtaining at least a second preamble of a second PPDU associated with a second PPDU format via the time resource and the primary frequency band, where the second preamble indicates that the second PPDU is intended for a second apparatus.

Another innovative aspect of the subject matter described in this disclosure can be implemented in a non-transitory computer-readable medium storing code for wireless communications. The code may include instructions executable by one or more processors to obtain first information signaling that indicates a primary frequency band and that indicates a secondary frequency band, where the secondary frequency band is outside of the primary frequency band, obtain a first PPDU associated with a first PPDU format via a time resource and the secondary frequency band, where a first preamble of the first PPDU indicates that the first PPDU is intended for the apparatus, and obtain at least a second preamble of a second PPDU associated with a second PPDU format via the time resource and the primary frequency band, where the second preamble indicates that the second PPDU is intended for a second apparatus.

In some examples of the method, apparatus, and non-transitory computer-readable medium described herein, a first legacy signal length field in the first preamble indicates a same value as a second legacy signal length field in the second preamble.

In some examples of the method, apparatus, and non-transitory computer-readable medium described herein, the first information signaling includes an indication to the second wireless node to refrain from combining legacy signal length fields associated with the primary frequency band and the secondary frequency band, the first preamble includes a first legacy signal length field that indicates a first value associated with the first PPDU format, and the second preamble includes a second legacy signal length field that indicates a second value associated with the second PPDU format.

In some examples of the method, apparatus, and non-transitory computer-readable medium described herein, the first PPDU format includes an extremely high-throughput PPDU format, the second PPDU format includes a high-efficiency multi-user PPDU format, a signal field B of the second preamble may be associated with a compression mode 1, and the second preamble indicates a quantity of one or more users may be equal to one.

In some examples of the method, apparatus, and non-transitory computer-readable medium described herein, the first PPDU format includes an extremely high-throughput PPDU format, a universal signal field of the first preamble indicates a modulation and coding scheme 0 may be applicable for a signal field of the first PPDU, the second PPDU format includes a high-efficiency multi-user PPDU format, and a signal field B of the second preamble may be associated with a compression mode.

In some examples of the method, apparatus, and non-transitory computer-readable medium described herein, the second PPDU format may be a high-efficiency single-user PPDU, the first preamble includes a signal field that spans two symbols and the signal field includes a first subset of information associated with a universal signal field format associated with an extremely high throughput PPDU format.

In some examples of the method, apparatus, and non-transitory computer-readable medium described herein, the first PPDU includes a bandwidth field in the first preamble that indicates the primary frequency band and the secondary frequency band and a resource allocation field in the first preamble indicates at least one of an assignment of a resource unit within the secondary frequency band for the first PPDU or that the primary frequency band may be punctured for the first PPDU.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of a signaling diagram that supports communication with dynamic sub-channel operation (DSO).

FIG. 6 shows an example of an aggregated uplink PPDU format that supports communication with DSO.

FIG. 7 shows examples of trigger frame formats that support communication with DSO.

FIG. 8 shows an example of an aggregated downlink PPDU format that supports communication with DSO.

FIG. 9 shows an example of an aggregated downlink PPDU format that supports communication with DSO.

FIG. 10 shows an example of an aggregated downlink PPDU format that supports communication with DSO.

FIG. 11 shows an example of a fields table that supports communication with DSO.

FIG. 12 shows an example of a fields table that supports communication with DSO.

FIG. 13 shows an example of a fields table that supports communication with DSO.

FIG. 14 shows an example of fields table that supports communication with DSO.

FIG. 15 shows an example of process flow that supports communication with DSO.

FIG. 16 shows an example of a process flow that supports communication with DSO.

FIG. 17 shows a block diagram of an example wireless communication device that supports communication with DSO.

FIG. 18 shows a block diagram of an example wireless communication device that supports communication with DSO.

FIGS. 19 through 22 show flowcharts illustrating example processes performable by or at a first wireless node that supports communication with DSO.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, an access point (AP) may support a relatively wider bandwidth than one or more stations (STAs) communicating with the AP. The AP may configure primary channel bandwidths (for example, a primary frequency band) for communication with narrower bandwidth STAs. In dynamic sub-channel operation (DSO), an AP may dynamically allocate resources to one or more STAs outside of the operating primary channel bandwidth of the STAs but within the larger AP operating bandwidth. An AP may communicate with different types of STAs (for example, high efficiency (HE) STAs, which are STAs that support HE communication (also referred to as IEEE 802.11ax) but do not support extremely high throughput (EHT) communication (also referred to as IEEE 802.11be) and ultra high reliability (UHR) STAs, which are STAs that support UHR communication (also referred to as IEEE 802.11bn)), some of which may not support communication outside of the primary channel bandwidth. For example, HE STAs may not support transmission or reception outside of the primary channel bandwidth. Further, different types of STAs may support transmission of different types of PPDUs (such as different physical layer protocol data unit (PPDU) formats).

Various aspects relate generally to aggregated PPDUs of different PPDU formats. Some aspects more specifically relate to transmission of a first PPDU of a first PPDU format on the secondary frequency band and a second PPDU of a second PPDU format on the primary frequency band in the same time resource, which may be referred to as an aggregated PPDU (APPDU). For example, the first PPDU format may be a UHR format and the second PPDU format may be an HE format. In some examples, to aggregate PPDUs in the same time resource on the primary and secondary frequency bands, per symbol boundary alignment may be designed for the aggregated PPDUs. Scheduling information for the first PPDU may be transparent to STAs that do not support the first PPDU type (the first PPDU format) in order to enable such legacy STAs to participate in DSO.

In uplink communication, one or more trigger frames may indicate the first scheduling information for the first PPDU of the first PPDU format to be transmitted in the secondary frequency band and the second scheduling information for the second PPDU of the second PPDU format to be transmitted in the primary frequency band. In some examples, a single trigger frame (such as a multi-generation trigger frame) may include the first scheduling information and the second scheduling information, and the single trigger frame may include a set of bits that indicate to the STA of the first STA type that the scheduling information is for a PPDU of the first PPDU format. For example, the set of bits may be in fields that are ignored by STAs of the second type of STA (for example, legacy STAs may not interpret such fields). In some examples, respective trigger frames scheduling the first PPDU of the first PPDU format and the second PPDU of the second PPDU format may be aggregated across both the primary frequency band and the secondary frequency band. In some examples, a first trigger frame scheduling the first PPDU of the first PPDU format may be transmitted in the secondary frequency band, and a second trigger frame scheduling the second PPDU of the second PPDU format may be transmitted in the primary frequency band. In such examples, DSO signaling may indicate for STAs of the first type of STA to monitor the secondary frequency band for trigger frames scheduling uplink PPDUs in the secondary frequency band.

In downlink DSO communication, DSO signaling may indicate for STAs of the first type of STA to monitor the secondary frequency band. The AP may transmit a first PPDU of the first PPDU format to the first STA of the first STA type via the secondary frequency band and a second PPDU of the second PPDU format to a second STA of the second STA type via the primary frequency band, where the first PPDU and the second PPDU format are aggregated in time. The preamble of the first PPDU format may be defined such that the data symbol boundaries of the first PPDU are the same as those in the second PPDU, for example, to maintain symbol-level orthogonality between the PPDUs. For example, reception parameters typically carried in the universal signal field and subsequent signal fields may be condensed by removing and/or redefining one or more parameter fields, in order to contain the necessary signaling in a newly defined 2-symbol universal signal field that would match the 2-symbol length of the HE-SIGA field in an HE SU PPDU. In such a scenario, some parameters not signaled in the condensed universal signal field may instead be communicated to the intended receiver via DSO setup or control signaling prior to the PPDU. Further, DSO signaling also may indicate to the STAs of the first STA type how to interpret legacy signal length fields to identify proper deferral information and identify corresponding sub-PPDUs.

Particular aspects of the subject matter described in this disclosure can be implemented to realize one or more of the following potential advantages. In some examples, by making the scheduling information for the first PPDU transparent to STAs that do not support the first PPDU type, the described techniques can be used to enable such STAs to participate in DSO. Accordingly, STAs of different generations may be multiplexed in the same time resource, thereby increasing network efficiency by utilizing otherwise unused frequency resources and enabling legacy STAs to be multiplexed with newer generation STAs. In downlink communication, DSO signaling may indicate to a STA capable of communication in a secondary frequency band information that would otherwise be included in a downlink PPDU preamble, thereby enabling per symbol alignment of the sub-PPDUs including the data fields of the different downlink PPDU formats and thus enabling multiplexing of downlink PPDUs of different PPDU formats.

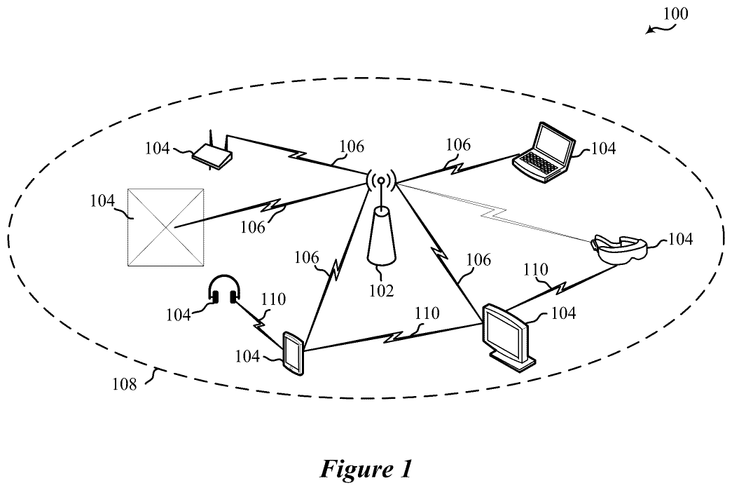

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit.

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting UHR communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in overlapping BSSs (OBSSs). The transmitting device (such as an AP 102 or a STA 104) may puncture the subchannels on which there is interference and in essence spread the data of the PPDU to cover the remaining portion of the bandwidth of the channel. For example, if a transmitting device determines (for example, detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHZ, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

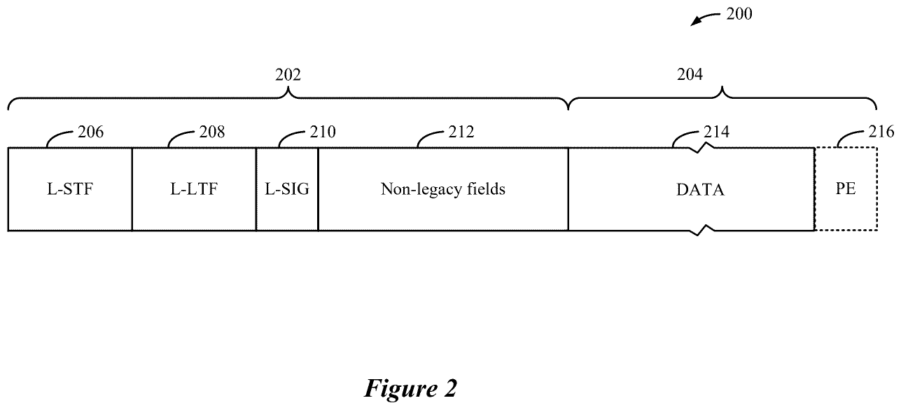

FIG. 2 shows an example physical layer protocol data unit (PPDU) 200 usable for wireless communication between a wireless AP and one or more wireless STAs. For example, the AP and STAs may be examples of the AP 102 and the STAs 104 described with reference to FIG. 1. The PPDU 200 can be configured as a PPDU. As shown, the PPDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PPDU and to use the determined duration to avoid transmitting on top of the PPDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU). In some examples, for example, for HE and later PHY generations, the PHY payload 204 of the PPDU 200 may include a packet extension (PE) 216.

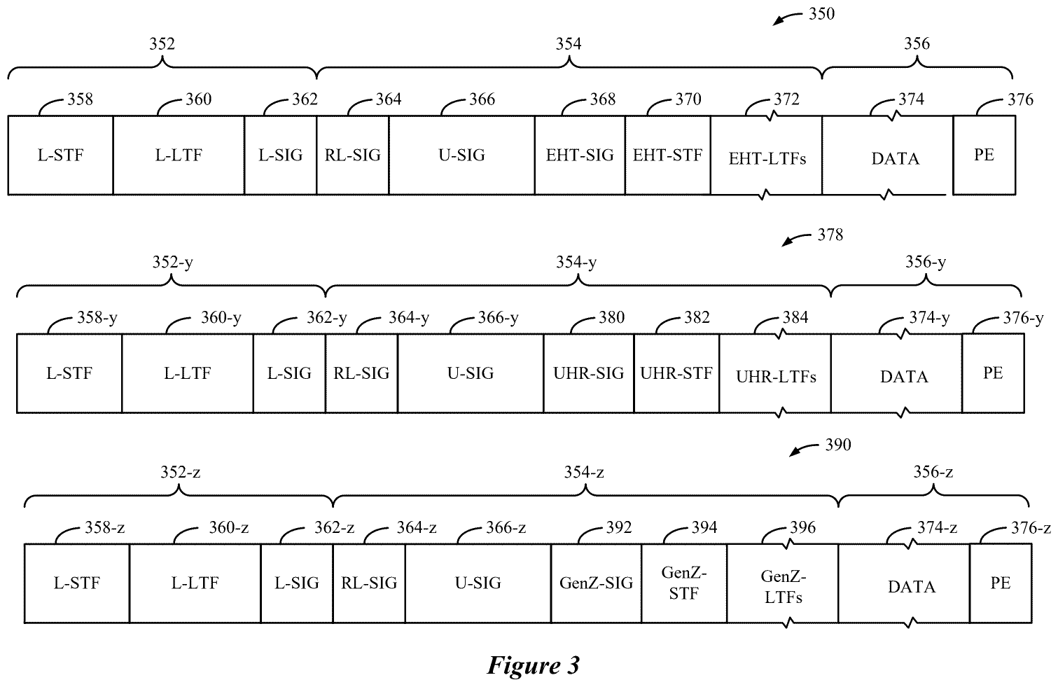

FIG. 3 shows an example PPDU 350 usable for communications between a wireless AP and one or more wireless STAs. For example, the PPDU 350 may be an example of a an EHT PPDU. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. In some examples, the payload 356 may include a PE 376. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and the Length field in L-SIG and RL-SIG being a multiple of 3 and the presence of U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. The U-SIG 366 may be structured as, and carry version-independent information and version-dependent information for, other wireless communication protocol versions associated with amendments to the IEEE family of standards beyond EHT. For example, one of the version-independent fields, the PHY Version Identifier subfield in U-SIG, may be set to a value of 0 to indicate EHT (i.e., IEEE 802.11be), and the version-dependent fields in U-SIG may be interpreted according to the U-SIG field format defined in the 802.11be amendment to the IEEE 802.11 wireless communication protocol standards. The combination of one or more subfields in U-SIG, for example, the UL/DL subfield and the PPDU Type And Compression Mode subfield, may be set to certain values to indicate the presence or absence of the EHT-SIG field. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (for example, STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

FIG. 3 also shows an example of a PPDU 378 which may be an example of a UHR PPDU. The PPDU 378 may be usable for communications between a wireless AP and one or more wireless STAs. As shown, the PPDU 378 includes a PHY preamble, that includes a legacy portion 352-y and a non-legacy portion 354-y, and a payload 356-y that includes a data field 374. In some examples, the payload 356-y may include a PE 376-y. The legacy portion 352-y of the preamble includes an L-STF 358-y, an L-LTF 360-y, and an L-SIG 362-y. The non-legacy portion 354-y of the preamble includes an RL-SIG 364-y and multiple wireless communication protocol version-dependent signal fields after RL-SIG 364-y. For example, the non-legacy portion 354-y may include a U-SIG 366-y and a UHR signal field 380 (referred to herein as “UHR-SIG 380”). The presence of RL-SIG 364-y and the Length field in L-SIG and RL-SIG being a multiple of 3 and the presence of U-SIG 366-y may indicate to UHR- or later version-compliant STAs 104 that the PPDU 378 is a UHR PPDU or a PPDU conforming to any later (post-UHR) version of a new wireless communication protocol conforming to a future IEEE 802.11 wireless communication protocol standard. The U-SIG 366-y may be structured as, and carry version-independent information and version-dependent information for, other wireless communication protocol versions associated with amendments to the IEEE family of standards beyond EHT. For example, one of the version-independent fields, the PHY Version Identifier subfield in U-SIG, may be set to a value of 1 to indicate UHR (i.e., IEEE 802.11bn), and the version-dependent fields in U-SIG may be interpreted according to the U-SIG field format defined in the 802.11bn amendment to the IEEE 802.11 wireless communication protocol standards. The combination of one or more subfields in U-SIG, for example, the UL/DL subfield and the PPDU Type And Compression Mode subfield, may be set to certain values to indicate the presence or absence of the UHR-SIG field. One or both of U-SIG 366 and UHR-SIG 380 may be structured as, and carry version-dependent information for, other wireless communication protocol versions associated with amendments to the IEEE family of standards beyond EHT. For example, U-SIG 366-y may be used by a receiving device (such as an AP 102 or a STA 104) to interpret bits in one or more of UHR-SIG 380 or the data field 374-y. Like L-STF 358-y, L-LTF 360-y, and L-SIG 362-y, the information in U-SIG 366-y and UHR-SIG 380 may be duplicated and transmitted in each of the component 20 MHz channels in instances involving the use of a bonded channel.

The non-legacy portion 354-y further includes an additional short training field 382 (referred to herein as “UHR-STF 382,” although it may be structured as, and carry version-dependent information for, other wireless communication protocol versions beyond EHT) and one or more additional long training fields 384 (referred to herein as “UHR-LTFs 384,” although they may be structured as, and carry version-dependent information for, other wireless communication protocol versions beyond UHR). UHR-STF 382 may be used for timing and frequency tracking and AGC, and UHR-LTF 384 may be used for more refined channel estimation.

UHR-SIG 380 may be used by an AP 102 to identify and inform one or multiple STAs 104 that the AP 102 has scheduled UL or DL resources for them. UHR-SIG 380 may be decoded by each compatible STA 104 served by the AP 102. UHR-SIG 380 may generally be used by the receiving device to interpret bits in the data field 374-y. For example, UHR-SIG 380 may include RU allocation information, spatial stream configuration information, and per-user (for example, STA-specific) signaling information. Each UHR-SIG 380 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374-y.

FIG. 3 also shows an example of a PPDU 390 which may be an example of a future generation PPDU (post-UHR) version of a new wireless communication protocol conforming to a future IEEE 802.11 wireless communication protocol standard, which may be referred to as GenZ. The PPDU 390 may be usable for communications between a wireless AP and one or more wireless STAs. As shown, the PPDU 390 includes a PHY preamble, that includes a legacy portion 352-z and a non-legacy portion 354-z, and a payload 356-z that includes a data field 374. In some examples, the payload 356-z may include a PE 376-z. The legacy portion 352-z of the preamble includes an L-STF 358-z, an L-LTF 360-z, and an L-SIG 362-z. The non-legacy portion 354-z of the preamble includes an RL-SIG 364-z and multiple wireless communication protocol version-dependent signal fields after RL-SIG 364-z. For example, the non-legacy portion 354-z may include a U-SIG 366-z and a GenZ signal field 392 (referred to herein as “GenZ-SIG 392”). The presence of RL-SIG 364-z and the Length field in L-SIG and RL-SIG being a multiple of 3 and the presence of U-SIG 366-z may indicate to GenZ or later version-compliant STAs 104 that the PPDU 390 is a GenZ PPDU or a PPDU conforming to any later (post-GenZ) version of a new wireless communication protocol conforming to a future IEEE 802.11 wireless communication protocol standard. The U-SIG 366-z may be structured as, and carry version-independent information and version-dependent information for, other wireless communication protocol versions associated with amendments to the IEEE family of standards beyond EHT. For example, one of the version-independent fields, the PHY Version Identifier subfield in U-SIG, may be set to a specific value (which is neither 0 or 1) to indicate GenZ, and the version-dependent fields in U-SIG may be interpreted according to the U-SIG field format defined in the GenZ amendment to the IEEE 802.11 wireless communication protocol standards. The combination of one or more subfields in U-SIG, for example, the UL/DL subfield and the PPDU Type And Compression Mode subfield, may be set to certain values to indicate the presence or absence of the GenZ-SIG field. One or both of U-SIG 366 and GenZ-SIG 392 may be structured as, and carry version-dependent information for, other wireless communication protocol versions associated with amendments to the IEEE family of standards beyond EHT. For example, U-SIG 366-z may be used by a receiving device (such as an AP 102 or a STA 104) to interpret bits in one or more of GenZ-SIG 392 or the data field 374-z. Like L-STF 358-z, L-LTF 360-z, and L-SIG 362-z, the information in U-SIG 366-z and GenZ-SIG 392 may be duplicated and transmitted in each of the component 20 MHz channels in instances involving the use of a bonded channel.

The non-legacy portion 354-z further includes an additional short training field 394 (referred to herein as “GenZ-STF 394,” although it may be structured as, and carry version-dependent information for, other wireless communication protocol versions beyond EHT) and one or more additional long training fields 396 (referred to herein as “GenZ-LTFs 396,” although they may be structured as, and carry version-dependent information for, other wireless communication protocol versions beyond GenZ). GenZ-STF 394 may be used for timing and frequency tracking and AGC, and GenZ-LTF 396 may be used for more refined channel estimation.

GenZ-SIG 392 may be used by an AP 102 to identify and inform one or multiple STAs 104 that the AP 102 has scheduled UL or DL resources for them. GenZ-SIG 392 may be decoded by each compatible STA 104 served by the AP 102. GenZ-SIG 392 may generally be used by the receiving device to interpret bits in the data field 374-z. For example, GenZ-SIG 392 may include RU allocation information, spatial stream configuration information, and per-user (for example, STA-specific) signaling information. Each GenZ-SIG 392 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374-z.

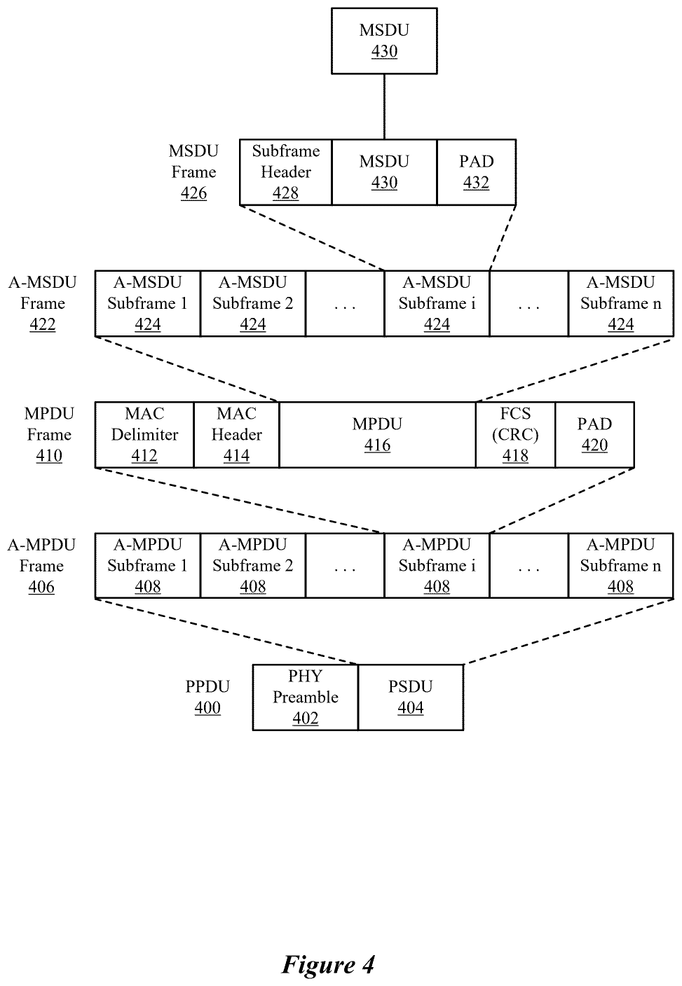

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (for example, the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

In some implementations, the AP 102 and STAs 104 can support various multi-user communications; that is, concurrent transmissions from one device to each of multiple devices (for example, multiple simultaneous downlink communications from an AP 102 to corresponding STAs 104), or concurrent transmissions from multiple devices to a single device (for example, multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHZ, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

In some wireless communications systems, an AP 102 may allocate or assign multiple RUs to a single STA 104 in an OFDMA transmission (hereinafter also referred to as “multi-RU aggregation”). Multi-RU aggregation, which facilitates puncturing and scheduling flexibility, may ultimately reduce latency. As increasing bandwidth is supported by emerging standards (such as the IEEE 802.11be standard amendment supporting 320 MHz and the IEEE 802.11bn standard amendment supporting 480 MHz and 640 MHz), various multiple RU (multi-RU) combinations may exist. Values indicating the various multi-RU combinations may be provided by a suitable standard specification (such as one or more of the IEEE 802.11 family of wireless communication protocol standards including the 802.11be standard amendment and the 802.11bn standard amendment).

As Wi-Fi is not the only technology operating in the 6 GHz band, the use of multiple RUs in conjunction with channel puncturing may enable the use of large bandwidths such that high throughput is possible while avoiding transmitting on frequencies that are locally unauthorized due to incumbent operation. Puncturing may be used in conjunction with multi-RU transmissions to enable wide channels to be established using non-contiguous spectrum blocks. In such examples, the portion of the bandwidth between two RUs allocated to a particular STA 104 may be punctured. Accordingly, spectrum efficiency and flexibility may be increased.

As described previously, STA-specific RU allocation information may be included in a signaling field (such as the EHT-SIG field for an EHT PPDU) of the PPDU's preamble. Preamble puncturing may enable wider bandwidth transmissions for increased throughput and spectral efficiency in the presence of interference from incumbent technologies and other wireless communication devices. Because RUs may be individually allocated in a MU PPDU, use of the MU PPDU format may indicate preamble puncturing for SU transmissions. While puncturing in the IEEE 802.11ax standard amendment was limited to OFDMA transmissions, the IEEE 802.11be standard amendment extended puncturing to SU transmissions. In some examples, the RU allocation information in the common field of EHT-SIG can be used to individually allocate RUs to the single user, thereby avoiding the punctured channels. In some other examples, U-SIG may be used to indicate SU preamble puncturing. For example, the SU preamble puncturing may be indicated by a value of the EHT-SIG compression field in U-SIG.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

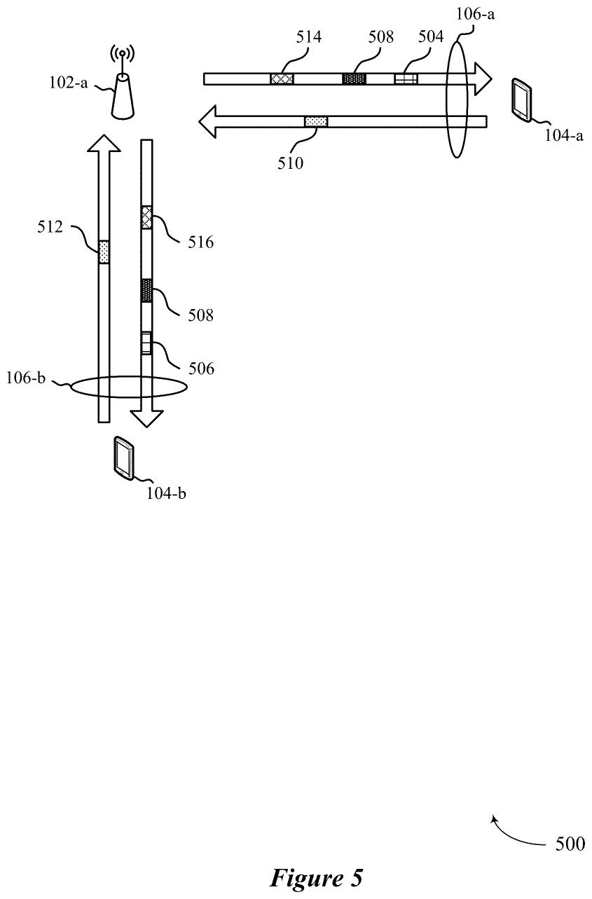

FIG. 5 shows an example of a signaling diagram 500 that supports communication with DSO. For example, the signaling diagram 500 may include an AP 102-a, which may be an example of an APs 102 as described with reference to FIG. 1. The signaling diagram 500 may include a STA 104-a and a STA 104-b, which may be examples of STAs 104 as described with reference to FIG. 1. The AP 102-a may communicate with the STA 104-a via a communication link 106-a, which may be an example of a communication link 106 as described with reference to FIG. 1. The AP 102-a may communicate with the STA 104-b via a communication link 106-b, which may be an example of a communication link 106 as described with reference to FIG. 1. A wireless node may refer to a wireless communication device, such as an AP (such as AP 102-a) or a STA 104 (such as STA 104-a or STA 104-b) that communicates via the wireless communication network 100.

The AP 102-a may implement DSO. In DSO, a non-AP STA 104 (such as the STA 104-a) may dynamically, on a per-TXOP basis, be allocated communication resources outside of the current operating bandwidth of the STA 104-a within the larger operating bandwidth of the AP 102-a. For example, the AP 102-a may transmit first information signaling 504 to the STA 104-a which indicates or configures a primary frequency band for communication between the STA 104-a and the AP 102-a, and the AP 102-a may transmit second information signaling 506 to the STA 104-b which indicates of configures the same primary frequency band for communication between the STA 104-b and the AP 102-a. For example, the information signaling 504 and the information signaling 506 may be control frames and/or management frames which set up association and/or reassociation between the AP 102-a and the STAs 104.

When the AP 102-a is using DSO, the STAs 104 in assigned subbands may be able to use different generation PPDU formats. For example, legacy STAs 104 (such as the STA 104-b) unable to communicate outside of the configured primary frequency band may participate in multiplexed DSO by keeping communications involving the legacy STAs within the primary frequency band. Other STAs (such as the STA 104-a) may communicate with the AP 102-a in a secondary frequency band that is non-overlapping with the primary frequency band (for example, is outside of the primary frequency band). For example, the first information signaling 504 may indicate or configure the secondary frequency band for the STA 104-a for DSO. For example, such DSO involving legacy STAs 104 may include multiplexing HE bandwidth limited STAs that are unable to communicate outside of the primary frequency band in up to 160 MHz transmissions (where other STAs 104 may communicate in the secondary frequency band), thereby essentially multiplexing HE devices into 160 MHz transmissions. For example, the STA 104-a may be a UHR STA 104 which may transmit/receive a first PPDU in a first time resource using a UHR-generation PPDU format in the secondary frequency band (for example, the secondary 80 MHz for a 160 MHz DSO transmission) and the STA 104-b may be an HE STA 104 which may transmit/receive a second PPDU in the same time resource using the HE-generation PPDU format in the primary frequency band (for example, the primary 80 MHz for a 160 MHz DSO transmission). DSO operation may be used for uplink trigger based (TB) frequency division (FD) aggregated PPDUs (APPDUs) or downlink FD-APPDUs.

For example, in uplink DSO, the AP 102-a may transmit one or more trigger frames 508 which include first scheduling information for an uplink TB PPDU 510 for transmission by the STA 104-a in the secondary frequency band and second scheduling information for an uplink TB PPDU 512 for transmission by the STA 104-b in the primary frequency band, where the uplink TB PPDU 510 and the uplink TB PPDU 512 are scheduled in the same time resource. The STA 104-a may accordingly transmit the uplink TB PPDU 510 in the secondary frequency band and the STA 104-b may accordingly transmit the uplink TB PPDU 512 in the primary frequency band. The uplink TB PPDU 510 and the uplink TB PPDU 512 may have per symbol boundary alignment. For example, the data symbol boundaries of the uplink TB PPDU 510 and the uplink TB PPDU 512 may align in time.

In downlink DSO, the AP 102-a may transmit a downlink PPDU 514 to the STA 104-a in the secondary frequency band and the AP 102-a may transmit a downlink PPDU 516 to the STA 104-b in the primary frequency band. The downlink PPDU 514 and the downlink PPDU 516 may be transmitted in the same time resource. The preambles of the downlink PPDU 514 and the downlink PPDU 516 may be designed such that the preamble and data OFDM symbol boundaries of the downlink PPDU 514 and the downlink PPDU 516 align in time, to maintain orthogonality between primary and secondary frequency bands. For example, to maintain orthogonality, the PPDUs in an APPDU (for example, the uplink TB PPDU 510 and the uplink TB PPDU 512; the downlink PPDU 514 and the downlink PPDU 516) may have per symbol boundary alignment. For example, L-STF, HE-LTF, EHT-LTF, and UHR-LTF fields use 0.8 us periodicity (0.8 us per symbol), and may be aligned in time for all sub-PPDUs. As another example, HE-LTF, EHT-LTF and UHR-LTF use symbols with 1×, 2× or 4× symbol durations, and may be aligned in time symbol by symbol for all sub-PPDUs. As another example, Data fields use 4× symbol duration and may be aligned in time symbol by symbol for all sub-PPDUs. One special case is when HE-LTF, EHT-LTF and UHR-LTF use 4× symbol duration (same as Data). In this special case, different numbers of LTF symbols in different sub-PPDUs may be allowed, because LTF symbols and Data symbols may be aligned in time symbol by symbol for different sub-PPDUs as well. The 4× symbol boundary may be either the beginning of the HE-LTF, EHT-LTF, and UHR-LTF fields, or the beginning of the Data fields in the case when LTF symbols use 1× or 2× symbol duration instead of 4× symbol duration.

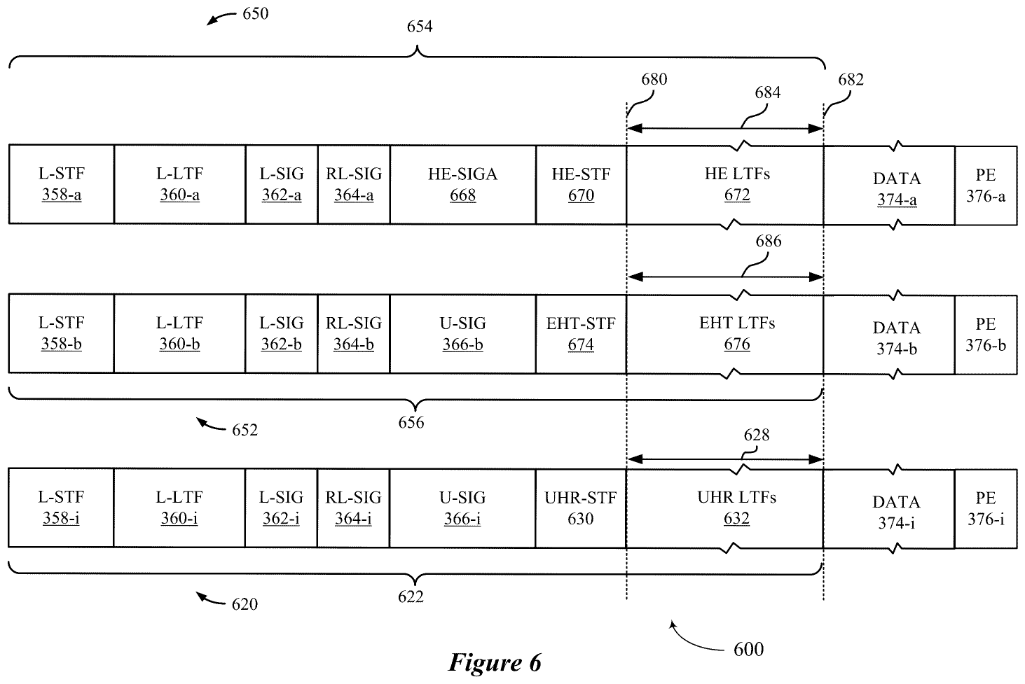

FIG. 6 shows an example of an aggregated uplink TB PPDU format 600 that supports communication with DSO. The aggregated uplink TB PPDU format 600 may implement or may be implemented by aspects of the wireless communication network 100, the PPDU 300, or the signaling diagram 500. For example, the aggregated uplink TB PPDU format shows a PPDU 650 and a PPDU 652. The PPDU 650 may be an example of an uplink TB PPDU 512 transmitted in the primary frequency band as described with reference to FIG. 5, and the PPDU 652 may be an example of an uplink TB PPDU 510 transmitted in the secondary frequency band as described with reference to FIG. 5. The PPDU 620 may be another example of the uplink TB PPDU 510 transmitted in the secondary frequency band as described with reference to FIG. 5. Any 2-generation combination may be used in an APPDU (for example, HE+EHT, HE+UHR, EHT+UHR).

The PPDU 650 may be an example of an HE TB PPDU. The PPDU 652 may be an example of an EHT TB PPDU. The PPDU 650 may include a preamble 654 that includes an L-STF 358-a, an L-LTF 360-a, an L-SIG 362-a, an RL-SIG 364-a, an HE-SIGA field 668, an HE-STF 670, and one or more HE-LTFs 672. The PPDU 650 may include a data field 374-a and a PE 376-a. The PPDU 652 may include a preamble 656 that includes an L-STF 358-b, an L-LTF 360-b, an L-SIG 362-b, an RL-SIG 364-b, a U-SIG 366-b, an EHT-STF 674, and one or more EHT-LTFs 676. The PPDU 652 may include a data field 374-b and a PE 376-b. The PPDU 620 may be an example of a UHR PPDU. The PPDU 620 may include a preamble 622 that includes an L-STF 358-i, an L-LTF 360-i, an L-SIG 362-i, an RL-SIG 364-i, a U-SIG 366-i, a UHR-STF 630, and one or more UHR-LTFs 632. the PPDU 620 may include a data field 374-i and a PE 376-i. In a TB uplink APPDU, each of the PPDU 650, the PPDU 652, and the PPDU 620 may be referred to as a sub-PPDU.

An AP 102 that receives the PPDU 650 and the PPDU 652 may not combine the L-SIG 362-a and the L-SIG 362-b as the length fields in the L-SIG 362-a and the L-SIG 362-b indicate different values (for example, due to the PPDU 650 and the PPDU 652 being different generations). Thus, due to the TB aspect of the PPDU 650 and the PPDU 652, an AP 102 that receives the PPDU 650 and the PPDU 652 may not have issues combining L-SIGs in an FD-PPDU that includes different generations of PPDUs including the PPDU 650 and the PPDU 652.

The preamble 654 may align in time with the preamble 656 (for example, per symbol alignment). For example, the HE-SIGA field 668 and the U-SIG 366-b may each be 2 symbols (where a symbol is 4 microseconds) and may naturally align given the aligning lengths of the preceding fields in the preamble 654 and the preamble 656. Each of the HE-STF 670 and the EHT-STF 674 may be 8 microseconds (2 symbols). Accordingly, the 4×OFDM symbol boundary 680 of the PPDU 650 and the PPDU 652 may align in time. The preamble 654 may not include an HE-SIGB field as the PPDU 650 is a TB uplink PPDU, and the preamble 656 may not include an EHT-SIG field as the PPDU 652 is a TB uplink PPDU. In uplink PPDUs, the quantity of LTFs may be variable, the duration of the guard intervals (GIs), and the quantity of spatial streams may be variable, and accordingly the duration 684 of the HE LTFs 672 and the duration 686 of the EHT-LTFs 676 may be variable. In some examples, signaling for the quantity of LTFs in the HE-LTFs, the GI duration, and the LTF duration may be indicated in the trigger frame (for example, the one or more trigger frames 508 of FIG. 5), and accordingly the data symbol boundary 682 of the PPDU 650 and the PPDU 652 may align in time. Thus an AP 102 may receive the PPDU 650 and the PPDU 652. Similarly, the preamble 654 may align in time with the preamble 622 (for example, per symbol alignment). For example, the HE-SIGA field 668 and the U-SIG 366-i may each be 2 symbols and may naturally align given the aligning lengths of the preceding fields in the preamble 654 and the preamble 622. Each of the HE-STF 670 and the UHR-STF may be formed by using 8 microseconds and may be aligned in time. Accordingly, the 4×OFDM symbol boundary 680 of the PPDU 650 and the PPDU 652 may align in time. The preamble 654 may not include an HE-SIGB field as the PPDU 620 is an uplink TB PPDU, and the preamble 622 may not include a UHR-SIG field as the PPDU 652 is an uplink TB PPDU. In uplink TB PPDUs, the quantity of LTFs may be variable, the duration of the GIs, and the quantity of spatial streams may be variable, and accordingly the duration 684 of the HE LTFs 672 and the duration 628 of the UHR-LTFs 632 may be variable. In some examples, signaling for the quantity of LTFs in the HE-LTFs, the GI duration, and the LTF duration may be indicated in the trigger frame (for example, the one or more trigger frames 508 of FIG. 5), and accordingly the data symbol boundary 682 of the PPDU 650 and the PPDU 620 may align in time. Thus an AP 102 may receive the PPDU 650 and the PPDU 620.

In some examples, the bandwidth of each of the primary frequency band and the secondary frequency band may be 80 MHz (such as for 160 MHz total across the APPDU). In some examples, the bandwidth of each of the primary frequency band and the secondary frequency band may be 160 MHz (for 320 MHz total across the APPDU). The bandwidth field in the HE PPDU (the PPDU 650) may signal the bandwidth of the HE PPDU (for example, 160 MHz in the example where the total bandwidth of the APPDU is 320 MHz) and may be compatible with HE STAs 104. In some examples, the bandwidth field in the EHT PPDU (652) or the UHR PPDU (the PPDU 620) may indicate the bandwidth of the secondary frequency band (for example, 160 MHz in the example where the total bandwidth of the APPDU is 320 MHZ), and with DSO, a UHR STA 104 may support transmitting a 160 MHz PPDU in the secondary frequency band. In some examples, the bandwidth field in the EHT PPDU (652) or the UHR PPDU (the PPDU 620) may indicate the entire bandwidth (the secondary frequency band plus the primary frequency band, for example, 320 MHz in the example where the total bandwidth of the APPDU is 320 MHZ). In such examples, a UHR STA 104 may support transmitting a punctured 320 MHz PPDU in the secondary 160 MHZ, and an uplink bandwidth extension field may indicate to transmit the punctured 320 MHz PPDU in the secondary 160 MHz. As another example, a UHR STA 104 may support transmitting a punctured 160 MHz PPDU in the secondary 80 MHz, and an uplink bandwidth extension field may indicate to transmit the punctured 160 MHz PPDU in the secondary 80 MHz (for example, the bandwidth extension field may be modified to indicate to transmit the punctured 160 MHz PPDU).

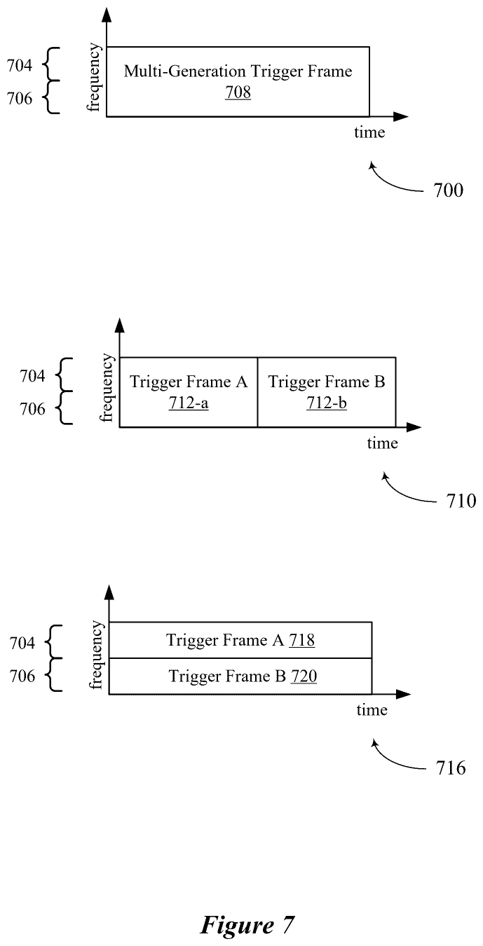

FIG. 7 shows an example 700, an example 710, and an example 716 of trigger frame formats that supports communication with DSO. The example 700, the example 710, and the example 716 of trigger frame formats may implement or may be implemented by aspects of the wireless communication network 100, the PPDU 300, or the signaling diagram 500. For example, the example 710, and the example 716 of trigger frame formats may show example formats for the one or more trigger frames 508 of FIG. 5. Such trigger frames may signal messages to STAs 104 of different generations (such as HE STAs and UHR STAs) in one PPDU. For example, such trigger frames may be carried in non-HT dupped PPDUs.

As shown in the example 700, a multi-generation trigger frame 708 may be used to trigger an uplink TB PPDU transmission for both an HE STA 104 and a UHR STA 104. For example, the multi-generation trigger frame 708 may be a single trigger frame that is transmitted in both the primary frequency band 704 and the secondary frequency band 706. As an example, with reference to FIG. 5, the multi-generation trigger frame 708 may trigger both the uplink TB PPDU 510 for transmission in the secondary frequency band 706 and the uplink TB PPDU 512 for transmission in the primary frequency band 704. The multi-generation trigger frame 708 may be carried in a non-HT dupped PPDU.

In EHT, both HE STAs 104 and EHT STSs may receive respective user information in the same trigger frame, but an HE+EHT FD-APPDU may not be allowed in EHT. This hook may be used, however, to multiplex HE and UHR STAs in the same trigger frame (for example, the multi-generation trigger frame 708). For example, a combination of the common user information field bit 54 (B54) through bit 55 (B55) and the user information field bit 39 (B39) may be transparent to HE STAs while UHR STAs may understand the special user information field. Thus, HE legacy STAs 104 may ignore the common information field B54-B55 and/or the user information field bit 39 (B39) when interpreting the common information field. The uplink bandwidth subfield in the common information field indicates the bandwidth of the HE TB PPDU (for example, the uplink TB PPDU 512 as described with reference to FIG. 5). UHR STAs 104 may interpret the common information field and the user information fields based on the B54-B55 in the common information field and the B39 in the user information field, and accordingly, these bits may indicate to UHR STAs to interpret the multi-generation trigger frame 708 as scheduling an uplink TB PPDU in the secondary frequency band 706 (for example, as scheduling the uplink TB PPDU 510 of FIG. 5).

As shown in the example 710, aggregated trigger frames 712 may be used to trigger an uplink TB PPDU transmission for an HE STA 104 and a UHR STA 104, respectively. For example, two trigger frames, a trigger frame A 712-a may trigger an HE STA 104 to transmit an uplink TB PPDU in the primary frequency band and a trigger frame B 712-b may trigger a UHR STA 104 to transmit an uplink TB PPDU in the secondary frequency band. The combination (or unity) of the trigger frame A 712-a and the trigger frame B 712-b may be an aggregated MPDU (A-MPDU). The aggregated trigger frames 712 may be transmitted as an A-MPDU using both the primary frequency band 704 and the secondary frequency band 706. For example, the aggregated trigger frames 712 may be carried in an HT PPDU, a VHT PPDU, an HE SU PPDU, or any of the aforementioned PPDU types duplicated across frequency bands. The aggregated trigger frames 712 may not be carried in a non-HT dupped PPDU.

For example, the two trigger frames (the trigger frame 712-a and the trigger frame B 712-b) may be aggregated in an AMPDU spanning the entire APPDU bandwidth (the primary frequency band 704 and the secondary frequency band 706). Each of the HE trigger frame (for example, the trigger frame 712-a) and the UHR trigger frame (for example, the trigger frame B 712-b) may be carried in one MPDU and may have its own FCS. An HT/VHT/HE PPDU, EHT MU PPDU, or UHR MU PPDU may be used to broadcast the aggregated trigger frames 712, as non-HT dupped PPDUs may not carry A-MPDU. For example, EHT/HE MU PPDU may be used where the PPDU contains at least one broadcast RU (for example, identified by AID 0 or 2045) that includes the UHR trigger frame, and where the MU PPDU contains one or more other RUs, including but not limited to individual RUs and other broadcast RUs. HE legacy bandwidth limited STAs 104 may understand the bandwidth signaled in the HE trigger frame (for example, the trigger frame 712-a). The AIDs of the HE legacy bandwidth limited STAs 104 may not be included in the UHR trigger frame (for example, the trigger frame B 712-b).

As shown in the example 716, frequency domain aggregated PPDUs may be used to trigger an uplink TB PPDU transmission for an HE STA 104 and a UHR STA 104, respectively. For example, each sub-PPDU may carry one trigger frame and may use non-HT dupped PPDUs. For example, the trigger frame A 718 may be carried in a PPDU transmitted in the primary frequency band 704 and may trigger an HE STA 104 to transmit an uplink TB PPDU in the primary frequency band 704. The trigger frame B 720 may be carried in a PPDU transmitted in the secondary frequency band 706 and may trigger UHR STA 104 to transmit an uplink TB PPDU in the secondary frequency band 706. In the example 716, sub-PPDU alignment (for example, alignment of the PPDUs carrying the trigger frame A 718 and the trigger frame B 720) may be naturally achieved via a DL FD APPDU. HE legacy bandwidth limited STAs 104 may only process the non-HT dupped sub-PPDU within the primary frequency band 704 (for example, based on the capability of the HE legacy bandwidth limited STAs 104 to only communicate in the primary frequency band 704). DSO signaling (for example, the information signaling 504 of FIG. 5) may indicate to UHR STAs 104 to only process the non-HT dupped sub-PPDU in the secondary frequency band 706 to ensure that the UHR STAs 104 do not combine the non-HT dupped sub-PPDUs across the primary frequency band 704 and the secondary frequency band 706. Bystander devices (third-party devices) may combine the non-HT dupped sub-PPDUs across both the primary frequency band 704 and the secondary frequency band 706, in receiver processing and may not correctly decode either the trigger frame A 718 or the trigger frame B 720. Bystanders may properly defer in transmission according to channel sensing.

In each of the example 700, the example 710, and the example 716, the HE trigger frame (for example, the trigger frame 712-a or the trigger frame A 718) or the portion of the multi-generation trigger frame 708 that targets the HE STA 104 may be 802.11ax compliant and understandable by HE STAs 104 in order to schedule the corresponding uplink transmission by the HE STA 104.

Some fields in the UHR trigger frame (for example, the trigger frame that indicates the scheduling information for the UHR STA 104 such as the trigger frame B 712-b or the trigger frame B 720 or the multi-generation trigger frame 708) may be changed, including: B54 and the B55 in the common information field and the B39 in the user information field; the PHY version identifier subfield in the special user information field may be set to UHR (for example, for bandwidth signaling, the uplink bandwidth subfield in the common information field and the uplink bandwidth extension subfield in the special user information field may jointly indicate the solicited TB PPDU bandwidth); spatial reuse fields, including the uplink spatial reuse-n, n=1, 2, 3, and 4 subfields in the common info field and the UHR spatial reuse-n, n=1, 2 subfields in the special user information field; and RU allocation signaling (including RU allocation subfield and PS160 (B39) subfield in the user information field).

Table 1 shows variations of the B54 and the B55 in the common information field and the B39 in the user information field. In some examples, the 3 combinations which indicate the EHT variant may be used to indicate the variant(s) of one or more generations, including the EHT variant and UHR variant, and three unused combinations also may be used to indicate specific variants of future generations, for example, the UHR variant (where the three unused combinations are “111,” “011,” and “010” as shown in Table 1). In some examples, the common information field B55 may be used as a special info field flag, and the common information field B54 may indicate whether the solicited TB PPDU transmitted in the primary frequency band is an HE TB PPDU or a TB PPDU of a future generation, including EHT and UHR.

TABLE 1

| Common | Common | | Presence of | User Info | |
|---|---|---|---|---|---|
| Info Field | Info Field | User Info | Special User | Field | TB PPDU |
| B54 | B55 | Field B39 | Info Field | Varian | Type |
| 1 | 1 | 0 | No | HE | HE |
| | | | | Variant | |
| 0 | 0 | 0 | Yes | EHT | EHT |
| | | | | Variant | |
| 0 | 0 | 1 | Yes | EHT | EHT |
| | | | | Varian | |
| 1 | 0 | 1 | Yes | EHT | EHT |
| | | | | Variant | |
| 1 | 0 | 0 | Yes | HE | HE |
| | | | | Variant | |
| 1 | 1 | 1 | Unused | Unused | Unused |
| 0 | 1 | 1 | Unused | Unused | Unused |
| 0 | 1 | 0 | Unused | Unused | Unused |

In some examples, the UHR trigger frame may use a first bandwidth signaling design which indicates the sub-PPDU bandwidth for the UHR STA 104 (for example, indicates the secondary frequency band for the corresponding uplink TB PPDU). In such examples, DSO signaling (for example, the information signaling 504 of FIG. 5) may indicate to a UHR STA 104 that the bandwidth signaling is applicable to the secondary frequency band. The bandwidth signaling may modify table 9-45 g (shown as Table 2 below). In some examples, the spatial reuse fields may decouple the relationship between the uplink spatial reuse-n, n=1, 2, 3, and 4 fields (for the HE TB sub-PPDU in the primary frequency band 704) and the UHR spatial reuse-n, n=1, 2 fields (for the UHR TB sub-PPDU in the secondary frequency band). In such a case, these spatial reuse fields may correspond to disjoint frequency bands and their field values may be uncorrelated. For RU allocation signaling, in some examples, the PS160 (B39) subfield in the user information field may be generalized to a Primary/Secondary (B39) subfield. The PS160 (B39) subfield may be used to indicate if the assigned RU to a UHR STA is in the primary or secondary 80 MHz when the bandwidth signaled for the UHR TB PPDU is 80 MHz, or if the assigned RU is in the primary or secondary 160 MHz when the bandwidth signaled for the UHR TB PPDU is 160 MHz. The PS160 (B39) subfield may be set to 1 to indicate the assigned RU to a UHR STA is in the secondary 80 MHz in an HE 80 MHz+UHR 80 MHz uplink TB APPDU. In some examples, for RU allocation signaling, PS160 may be set to 1 to indicate the assigned RU to a UHR STA is in the secondary 160 MHz in an HE 160 MHz+UHR 160 MHz uplink TB APPDU and [primary 80 MHz, Secondary 80 MHz] may be used as the configuration in the secondary 160 MHZ, as an input to Table 9-45m (Lookup table for X1 and N) in 802.11be spec draft D6.0 to interpret the RU assignment.

In some examples, the UHR trigger frame may use a second bandwidth signaling design which indicates the entire A-PPDU bandwidth (the primary frequency band 704 plus the secondary frequency band 706), which may be more straightforward in the UHR trigger frame, despite the bandwidth of the PPDU that carries the UHR trigger frame. In 802.11be, HE STAs 104 may understand the primary 20/40/80 MHz if the EHT bandwidth is also the primary 20/40/80 MHz. If the bandwidth signaling indicates the primary 160 MHz for HE STAs, then the EHT bandwidth may be the primary 160 MHz or may be 320 MHz (including both the primary and secondary 160 MHz). The spatial reuse fields of HE and EHT may be tied to one another considering the HE TB PPU bandwidth would be fully or partially overlapped with the EHT TB PPDU bandwidth. RU allocation signaling may be tied to the primary or secondary channel definition within the bandwidth signaled for the EHT TB PPDU. Accordingly, to signal the bandwidth, 320 MHz may be already supported by EHT where the uplink bandwidth field in the common information field signals 160 MHz (for example, where the total APPDU bandwidth is 320 MHz). To support a total APPDU bandwidth of 160 MHz, table 9-45-g may be modified (shown in Table 2 below) when the uplink bandwidth signals 80 MHz in the common information field in the second bandwidth signaling design. In the second bandwidth signaling design, the spatial reuse and RU allocation signaling may not be modified with respect to EHT.

TABLE 2

| | Bandwidth for | Uplink | Bandwidth for |
|---|---|---|---|
| Uplink | HE TB PPDU | Bandwidth | EHT TB PPDU |
| Bandwidth | (MHz) | Extension | (MHz) |
| 0 | 20 | 0 | 20 |
| 0 | 20 | 1 | Reserved |
| 0 | 20 | 2 | Reserved |
| 0 | 20 | 3 | Reserved |
| 1 | 40 | 0 | 40 |
| 1 | 40 | 1 | Reserved |
| 1 | 40 | 2 | Reserved |
| 1 | 40 | 3 | Reserved |
| 2 | 80 | 0 | 80 |
| 2 | 80 | 1 | Reserved |
| 2 | 80 | 2 | Reserved |
| 2 | 80 | 3 | Reserved |
| 3 | 160 | 0 | Reserved |
| 3 | 160 | 1 | 160 |
| 3 | 160 | 2 | 320 (for 320 MHz-1 |
| | | | channelization) |
| 3 | 160 | 3 | 320 (for 320 MHz-1 |
| | | | channelization) |

For the first bandwidth signaling design, in a first sub-design, DSO messaging (for example, in the information signaling 504 of FIG. 5) may indicate to a UHR STA 104 that the bandwidth signaling is for the secondary channel, in which case the trigger frame may be less self-contained. For the first bandwidth signaling design, in a second sub-design, a combination in Table 2 may be re-purposed to indicate the 80 MHz UHR PPDU (for example, the Uplink Bandwidth field in the common information field is set to 80 MHz and the UL bandwidth extension field in the special user info field is set to 1, 2 or 3) or the 160 MHz UHR PPDU (for example, the Uplink Bandwidth field in the common information field is set to 160 MHz and the UL bandwidth extension field in the special user info field is set to 0) in the secondary frequency band 706. For example, reserved entries in Table 2 may be used to indicate the 80 MHz UHR PPDU or the 160 MHz UHR PPDU in the secondary frequency band 706. Currently, the Uplink bandwidth field in the common information field set to 160 MHz and uplink bandwidth extension field set to 1 indicates 160 MHz UHR TB PPDU in the primary frequency band when the primary frequency band is 160 MHz.

For the second bandwidth signaling design, a combination (for example, the Uplink bandwidth field in the common information field is set to 80 MHz and the UL bandwidth extension field in the special user info field is set to 1, 2 or 3) may be used to indicate the 160 MHz or 320 MHz PPDU bandwidth for the UHR TB PPDU.

In some examples, for the UHR trigger frame, for the B39 or the PS160 field in the variant user information field, the PS160 bit together with bit 0 (B0) in the RU allocation subfield may be used to differentiate the assigned RU or MRU in the 80 MHz or 160 MH for the UHR TB PPDU. In the first bandwidth signaling design, the PS160 bit may indicate the assigned RU in the primary or the secondary channel (such as setting PS160=1 to indicate S80 in HE80+UHR80 or setting PS160=1 to indicate S160 in HE160+UHR160 and using [P80, S80] as the configuration in S160, as an input to Table 9-45m (Lookup table for X1 and N) in the 802.11be specification draft D6.0 to interpret the RU assignment). As another example, for the second bandwidth signaling design, no change may be made to the B39 in the variant user information field.

In some examples, TB APPDU may be extended to N generations (N>2) where at least two generations belong to EHT and beyond. For example, a TB APPDU may be an HE+EHT+UHR APPDU involving HE160+EHT/UHR160 where HE STAs 104 are assigned in the primary 160 MHz frequency band (P160) and EHT/UHR STAs are multiplexed in non-overlapped 20/40/80 MHz subchannels within secondary 160 MHz frequency band (S160) or involving HE80+EHT80+UHR160 where HE STAs 104 are assigned in the primary 80 MHz frequency band (P80), EHT STAs 104 are assigned in a secondary 80 MHz frequency band (S80) within the P160 and UHR STAs are assigned in the secondary 160 MHz frequency band (S160). As another example, a TB APPDU may be an EHT+UHR APPDU involving EHT160+UHR160 where EHT STAs 104 are assigned in P160 and UHR STAs 104 are assigned in S160. As another example, a TB APPDU may be an HE+UHR+Wi-Fi-x APPDU, where Wi-Fi-x is a future generation where x>=9 (where EHT and UHR are considered as “Wi-Fi7” and “Wi-Fi8”, respectively).

Three main approaches may be used for the design of the trigger frame for an N generation PPDU where at least two generations belong to EHT and beyond. In a first approach (the multi-generation trigger frame similar to the example 700), one trigger frame may be used to signal STAs 104 of all included generations of the APPDU. In a second approach (an A-MPDU with of MPDU per trigger frame similar to the example 710), N trigger frames may be used an aggregated in an A-MPDU that may not use a non-HT dupped PPDU. In a third approach (an FD-aggregated PPDU similar to the example 716), an FD-APPDU may be used, where each sub-PPDU carries one trigger frame. The second and third approaches may naturally account for the coexistence of EHT, UHR, and beyond. In some examples, a combination of the three approaches may be used. An HE80+EHT80+UHR160 TB APPDU may be used as an example of the combination approach. For example, an FD-A-PPDU may be used to carry a multi-generation Trigger Frame (to trigger both HE and EHT STAs in non-overlapping subchannels in P160) in a first sub-PPDU in P160 and a UHR Trigger Frame (to trigger UHR STAs in S160) may be used in a second sub-PPDU in S160. As another example, an A-MPDU may be used where one MPDU is a multi-gen Trigger Frame (to trigger both HE and EHT STAs in non-overlapping subchannels in P160) and the other MPDU may be a UHR Trigger Frame (to trigger UHR STAs in S160). As another example, an FD-A-PPDU may be used to carry an A-MPDU of two Trigger Frames (HE and EHT) in a first sub-PPDU in P160 and a UHR Trigger Frame may be used in a second sub-PPDU in S160.

The first approach, using one multi-generation trigger frame to signal STAs 104 of all generations) may involve modifications to account for the coexistence of EHT, UHR, and beyond. For example, Table 3 shows the HE/EHT trigger frame format, where the second row shows the quantity of octets per each field.

TABLE 3

| Frame | Duration | | | Common | User | | |
|---|---|---|---|---|---|---|---|
| Ctrl | (Dur) | RA | TA | Info | Info List | Padding | FCS |
| 2 | 2 | 6 | 6 | 8 or | variable | variable | 4 |
| | | | | more | | | |

In the HE/EHT trigger frame format as shown in Table 3, there may be only one special user information field (with the PHY version identifier subfield) that can signal STAs of only one generation of EHT, UHR, and beyond (for example, whichever generation the PHY version identifier subfield is set to). B55 in the common information field may be set to “0” to indicate the presence of a special user information field as shown in Table 4, where the special user information field is immediately after the common information field and may be identified by the AID12 value of 2007. In Table 4, the second row shows the quantity of octets per field in the Trigger Frame format. The user info field #1 through the user info field #M may be user info fields for specific non-AP STAs 104, and the special user info field through the user info field #M may be a user info list.

TABLE 4

| | | | | | Special | | | | | |
|---|---|---|---|---|---|---|---|---|---|---|
| | | | | | User | | | | | |
| | | | | | Info | | | | | |
| | | | | | Field | | | | | |
| | | | | | (PHY | User | | User | | |
| | | | | | Ver. | Info | | Info | | |
| Frame | | | | Common | ID = | Field | | Field | | |
| Ctrl | Dur | RA | TA | Info | 0) | #1 | . . . | #M | Padding | FCS |
| 2 | 2 | 6 | 6 | 8 or | 5 or | 5 or | . . . | 5 or | variable | 4 |
| | | | | more | more | more | | more | | |

To signal STAs of different generations of EHT, UHR, and beyond, more special user information fields may be included in a multi-generation trigger frame. One special user information field may be included for each generation if needed to solicit a TB PPDU of that generation. The structure of the special user information fields may depend on the value of the PHY Version Identifier subfield. The uplink bandwidth extension subfield may use N1>=2 bits, where N1 depends on the generation (value of the PHY Version Identifier subfield). The quantity of special user information fields may depend on how many generations coexist in the TB APPDU. For example, by the time of Wi-Fi 10, EHT, UHR, Wi-Fi9 STAs may still be in use; and thus there may be 4 generations of coexistence. In some examples, two generations of coexistence may be assumed at a time (for example, EHT and UHR, UHR and Wi-Fi 9, etc.). In some examples, four generations of coexistence may be assumed at a time (for example, EHT, UHR, Wi-Fi9 & Wi-Fi10). In some examples, up to 8 generations may coexist, which may be the maximum amount of generations that may be signaled using the 3 bit PHY version identifier.

In a first design option, all special user information fields may be immediately after the common information field, as shown in Table 5. The special user information fields may be in any order or may be in PHY version identifier ascending or descending order. Each STA 104 may use the special user information field of the highest generation each STA 104 understands. For example, if there are two special user information fields, one indicates EHT, and the other indicates UHR, an EHT STA 104 may use the special user information field that indicates EHT and may disregard the other special user information field that indicates UHR while a UHR STA 104 may use the special user info field that indicates UHR and may disregard the other special user info field that indicates EHT. In Table 5, the second row shows the quantity of octets per field. Regardless of the value in the PHY Version Identifier field, an EHT STA may always interpret the field structure and definition of a special user information field as the special user information field defined in the 802.11be spec and interpret other user information fields as EHT variant user information fields.

TABLE 5

| | | | | | Special | | Special | | |
|---|---|---|---|---|---|---|---|---|---|
| | | | | | User | | User | | |
| | | | | | Info | | Info | | |
| | | | | | Field | | Field | User | |
| | | | | | (PHY | | (PHY | Info | |
| Frame | | | | Common | Ver. | | Ver. | Field | |
| Ctrl | Dur | RA | TA | Info | ID = a) | . . . | ID = n) | #1 | . . . |
| 2 | 2 | 6 | 6 | 8 or | 5 or | . . . | 5 or | 5 or | . . . |
| | | | | more | more | | more | more | |

. . .

| User Info Field #M | Padding | FCS |
|---|---|---|
| 5 or more | variable | 4 |

In the first design option, the user information field size may not be changed. HE and EHT STAs do not understand a user information field size other than a size of 5 octets before the Trigger Dependent User Info subfield (if present). HE and EHT STAs may continue to process all user information fields, assuming each having size of 5 octets before the Trigger Dependent User Info subfield (if present), until they find a user information field that indicates their own AID12 value, or the “Start of padding field”, which may be identified by the AID12 value of 4095, such that HE and EHT STAs know that the User Info List has ended, and the remaining are padding bits until the FCS. The UHR variant user information field or a future generation variant user information field may need more than 5 octets before the Trigger Dependent User Info subfield (if present) for signaling. There may be methods to change the effective size of these generations' variant user information fields. In a first method, use two UHR variant user information fields, or two future generation variant user information fields, to carry signaling for the same non-AP STA. The two user information fields may have the same value in their AID12 fields to identify the same non-AP STA. The two user information fields may further have same value in the RU Allocation subfield and same value in the PS160 (B39) to identify same non-AP STA in same assigned RU, and/or same value in the SS Allocation subfield to identify same non-AP STA with same assigned spatial stream(s). The field structures of the remaining bits in the two user information fields may be different to carry more signaling for the same non-AP STA. In a second method, a 1-bit reserved field may be periodically used and set to 1 to indicate to HE and EHT STAs interpret the AID12 subfield value not matching their station identifications. For example, if the Trigger Dependent User Info subfield is absent, the B11 of each 5-octet block may be a reserved bit and may be set to 1. For another example, if the Trigger Dependent User Info subfield is present, the B11 of each block, whose size is 5 octets plus the size of the Trigger Dependent User Info subfield, may be a reserved bit and may be set to 1. When HE and EHT STAs interpret the 5-octet block before the Trigger Dependent User Info subfield (if present), B0-B11 are the AID12 subfield they assume. By setting B11 to 1, the AID12 value would be from 2048 to 4095. Therefore, HE and EHT STAs see either reserved values of AID12 or the “Start of Padding field” identified by a value of 4095, and thus would not falsely identify the values to match their own STA IDs.

In a second design option, as shown in Table 6, the user information fields that use a certain PHY generation's user information field format may be after the special user information field that indicates that PHY generation. This is a grouping design that groups a certain generation's variant user information fields with the special user information field that indicates that PHY generation. In this design option, the HE variant user information fields may be anywhere, as long as the first user information field immediately after the common information field is a special user information field, if present. The HE variant user information fields may be after the first special user information field. In the example in Table 6, HE variant user information fields and the generation-a variant user information fields, (for example, User information fields #al to #aM are after the first special user information field whose PHY Version Identifier subfield is set to generation-a, and before the second special user information field). The generation-n variant user information fields, (User information fields #n1 to #nM) are after the special user information field whose PHY Version Identifier subfields is set to generation-n. In such examples, it may take different amounts of time to generate the TB sub-PPDU of different generations. The grouping design of the second design option allows different generations to have different padding time to meet the timeline of generating the corresponding TB sub-PPDUs. The padding time of each generation depends on how many fields or bits are signaled after this generation's variant user information fields. The second design option also allows that one STA 104 may be assigned with multiple RUs in different sub-PPDUs. For example, a UHR STA 104 may be assigned on RU in the HE sub-PPDU's channel and another RU in the UHR sub-PPDU's channel. The second design option also allows that the user information field size may be changed according to the PHY generation and before the Padding field. In Table 6, the second row shows the quantity of octets per field.

TABLE 6

| | | | | | Special | | | | |
|---|---|---|---|---|---|---|---|---|---|
| | | | | | User | | | | |
| | | | | | Info | | | | |
| | | | | | Field | User | | | |
| | | | | | (PHY | Info | | | |
| Frame | | | | Common | Ver. | Field | | User Info | |
| Ctrl | Dur | RA | TA | Info | ID = a) | #a1 | . . . | Field #aM | . . . |
| 2 | 2 | 6 | 6 | 8 or more | 5 or | 5 or | . . . | 5 or more | . . . |
| | | | | | more | more | | | |

. . .

| Special | | | | | |
|---|---|---|---|---|---|
| User Info | | | | | |
| Field (PHY | | | | | |
| Ver. ID = | User Info | | User Info | | |
| n) | Field #n1 | . . . | Field #nM | Padding | FCS |
| 5 or more | 5 or more | . . . | 5 or more | variable | 4 |

In EHT, the special user information field may be identified by the AID12 value of 2007. HE and EHT STAs may continue to process all user information fields, each having size of 5 octets before the Trigger Dependent User Info subfield (if present), until they find one that indicate own AID12 value, or the “Start of padding field”, which may be identified by the AID12 value of 4095, such that HE and EHT STAs know that the User Info List has ended, and the remaining are padding bits until the FCS. When there are multiple special user info fields, specific AID12 values may be used to identify special user info fields. For example, the same AID12 value of 2007 may be used to identify all special user info field(s), as EHT, UHR, and beyond APs may not assign AID12 value 2007 to any non-AP STAs associated to the APs. In some examples, a set of AID12 values may be used (for example, {2007, 2006, . . . }) where each value may be use for a specific PHY generation (PHY Version Identifier equals a certain value). An AP 102 of a given generation may not assign that specific AID12 value to any non-AP STAs 104 associated to that AP 102. In some examples, specific AID12 value 4095 may be used to identify one or more special user info fields for certain PHY generations after EHT, for example, WiFi-9. HE and EHT STAs may not continue to process user information fields as they find the “Start of Padding field” which is identified by AID12 value of 4095. From the first special user information field identified by the specific AID12 value of 4095, each user information field may have a size different from previous user information fields, for example, having the size of 6 octets before the Trigger Dependent User Info subfield (if present). For these one or more PHY generations where the special user information filed may be identified by the AID12 value of 4095, a “Start of padding field” may be identified by a different AID12 value, for example, 4094, such that STAs of these one or more PHY generations may not continue to process the user information fields afterwards. And this different AID12 value, for example, 4094, may again be used to identify special user information fields for one or more further future PHY generations. And again, from the first special user information field identified by the specific AID12 value of 4094, each user information field may have a size different from the previous user information fields, for example, having the size of 7 octets before the Trigger Dependent User Info subfield (if present). This design philosophy may be continued for future generations, where one AID12 value to indicate the “Start of padding field” of particular generations may be used to indicate the special information field of further future generations and change the size of the user information fields.

Several methods may be used to signal the additional special user information fields after the first special user information field signaled by the B55 in the common information field. In a first method, no additional signaling may be used, and only specific AID12 values may be used to identify special user information fields. In a second method, the quantity of additional special user information fields (not counting the first special information field) or the total quantity of special user information fields may be explicitly indicated. For example, a “quantity of additional special user info fields” or “total quantity of special user info fields” indication may be added and may involve 1-3 bits. For example, such an indication may be signaled by repurposing some reserved fields such as B56-B63 of the common information field, or B37-B39 of the first user information field. In a third method, the presence of the next additional special user info field may be indicated. B55 in the common information field may be used to indicate the presence of the first special user info field. For example, 1 bit may be used to indicate the presence or absence of a next additional special user information field. The presence of the first additional special user info field (the second special user info field) may be signaled by repurposing one reserved bit, for example, B56-B63 of the common info field, or B37-B39 of the user info field (the first special user info field). Starting from the second additional special user information field (the third special user information field), the presence of the additional special user information fields may be indicated by a bit in the previous special info field (for example, one of B37-B39). For example, Table 7 shows the special user information field in 802.11be, Table 8 shows an example of the first method to signal the additional special user information fields, Table 9 shows an example of the second method to signal the additional special user information fields, and Table 10 shows an example of the third method to signal the additional special user information fields. In Table 8, the quantity of bits for the uplink bandwidth extension may depend on the value of the PHY version identifier subfield. In Table 10, the field structure may be allowed to change depending on the value of the PHY version identifier subfield. In Table 10, N1 bits (N1>=2) may be used for uplink bandwidth extension to accommodate 320 MHz and larger bandwidth (for example, 480 MHz or 640 MHz). In each of Tables 7, 8, 9, and 10, the second row shows the quantity of bits per field. The bits extend from B0 for the first bit of AID12 to B39 for the last bit of the reserved field for Table 7, and the bits are ordered sequentially. The bits extend from B0 for the first bit of AID12 to B39 for the last bit of the reserved field for Table 8, and the bits are ordered sequentially. The bits extend from B0 for the first bit of AID12 to B39 for the last bit of the quantity of additional special user information fields for Table 9, and the bits are ordered sequentially. The bits extend from B0 for the first bit of AID12 to B39 for the last bit of the additional special user information field for Table 10, and the bits are ordered sequentially. In another example, the “Quantity of Additional Special User Info Fields” subfield in Table 9 may be replaced by a “Total Quantity of Special User Info Fields” subfield. In Tables 7-10, the size of user information field is 5 octets before the Trigger Dependent User Info subfield (if present).

TABLE 7

| | | | EHT | EHT | U-SIG | | |
|---|---|---|---|---|---|---|---|
| | PHY | | Spatial | Spatial | Disregard | | Trigger |
| | Ver | UL BW | Reuse | Reuse | and | | Dependent |
| AID12 | ID | Extension | 1 | 1 | Validate | Reserved | User Info |
| 12 | 3 | 2 | 4 | 4 | 12 | 3 | variable |

TABLE 8

| | | | | | U-SIG | | |
|---|---|---|---|---|---|---|---|
| | PHY | | Spatial | Spatial | Disregard | | Trigger |
| | Ver | UL BW | Reuse | Reuse | and | | Dependent |
| AID12 | ID | Extension | 1 | 1 | Validate | Reserved | User Info |
| 12 | 3 | N1 | 4 | 4 | 12 | 5-N1 | variable |

TABLE 9

| | | | | | | | Quantity | |
|---|---|---|---|---|---|---|---|---|
| | | | | | | | of | |
| | | | | | U-SIG | | additional | Trigger |
| | PHY | | Spatial | Spatial | Disregard | | special | Dependent |
| | Ver | UL BW | Reuse | Reuse | and | | user info | User |
| AID12 | ID | Extension | 1 | 1 | Validate | Reserved | field | Info |
| 12 | 3 | N1 | 4 | 4 | 12 | 4-N1 | 1 | variable |

TABLE 10

| | | | | | U-SIG | | Additional | Trigger |
|---|---|---|---|---|---|---|---|---|
| | PHY | | Spatial | Spatial | Disregard | | special | Dependent |
| | Ver | UL BW | Reuse | Reuse | and | | user info | User |
| AID12 | ID | Extension | 1 | 1 | Validate | Reserved | field | Info |
| 12 | 3 | N1 | 4 | 4 | 12 | 4-N1 | 1 | variable |

Several methods may be used to signal the size of a special user information field, if identified by a specific AID12 value, for example, 4095, and the successive user information fields, before the next special user information field or the “Start of padding field” identified by a specific AID12 value, for example, 4094. In a first method, no additional signaling may be used, and the size only depends on the value of the AID12 value, for example, 4095, used to identify that special user information field, or the value of the PHY Version Identifier of that special user information field. In a second method, the size may be signaled in a “User information field length” subfield in that special user information field. For example, 1-2 bits may be used to indicate the “User information field length”. In a third method, the size may be indicated in a “User information field length increment” subfield in that special user information field. It indicates what additional quantity of octets or bits compared to a pre-assumed size (for example, 5 octets before the Trigger Dependent User Info subfield (if present), or compared to a previous size of user information fields. For example, 1-2 bits may be used to indicate the “User information field length increment”. For example, Table 11 shows an example of the second method to signal the “User information field length” in a subfield in the special user information field, and Table 12 shows an example of the second method to signal the “User information field length increment” in a subfield in the special user information field. The bits extend from B0 for the first bit of AID12 to B39 for the last bit of the quantity of additional special user information fields for Table 11, and the bits are ordered sequentially. The bits extend from B0 for the first bit of AID12 to B39 for the last bit of the additional special user information field for Table 12, and the bits are ordered sequentially. In Tables 11-12, the size of user information field is 6 octets before the Trigger Dependent User Info subfield (if present).

TABLE 11

| | | | | | U-SIG | | User | Trigger |
|---|---|---|---|---|---|---|---|---|
| | PHY | | Spatial | Spatial | Disregard | | info | Dependent |
| | Ver | UL BW | Reuse | Reuse | and | | field | User |
| AID12 | ID | Extension | 1 | 1 | Validate | Reserved | length | Info |
| 12 | 3 | N1 | 4 | 4 | 12 | 12-N1 | 1 | Variable |

TABLE 12

| | | | | | | | User | |
|---|---|---|---|---|---|---|---|---|
| | | | | | U-SIG | | info | Trigger |
| | PHY | | Spatial | Spatial | Disregard | | field | Dependent |
| | Ver | UL BW | Reuse | Reuse | and | | length | User |
| AID12 | ID | Extension | 1 | 1 | Validate | Reserved | increment | Info |
| 12 | 3 | N1 | 4 | 4 | 12 | 12-N1 | 1 | Variable |

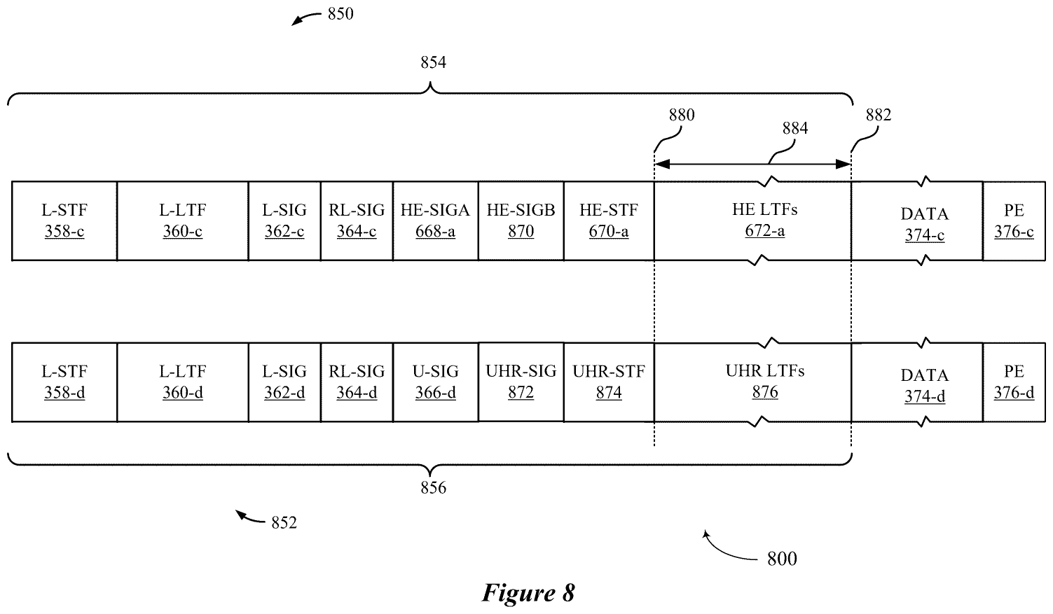

FIG. 8 shows an example of an aggregated downlink PPDU format 800 that supports communication with DSO. The aggregated downlink PPDU format 800 may implement or may be implemented by aspects of the wireless communication network 100, the PPDU 300, or the signaling diagram 500. For example, the aggregated downlink PPDU format 800 shows a PPDU 850 and a PPDU 852. The PPDU 850 may be an example of a downlink PPDU 516 transmitted in the primary frequency band as described with reference to FIG. 5, and the PPDU 852 may be an example of a downlink PPDU 514 transmitted in the secondary frequency band as described with reference to FIG. 5.

The PPDU 850 may be an example of a MU HE PPDU. The PPDU 852 may be an example of a UHR PPDU. The PPDU 850 may include a preamble 854 that includes an L-STF 358-c, an L-LTF 360-c, an L-SIG 362-c, an RL-SIG 364-c, an HE-SIGA field 668-a, an HE-SIGB field 870, an HE-STF 670-a, and one or more HE-LTFs 672-a. An SU HE PPDU may be similar to an MU HE PPDU but may not include an HE-SIGB field 870. The PPDU 850 may include a data field 374-c and a PE 376-c. The PPDU 852 may include a preamble 856 that includes an L-STF 358-d, an L-LTF 360-d, an L-SIG 362-d, an RL-SIG 364-d, a U-SIG field 366-d, a UHR-SIG 872, an EHT-STF field 874, and one or more EHT-LTFs 876. The UHR-SIG 872, may be a UHR design but may be based on EHT-SIG, USIG, EHT-STF, and/or EHT-LTF contents. The PPDU 852 may include a data field 374-d and a PE 376-d. The duration 884 of the HE-LTFs 672-a and the UHR-LTFs or EHT-LTFs 876 may be variable depending on the quantity of HE-LTFs/EHT/LTFs, the GIs, and the quantity of spatial streams. In a downlink APPDU, each of the PPDU 850 and the PPDU 852 may be referred to as a sub-PPDU.

To transmit a downlink APPDU including different PPDU formats, such as the PPDU 850 and the PPDU 852, the data symbol boundary 882 should be aligned in time. Similarly, the 4×OFDM symbol boundary 880 before the HE-LTFs 672-a and the EHT-LTFs 676 or the UHR-LTFs 632 should be aligned in time.

In downlink FD-APPDU, the HE sub-PPDU (for example, the PPDU 850) may include a bandwidth field that signals the bandwidth of the HE sub-PPDU (for example, 160 MHz for a 320 MHz APPDU or 80 MHz for a 160 MHz PPDU) and is compatible with HE STAs 104. In some examples, the UHR sub PPDU (for example, the PPDU 852) may indicate the bandwidth of the secondary frequency band (for example, 160 MHz for a 320 MHz APPDU or 80 MHz for a 160 MHz PPDU), as with DSO, UHR STAs may support transmitting or receiving a PPDU in the secondary frequency band. Such signaling of the bandwidth of the secondary frequency band may involve minimal signaling overhead in the UHR-SIG field. In some examples, the UHR sub PPDU (for example, the PPDU 852) may indicate the entire bandwidth of the downlink FD-APPDU (for example, the primary frequency band plus the secondary frequency band), and only RUs or MRUs within the secondary frequency band may be assigned to the UHR STA(s) 104 while the primary frequency band is punctured for the UHR STA(s). Signaling of the entire bandwidth of the downlink FD-APPDU may be better for bystander devices and may include a lower peak to average power ratio (PAPR) in the STF/LTFs. Such signaling of the entire bandwidth of the downlink FD-APPDU, however, may involve larger signaling overhead in UHR-SIG due to more RU allocation subfields (for example, four more 9-bit RU allocation subfields per content channel means ˜1.5 more MCS0 symbols, and in an HE80+UHR80 APPDU, two more 9-bit RU allocation subfields plus CRC and Tail per content channel means ˜1 more MCS0 symbol).

The LSIG length (L_LENGTH) field in each sub-PPDU may be set in a manner to avoid causation of errors at bystander devices. For example, for packet classification, L_LENGTH is a multiple of 3 (for example, L_LEN % 3=0) in EHT & UHR, but is not a multiple of 3 (L_LEN % 3≠0) in HE. Accordingly, setting the LSIG length field in each sub-PPDU to the correct format-specific value could cause problems at bystander devices. For example, such LSIG decoding problems may occur to bystander devices which combine LSIG decoding across more than 80 MHz or across both the primary frequency band and the secondary frequency band of the APPPDU containing the PPDU 850 and the PPDU 852. Additionally, such LSIG decoding problems may occur to a UHR STA 104 in the secondary frequency band if the UHR STA 104 combines the LSIG decoding across the full bandwidth of the APPDU (for example, based on subchannel LTF energy detection, the UHR STA 104 may perform combined decoding over various 20 MHz subchannels in the primary frequency band and the secondary frequency band).

In some examples, in a first design to eliminate LSIG combining issues, for the HE portion (such as for the HE-MU format as shown in the PPDU 850), the LSIG length field value may be encoded to identify the HE-MU PPDU type, and for the UHR portion (EHT-MU format as shown in the PPDU 852), the LSIG length may be set to the same value as the HE portion. In the first design, a UHR STA 104 may not use the LSIG length field decoded from the PPDU 852 to determine the PPDU type, but may bypass the LSIG length field check (for example, based on instructions from DSO setup messaging such as in the information signaling 504 of FIG. 5). In some examples, bystander STAs 104 in any part of the FD-APPDU bandwidth may be able to decode LSIG to get proper deferral information, though such deferral information may misidentify the sub-PPDU type, since the bystander STAs 104 are not the intended recipients the bystander STAs 104 will abort after subsequent SIG field decoding failure. As the UHR STA 104 may receive prior DSO setup messaging, the UHR STA 104 may not rely on the LSIG length field to identify the sub-PPDU intended for the UHR STA 104.

In some examples, in a second design to eliminate LSIG combining issues, the LSIG length field in each sub-PPDU may be set to the correct format-specific value (for example, LSIG Length % 3=={0,1, or 2} appropriate to its PPDU type), and prior DSO messaging (for example, the information signaling 504 of FIG. 5) may instruct the UHR STA 104 not to combine LSIGs from outside the portion of the FD-APPDU bandwidth allocated to the UHR STA 104 (for example, outside the secondary frequency band). In the second design, as the LSIG Length is correctly encoded for each sub-PPDU, bystander devices (that do not pull in parts of both sub-PPDUs) can properly defer. Some bystander devices that have wider bandwidths than either sub-PPDU may end up doing combined decoding over both sub-PPDUs and fail as a result, which may mean that such bystander devices may not obtain proper LSIG Length info for deferral. In the second design, the intended UHR STA 104 for the PPDU 852 in the secondary frequency band may be able to correctly identify the PPDU type using existing mode auto-detection methods. Prior DSO signaling (for example, the information signaling 504 of FIG. 5) may be used to indicate to the UHR STA 104 the incoming FD-APPDU, and to indicate that the UHR STA 104 should only perform LSIG decoding over the secondary frequency band.

In downlink APPDUs that include an HE format PPDU (such as the PPDU 850) and a UHR format PPDU (such as the PPDU 852), the {U-SIG+EHT-SIG} region of the UHR sub-PPDU may be of same duration as {HE-SIGA+HE-SIGB (if present)} region of HE sub-PPDU, so that 4×OFDM symbol FFT boundaries (the 4×OFDM symbol boundary 880) align and properties of OFDM hold for the entire FD-APPDU duration. Table 13 shows possible design choices for aligning HE format PPDUs and UHR format PPDUs. The design where the HE PPDU is an HE-MU PPDU format, as shown in FIG. 8, may be referred to as approach 1, and the design where the HE PPDU is an HE-SU PPDU may be referred to as approach 2. In both approaches, the UHR sub-PPDU in the secondary frequency band may be designed to align in time with the HE PPDU.

TABLE 13

| HE PPDU Format | HE-MU | HE-SU |
|---|---|---|
| UHR PPDU Format | EHT-MU | New Condensed format |
| | (Compression==1) | based on HE-SIGA |
| | EHT-MU | New Condensed format |
| | (Compression==0) | for U-SIG |

In approach 1, in a first sub-design (referred to as approach 1A), an HE-MU PPDU may be used for an HE STA 104 in the primary frequency band and a UHR-MU-PPDU may be used for a UHR STA 104 in the secondary frequency band. The HE-MU PPDU may use SIG-B compression==1 (in other words, full bandwidth MU-MIMO) and may specify the quantity of users=1. The per user information field quantities may be derived accordingly, and thus HE-SIGB field 870 in the PPDU 850 may span 2 symbols (8 microseconds), which can align with the SU UHR-SIG field across MCSs selected for UHR-SIG 872.

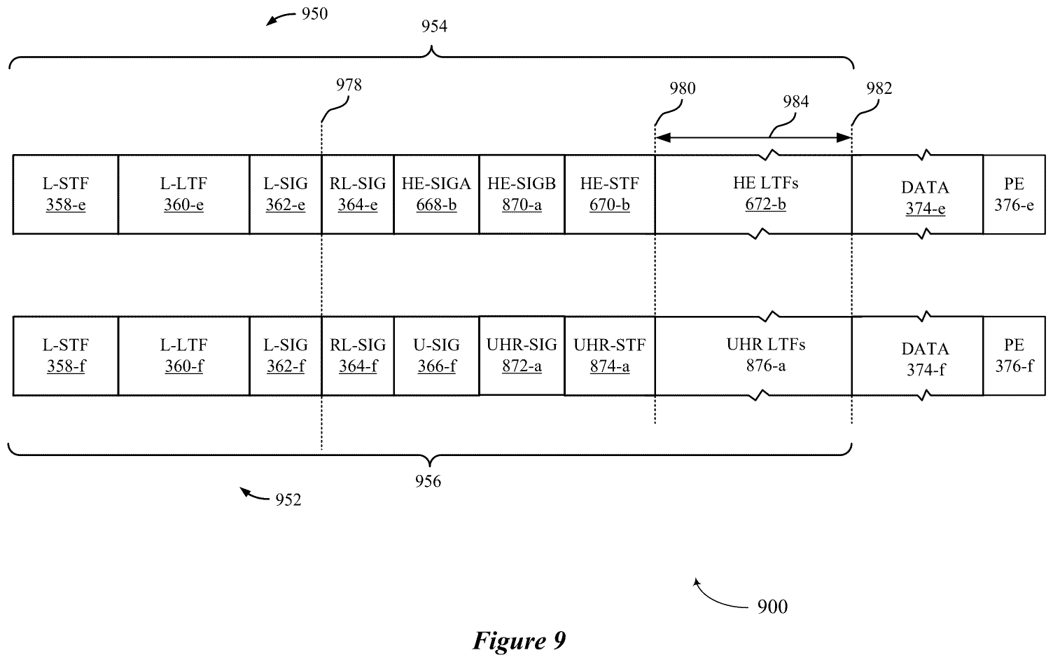

FIG. 9 shows an example of an aggregated downlink PPDU format 900 that supports communication with DSO. The aggregated downlink PPDU format 900 may implement or may be implemented by aspects of the wireless communication network 100, the PPDU 300, or the signaling diagram 500. For example, the aggregated downlink PPDU format 900 shows a PPDU 950 and a PPDU 952. The PPDU 950 may be an example of a downlink PPDU 516 transmitted in the primary frequency band as described with reference to FIG. 5, and the PPDU 952 may be an example of a downlink PPDU 514 transmitted in the secondary frequency band as described with reference to FIG. 5.

The PPDU 950 may be an example of a MU HE PPDU. The PPDU 952 may be an example of a UHR PPDU. The PPDU 950 may include a preamble 954 that includes an L-STF 358-e, an L-LTF 360-e, an L-SIG 362-e, an RL-SIG 364-e, an HE-SIGA field 668-b, an HE-SIGB field 870-a, an HE-STF 670-b, and one or more HE-LTFs 672-b. The PPDU 950 may include a data field 374-e and a PE 376-e. The PPDU 952 may include a preamble 956 that includes an L-STF 358-f, an L-LTF 360-f, an L-SIG 362-f, an RL-SIG 364-f, a U-SIG field 366-f, a UHR-SIG field 872-a, a UHR-STF field 874-a, and one or more UHR-LTFs 876-a. The PPDU 952 may include a data field 374-f and a PE 376-f. The duration 984 of the HE-LTFs 672-b and the UHR-LTFs 876-a may be variable depending on the quantity of HE-LTFs/UHR-LTFs, the GIs, and the quantity of spatial streams. In a downlink APPDU, each of the PPDU 950 and the PPDU 952 may be referred to as a sub-PPDU. To transmit a downlink APPDU including different PPDU formats, such as the PPDU 950 and the PPDU 952, the data symbol boundary 982 should be aligned in time. Similarly, the 4×OFDM symbol boundary 980 before the HE-LTFs 672-a and the UHR-LTFs 876-a should be aligned in time.

FIG. 9 illustrates a second sub-design of approach 1 (referred to as approach 1B) to align the UHR sub-PPDU in the secondary frequency band in time with the HE PPDU. In approach 1B, the PPDU 950 in the primary frequency band may be a HE-MU PPDU and the PPDU 952 in the secondary frequency band may be a UHR-MU PPDU. The HE-MU PPDU may use SIG-B compression==0 (SU OFDMA with a full bandwidth RU). SU implies 58 bits, which produces 3 HE-SIGB symbols using MCS0. Accordingly the HE-SIGB field 870-a may span 3 symbols (12 microseconds). To align the PPDU 952 with the PPDU 950, the EHT/UHR-SIG field 872-a may be set to 3 symbols (12 microseconds), with padding the contents of the EHT/UHR-SIG field 872-a to fill any remaining bits. In approach 1B, UHR320-80 is a 320 MHz UHR MU sub-PPDU with 80 MHz punctured so that the UHR sub-PPDU essentially occupies 240 MHz. Further, the L-SIG 362-e may align with the L-SIG 362-f at time 978 as for the HE MU PPDU (the PPDU 950) Length % 3==2 and for the EHT-MU PPDU (the PPDU 952) length % 3==2.

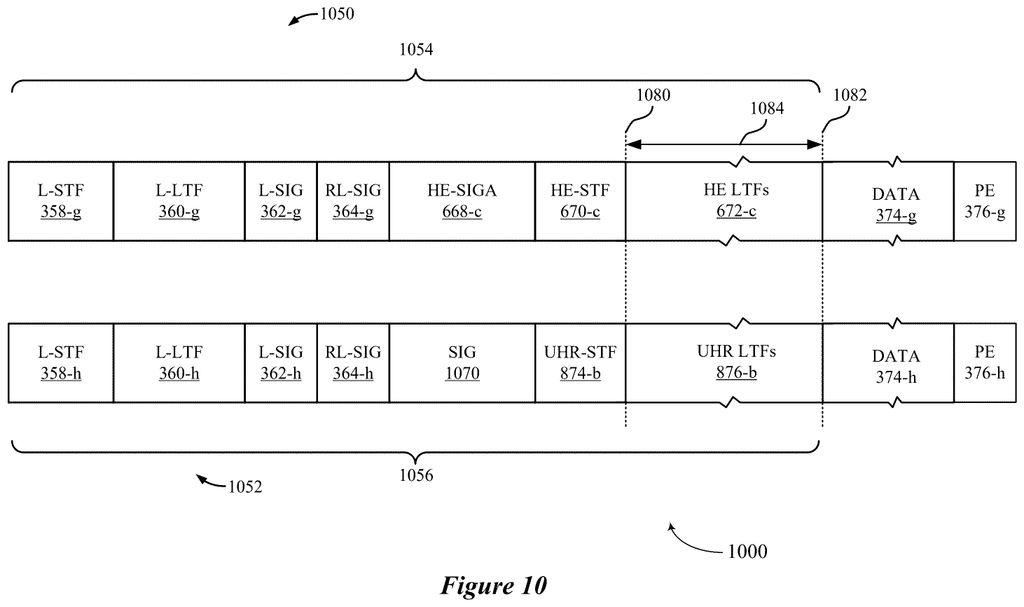

FIG. 10 shows an example of an aggregated downlink PPDU format 1000 that supports communication with DSO. The aggregated downlink PPDU format 1000 may implement or may be implemented by aspects of the wireless communication network 100, the PPDU 300, or the signaling diagram 500. For example, the aggregated downlink PPDU format 1000 shows a PPDU 1050 and a PPDU 1052. The PPDU 1050 may be an example of a downlink PPDU 516 transmitted in the primary frequency band as described with reference to FIG. 5, and the PPDU 1052 may be an example of a downlink PPDU 514 transmitted in the secondary frequency band as described with reference to FIG. 5.

The PPDU 1050 may be an example of a SU HE PPDU. The PPDU 1052 may be an example of a UHR PPDU. The PPDU 1050 may include a preamble 1054 that includes an L-STF 358-g, an L-LTF 360-g, an L-SIG 362-g, an RL-SIG 364-g, an HE-SIGA field 668-c, an HE-STF 670-c, and one or more HE-LTFs 672-c. The PPDU 1050 may include a data field 374-g and a PE 376-g. The PPDU 1052 may include a preamble 1056 that includes an L-STF 358-h, an L-LTF 360-h, an L-SIG 362-h, an RL-SIG 364-h, a SIG field 1070, a UHR-STF field 874-b, and one or more UHR-LTFs 876-b. The PPDU 1052 may include a data field 374-h and a PE 376-h. The duration 1084 of the HE-LTFs 672-c and the UHR-LTFs 876-b may be variable depending on the quantity of HE-LTFs/UHR-LTFs, the GIs, and the quantity of spatial streams. In a downlink APPDU, each of the PPDU 950 and the PPDU 952 may be referred to as a sub-PPDU. To transmit a downlink APPDU including different PPDU formats, such as the PPDU 1050 and the PPDU 1052, the data symbol boundary 1082 should be aligned in time. Similarly, the 4×OFDM symbol boundary 1080 before the HE-LTFs 672-a and the UHR-LTFs 876-b should be aligned in time. In a downlink APPDU, each of the PPDU 1050 and the PPDU 1052 may be referred to as a sub-PPDU.

In approach 2, the PPDU 1050 transmitted in the primary frequency band (for example, the HE PPDU) may be an HE-SU PPDU. In an HE-SU PPDU, as in the PPDU 1050, the HE-SIGA field 668-c spans 2 symbols (8 microseconds). The PPDU 1052 transmitted in the secondary frequency band may use a new condensed PPDU format, where the SIG field 1070 may be 2 symbols (8 microseconds) to align with the HE-SIGA field 668-c. In some examples, the SIG field 1070 may be a HE-SIGA like field for UHR, which may be referred to as approach 2A. For example, the information that would otherwise be included in an EHT-SIG field may be packed into corresponding fields of the SIG field 1070, which would be formatted as an HE-SIGA field, and DSO setup messaging such as the information signaling 504 of FIG. 5. For example, such DSO setup messaging may indicate prior to the FD-APPDU items from the EHT-SIG field that do not fit within the SIG field 1070. The DSO setup messaging may indicate to the receiving STA that the PPDU 1050 in the FD-APPDU contains the format that includes the SIG field 1070. As another example, the SIG field 1070 may be new USIG field and the EHT-SIG information may be packed in to the new USIG field and DSO setup messaging such as the information signaling 504 of FIG. 5, which may be referred to as approach 2B. For example, the DSO setup messaging may include an indication of the information that would be in the EHT-SIG field that does not fit in the new USIG field (the SIG field 1070).

Assuming MCS0 for SIG modulation, both approach 2A and approach 2B fit the 4-symbol USIG+EHT-SIG information into 2 symbols (the SIG field 1070). In addition, with respect to the EHT-SIG field in EHT PPDUs, a UHR-SIG field may include 1 bit-from the disregard field of the U-SIG overflow content to expand the UHR-SIG MCS field from 4-bits to 5-bits. Approach 2A uses HE-SIGA structure for the SIG field 1070 and may appear as an FD-APPDU with 2 or more HE-SU sub PPDUs to bystander devices. Approach 2B follows the U-SIG field structure and may include a new 3-bit PHY version identifier (for example, different from EHT, to indicate UHR) and may include a PPDU type field to indicate the condensed 2-symbol format. Both approach 2A and approach 2B may rely upon prior DSO signaling (for example, the information signaling 504 of FIG. 5) to prepare intended UHR STAs and to signal some information that would otherwise have been carried in USIG and EHT-SIG fields.

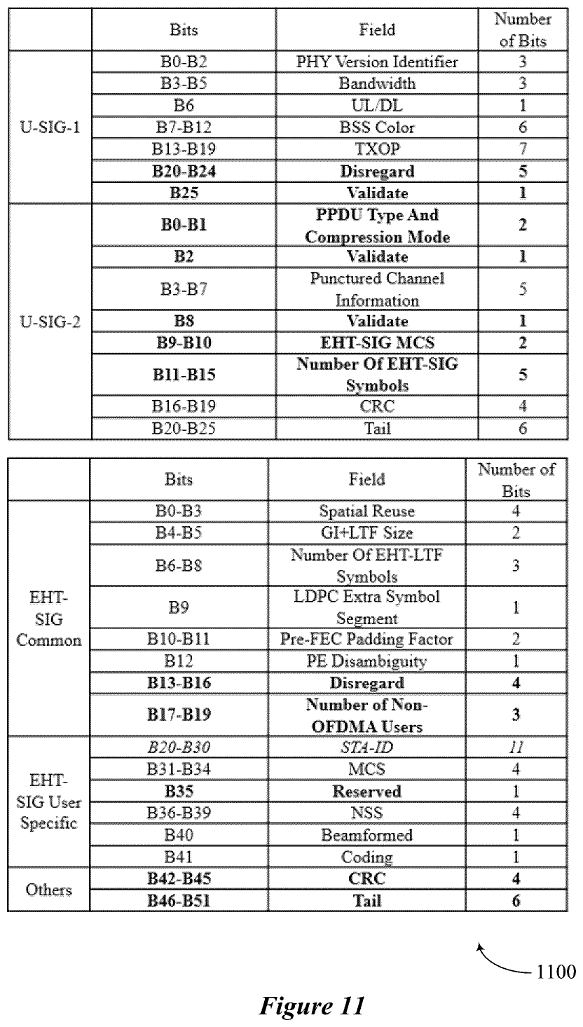

FIG. 11 shows the U-SIG and EHT-SIG fields of an EHT MU PPDU for single user transmission. When the EHT-SIG is transmitted in MCS0 (BPSK, rate 1/2 coding), the EHT-SIG spans 2 OFDM symbols. FIG. 11 shows an example of a fields table 1100 for U-SIG-1, U-SIG-2, and EHT-SIG for a condensed UHR PPDU format that supports communication with DSO.

In approach 2a and approach 2b as described with reference to FIG. 10, some fields in the USIG and EHT-SIG may be removed from the SIG field 1070 and instead may be indicated or configured in DSO setup signaling. Some of the fields in U-SIG and EHT-SIG carry signaling information used by intended and bystander receiving devices. Some fields, corresponding to 35 bits, shown as bolded in FIG. 11, may not be necessary for intended and bystander receiving devices and may be removed from the SIG field 1070 in approach 2A and approach 2B. Such fields may include: U-SIG-1 B20-B24 disregard field including 5 bits; U-SIG-1 B25 validate field including 1 bit; U-SIG-2 B0-B1 PPDU Type and Compression Mode field including 2 bits; U-SIG-2 B2 validate field including 1 bit; U-SIG-2 B8 validate field including 1 bit; U-SIG-2 B9-B10 EHT-SIG MCS field including 2 bits; U-SIG-2 B11-B15 quantity of EHT-SIG symbols including 5 bits; EHT-SIG Common B13-B16 disregard field including 4 bits; EHT-SIG Common B17-B19 Quantity of Non-OFDMA Users field including 3 bits; EHT-SIG User Specific B35 Reserved field including 1 bit; others B42-B45 CRC field including 4 bits; and others B46-B51 tail field including 6 bits. Thus 35 bits may not be needed. As another example, the 11 bit STA-ID field, shown in italics in FIG. 11, may be removed in approach 2A and approach 2B. Such fields include the EHT-SIG User Specific B20-B30 STA-ID field including 11 bits. Removing the fields shown in bold and italics leaves 58 bits, which does not fit into the 2 symbols of the SIG field 1070, when transmitted in MCS0 (BPSK, rate 1/2 coding).

The quantity of bits can be further reduced from 58 bits in approach 2A and approach 2B to no more than 52 bits by combining fields or discarding additional fields.

For example, for approach 2A and approach 2B, the signaling of Quantity of EHT-LTF Symbols (3-bits originally) and NSS (4-bits originally) may be combined to use just 3-bits (saving 4 bits), which may revert to the method used in 802.11ax to jointly indicate both parameters. In approach 2A, this information may be carried by the 3-bit “Nsts and Midamble Periodicity” subfield of HE-SIGA. In approach 2B, this information may be carried in the “Quantity of Spatial Streams (NSS)” subfield of the condensed USIG.

In approach 2A, the 3-bit PHY version identifier subfield may be discarded. Taken with the previous steps, this leads to a total of 51 bits, which results in a savings surplus of 1-bit. This 1-bit will be allocated to expand the MCS field to 5 total bits, which would now enable the UHR sub-PPDU to use the expanded MCS set available for 802.11bn (e.g. 4kQAM, intermediate MCS).

In approach 2B, the 5 bit punctured channel information subfield may be discarded to achieve a net saving of 3 bits. One of those 3 extra bits may be used to expand the MCS field from 4 to 5 bits to bring the MCS field in line with 802.11bn (for example, to support 4kQAM and new MCS support). The remaining 2 extra bits may be used to add back in the PPDU Type and Compression Mode field of the original U-SIG-2. The PPDU Type and Compression Mode may carry an enumerated value to allow for differentiation of this condensed SIG UHR PPDU type with other potential UHR PHY version PPDU types.

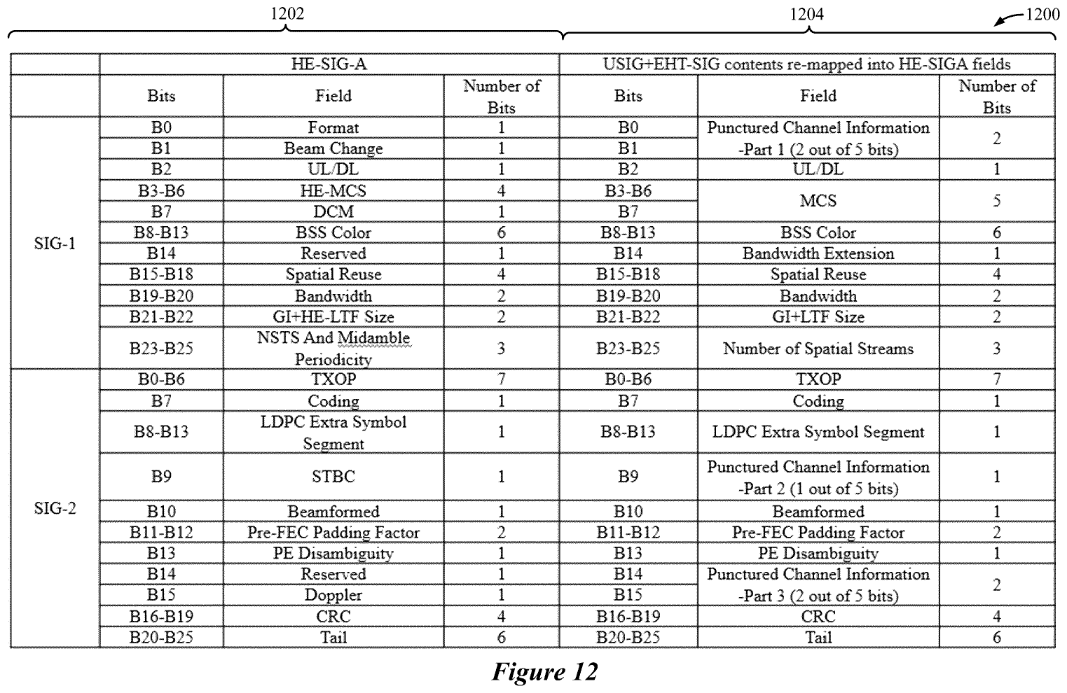

FIG. 12 shows an example of a fields table 1200 for SIG-1 and SIG-2 for a condensed UHR PPDU 2-symbol SIG format that supports communication with DSO. For example, the table 1202 shows the original HE-SIGA format (for example, the HE-SIGA field 668), and the table 1204 shows an example of the modified HE-SIGA format that would be included in the SIG field 1070 of approach 1A. The condensed format may be any variation of table 1204 with different field formats (arrangement of these subfields).

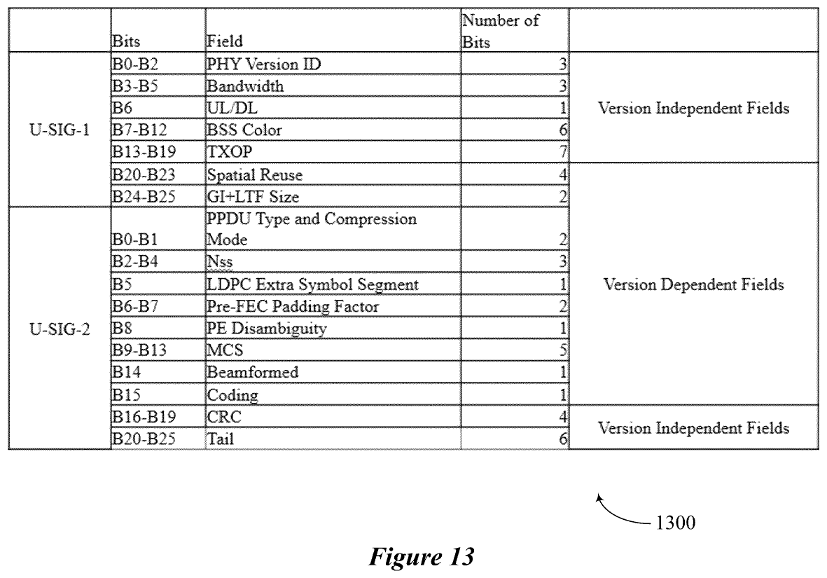

FIG. 13 shows an example of a fields table 1300 for U-SIG for a condensed UHR PPDU 2-symbol U-SIG format that supports communication with DSO. For example, the fields table 1300 for U-SIG for a condensed UHR PPDU format shows the fields included in the SIG field 1070 in approach 2. As shown, the fields table 1300 includes 52 total information bits as there is no other SIG fields such as a UHR-SIG following the U-SIG in approach 2, which 52 total information bits can fit in 2 symbols when transmitted in MCS0 (BPSK, rate 1/2 coding).

An initial 20 bit version independent section of the USIG carries information potentially useful to bystander devices, and this is included in the SIG field 1070 in approach 2A. The PHY version ID may be new/unique as compared to EHT or UHR to indicate the special format used for downlink FD-APPDU. Alternatively, the EHT or UHR enumeration value may be re-used, in which case a subsequent field (for example, in the version-dependent section) may be used to indicate this special format. The version-dependent section may be modified with respect to baseline EHT version dependent fields to carry user specific signaling for the UHR STA 104 in the downlink FD-APPDU. Some of the existing baseline fields may be removed without consequence to the UHR STA 104 in the downlink FD-APPDU for single user UHR. Some fields, such as the 5-bit puncturing channel indication may be carried in prior DSO signaling in downlink FD-APPDU scenarios where puncturing is used. Such prior DSO signaling also may carry other information if/when more features or modes are supported in the UHR portion of a downlink FD-APPDU.

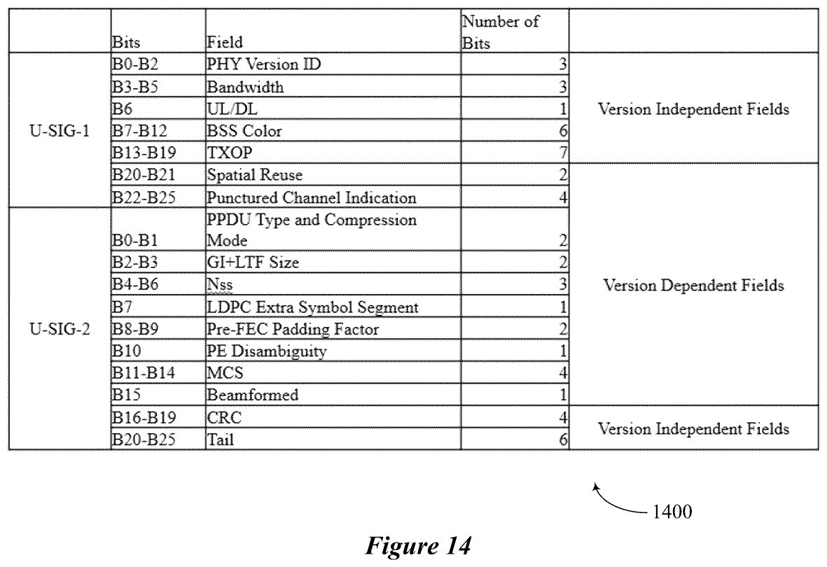

FIG. 14 shows an example of a fields table 1400 for U-SIG for a condensed UHR PPDU 2-symbol U-SIG format that supports communication with DSO. For example, the fields table 1400 for U-SIG for a condensed UHR PPDU format shows the fields included in the SIG field 1070 in an approach 3, which may be similar to approach 2A but avoids DSO setup signaling to carry omitted fields. For example, as shown in the fields table 1400, the punctured channel indication field is included in the USIG symbol 1 and thus would not be indicated in DSO setup signaling. All signaling for a single UHR user in a downlink FD-APPDU may be self-contained in the USIG in the fields shown in the fields table 1400. As shown, the fields table 1400 includes 52 total information bits as there is no other SIG fields such as a UHR-SIG following the U-SIG in approach 3, which 52 total information bits can fit in 2 symbols when transmitted in MCS0 (BPSK, rate 1/2 coding).

In approach 3, the punctured channel indication may be reduced from 5 bits to 4 bits as the maximum bandwidth=160 MHz for this PPDU format in FD-APPDU, reducing puncturing possibilities. To create room for the punctured channel indication, other field sizes may be reduced. For example the spatial reuse field may be reduced from 4 bits to 2 bits as the PPDU format of approach 3 may be a downlink only FD-APPDU format (for example, uplink specific enumerations may be removed from its definition). The 1 bit coding field may also be removed, and the coding type for the following data in the PPDU may be fixed to low density parity check (LDPC) coding (for example, block convolutional coding (BCC) may not be allowed). As another example, the MCS field may be reduced from 5 bits to 4 bits the definition may be reverted to the EHT MCS table (for example, new UHR intermediate MCSs may not be supported in the downlink FD-APPDU format of approach 3).

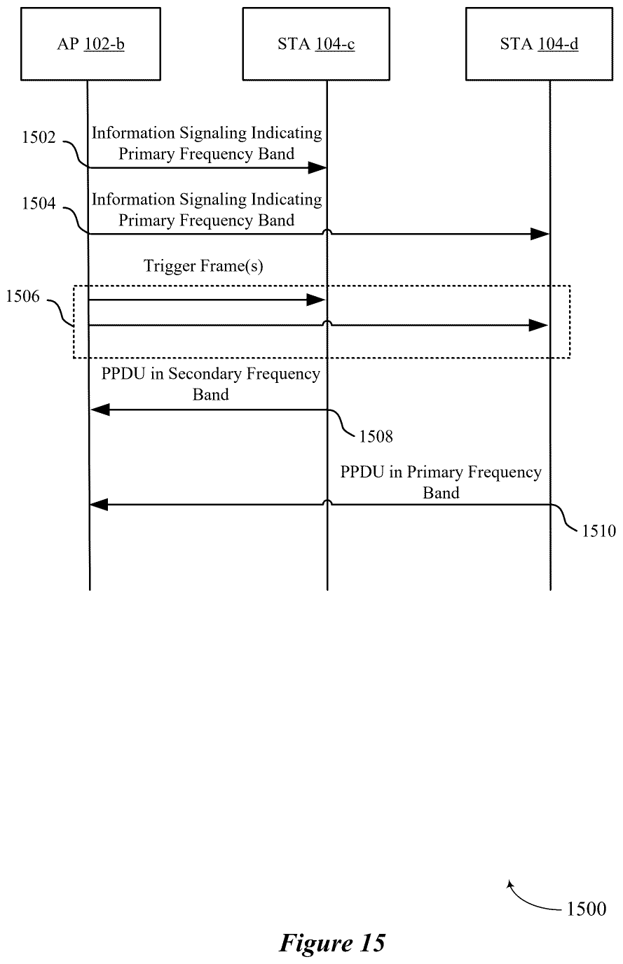

FIG. 15 shows an example of a process flow 1500 that supports communication with DSO. The process flow 1500 may include an AP 102-b, which may be an example of an APs 102 as described herein. The process flow 1500 may include a STA 104-c and a STA 104-d, which may be examples of STAs 104 as described herein. In the following description of the process flow 1500, the operations between the AP 102-b, the STA 104-c, and the STA 104-d may be transmitted in a different order than the example order shown, or the operations performed by the AP 102-b, the STA 104-c, and the STA 104-d may be performed in different orders or at different times. Some operations also may be omitted from the process flow 1500, and other operations may be added to the process flow 1500.

At 1502, the AP 102-b may transmit first information signaling to the STA 104-c that indicates a primary frequency band for communication between the AP 102-b and the STA 104-c.

At 1504, the AP 102-b may transmit second information signaling to the STA 104-d that indicates the primary frequency band for communication between the AP 102-b and the STA 104-d.

At 1506, the AP 102-b may transmit one or more frames (for example, trigger frames) that indicate first scheduling information for a PPDU associated with a first PPDU format and second scheduling information for a second PPDU associated with a second PPDU format. The first scheduling information may indicate that the first PPDU is scheduled for transmission by the STA 104-c and the second scheduling information may indicate that the second PPDU is scheduled for transmission by the STA 104-d. The first scheduling information may indicate a time resource and a secondary frequency band for the first PPDU, where the secondary frequency band does not overlap with the primary frequency band, and the second scheduling information may indicate the same time resource and the primary frequency band.

At 1508, the AP 102-b may receive the first PPDU from the STA 104-c via the time resource and the secondary frequency band.

At 1510, the AP 102-b may receive the second PPDU from the STA 104-d via the time resource and the primary frequency band. For example, the one or more frames may schedule a TB APPDU including the first PPDU in the secondary frequency band and the second PPDU in the primary frequency band.

In some examples, the first PPDU includes a bandwidth field that indicates the secondary frequency band. In some examples, the first PPDU includes a bandwidth field that indicates a total bandwidth that includes the primary frequency band and the secondary frequency band.

In some examples, the one or more frames include a single frame that indicates the first scheduling information and the second scheduling information, and one or more fields of the single frame indicates that the first PPDU has the first PPDU format. For example, the single frame may be a multi-generation trigger frame as described herein.

In some examples, the one or more frames include a first frame transmitted via the primary frequency band and the secondary frequency band, where the first frame indicates the first scheduling information, and where the first frame includes an indication of a first identifier associated with the second wireless node. In such examples, the one or more frames may include a second frame transmitted via the primary frequency band and the secondary frequency band, where the second frame indicates the second scheduling information, and where the second frame includes an indication of a second identifier associated with the third wireless node.

In some examples, the one or more frames include a first frame transmitted via the secondary frequency band and a second time resource, where the first frame indicates the first scheduling information, and where the first information signaling at 1502 includes an indication of the secondary frequency band; and the one or more frames include a second frame transmitted via the primary frequency band and the second time resource, where the second frame indicates the second scheduling information.

In some examples, the one or more frames include a first frame that at least one of: includes a first set of bits in a common information field of the first frame that in combination with a second set of bits in a user information field of the first frame and a PHY version identifier of the first frame indicate the first PPDU has the first PPDU format, and the first frame indicates the first scheduling information. In some examples, the first set of bits includes a common information field bit 54 and a common information field bit 55, and the second set of bits includes a user information field bit 39 or a PS160 field.

In some examples, the one or more frames include a first frame, and the first frame includes a bandwidth field and a bandwidth extension field that in combination indicate to use the secondary frequency band for the first PPDU. In some examples, the first frame includes a user information field that indicates a resource unit for the first PPDU in the secondary frequency band. For example, the B39 in the user information field may indicate the resource unit for the first PPDU in the secondary frequency band. In some examples, the one or more frames includes a first frame that includes a set of multiple special user info fields each indicative of a respective PPDU format. For example, a first special user info field may be indicative of the first PPDU format and a second special user info field may be indicative of the second PPDU format. In some examples, the set of multiple special user info fields are located after a common information field of the first frame. In some examples, a first special user info field of the set of multiple special user info fields indicates that the first PPDU has the first PPDU format and is followed by a first set of user information fields that indicate stations of associated with the first PPDU format, and the first special user info field is indicative of a first format of the first set of user information fields, and a second special user info field of the set of multiple special user info fields indicates that the second PPDU has the second PPDU format and is followed by a second set of user information fields that indicate stations of associated with the second PPDU format, and the second special user info field is indicative of a second format of the second set of user information fields. In some examples, one or more AID12 field values in the first frame are indicative of a presence of the set of multiple special user info fields in the first frame. In some examples, the first frame includes at least one of: a “quantity of additional special user info fields” subfield which indicates a quantity of special user info fields of the set of multiple special user info fields after a first special user info field; or a “total quantity of special user info fields” subfield which indicates a quantify of special user info fields of the plurality of special user info fields in the first frame. In some examples, each special user info field of the set of multiple special user info fields indicates a presence or absence of a subsequent special user info field in the first frame. In some examples, each special user info field may include a subfield indicating a size of the special user info field and each user information field in the following set of user information fields that indicate stations of associated with the same PPDU format as in the special user info field. In some examples, the subfield indicating the size of the special user info field and each user information field in the following set of user information fields that indicate stations of associated with the same PPDU format as in the special user info field may indicate an increment with respect to a default user info field size (for example, an increment with respect to 5 octets). In some examples, the size of each special user info field may be the same and unchanged, and each special user info field may include a subfield indicating a size of each user information field in the following set of user information fields that indicate stations of associated with the same PPDU format as in the special user info field. In some examples, the subfield indicating the size of each user information field in the following set of user information fields that indicate stations of associated with the same PPDU format as in the special user info field may indicate an increment with respect to a default user info field size (for example, an increment with respect to 5 octets).

In some examples, the one or more frames includes a first frame that includes two user info fields indicative of the first PPDU format, each of the two user info fields including five octets positioned before a trigger dependent user info subfield, and at least one of: both of the two user info fields include a same value in an AID12 subfield indicative of a same station; first user info field of the two user info fields carries a first subfield that is not carried in a second user info field of the two user info fields; the second user info field carries a second subfield that is not carried in the first user info field; both of the two user info fields include a same value in a PS160 subfield; both of the two user info fields include a same value in a resource unit allocation subfield indicating the secondary frequency band; or both of the two user info fields include a same value in a spatial stream allocation subfield.

In some examples, the one or more frames include a first frame that includes a set of multiple user info fields, one special user info field of the plurality of user info fields including a physical layer identifier subfield value indicative of the first PPDU format other than a high efficiency or extremely high throughput format, and one or more block octets comprising a B11 value set to 1, and a size of the block octets may be five octets plus a size of a Trigger Dependent User Info subfield if present. In some examples, a 1-bit reserved value may be periodically set to 1 to indicate to HE and EHT STAs interpret the AID12 subfield value not matching their station identifications. For example, if the Trigger Dependent User Info subfield is absent, the B11 of each 5-octet block may be a reserved bit set it to 1. For another example, if the Trigger Dependent User Info subfield is present, the B11 of each block, whose size is 5 octets plus the size of the Trigger Dependent User Info subfield, may be a reserved bit and set to 1. When HE and EHT STAs interpret the 5-octet block before the Trigger Dependent User Info subfield (if present), B0-B11 are the AID12 subfield they assume. By setting B11 to 1, the AID12 value would be from 2048 to 4095. Therefore, HE and EHT STAs see either reserved values of AID12 or the “Start of Padding field” identified by a value of 4095, and thus would not falsely identify the values to match their own STA identifications.

In some examples, the one or more frames includes a first frame that includes a set of multiple user info fields, one special user info field of set of multiple user info fields including a physical layer identifier value indicative of the first PPDU format and including an AID12 value set to 4095 or 2007, and user info fields of the set of multiple user info fields subsequent to the one special user info field associated with one or more PPDU formats other than an HE or EHT format. For example, HE STAs only knows the HE variant user info field format and interpret all user info fields according to the HE variant user info field format. If no special user info fields is present, EHT, UHR and beyond STAs may interpret user fields according to the HE variant user info field format. If a special user info field is present, EHT and UHR STAs may interpret a following user info field according to the HE variant user info field format if B39 in the user info field is set to 0 and B54 in the common info field is set to 1. In other cases, when a special user info field is present, EHT STAs may interpret all following user fields according to the EHT variant user info field format. In other cases, when at least one special user field is present, UHR STAs may look at the one or more values of PHY Version Identifiers to determine the user info field format to interpret. For example, in other cases, when there is only one special user info field with PHY Version Identifier set to EHT, UHR STAs may interpret other use info fields according to the EHT variant user info field format. In other cases, when there is a special user info field with PHY Version Identifier set to UHR, UHR STAs will interpret any following user info fields according to the UHR variant user info field format. UHR and beyond generations may use a different AID12 value (for example, 4094) to indicate “Start of Padding field,” because the original “4095” value viewed by HE and EHT STAs 104 to indicate the “Start of Padding field” may no longer work for HE and EHT STAs to indicate the “Start of Padding field”.

In some examples, the first PPDU format and the second PPDU format are a same PPDU format (for example, are from a same 802.11 generation).

In some examples, the one or more frames includes first frame, the first frame includes a bandwidth field and a bandwidth extension field that in combination indicate a bandwidth for the first PPDU, the primary frequency band and the secondary frequency band each have the bandwidth, and the first information signaling indicates for the STA 104-c to interpret the bandwidth field in combination with the bandwidth extension field as indicating the secondary frequency band.

In some examples, the one or more frames includes first frame, the first frame includes a bandwidth field and a bandwidth extension field that in combination indicate a bandwidth that includes the primary frequency band and the secondary frequency band, and the first frame indicates the first scheduling information.

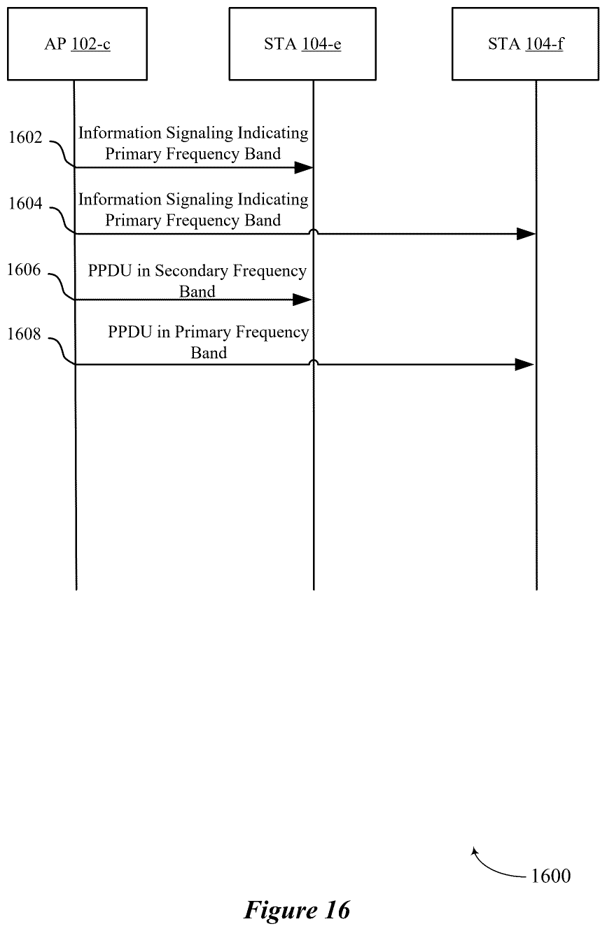

FIG. 16 shows an example of a process flow 1600 that supports communication with DSO. The process flow 1600 may include an AP 102-c, which may be an example of an APs 102 as described herein. The process flow 1600 may include a STA 104-e and a STA 104-f, which may be examples of STAs 104 as described herein. In the following description of the process flow 1600, the operations between the AP 102-c, the STA 104-e, and the STA 104-f may be transmitted in a different order than the example order shown, or the operations performed the AP 102-c, the STA 104-e, and the STA 104-f may be performed in different orders or at different times. Some operations also may be omitted from the process flow 1600, and other operations may be added to the process flow 1600.

At 1602, the AP 102-c may transmit first information signaling to the STA 104-e that indicates a primary frequency band for communication between the AP 102-c and the STA 104-c and a secondary frequency band outside of (for example, does not overlap with) the primary frequency band.

At 1604, the AP 102-c may transmit second information signaling to the STA 104-f that indicates the primary frequency band for communication between the AP 102-c and the STA 104-f.

At 1606, the AP 102-c may transmit a first PPDU associated with a first PPDU format via a time resource and the secondary frequency band. A first preamble of the first PPDU may indicate that the first PPDU is intended for the STA 104-e.

At 1608, the AP 102-c may transmit a second PPDU associated with a second PPDU format via the same time resource and the primary frequency band. A second preamble of the second PPDU may indicate that the second PPDU is intended for the STA 104-f. For example, the first PPDU and the second PPDU may be a downlink FD-APPDU.

In some examples, a first legacy signal length field in the first preamble indicates a same value as a second legacy signal length field in the second preamble.

In some examples, the first information signaling includes an indication to the STA 104-e to refrain from combining legacy signal length fields associated with the primary frequency band and the secondary frequency band, the first preamble includes a first legacy signal length field that indicates a first value associated with the first PPDU format, and the second preamble includes a second legacy signal length field that indicates a second value associated with the second PPDU format.

In some examples, the first PPDU format includes an EHT PPDU format, the second PPDU format includes a HE MU PPDU format, a signal field B of the second preamble is associated with a compression mode 1, and the second preamble indicates a quantity of one or more users is equal to one.

In some examples, the first PPDU format includes an extremely high-throughput PPDU format, a universal signal field of the first preamble indicates that a modulation and coding scheme 0 is applicable for a signal field of the first PPDU, the second PPDU format includes a HE MU PPDU format, and a signal field B of the second preamble is associated with a compression mode.

In some examples, the second PPDU format is a HE SU PPDU, the first preamble includes a signal field that spans two symbols, and the signal field includes a first subset of information associated with a universal signal field format associated with an EHT PPDU format. In some examples, the first information signaling includes an indication of a second subset of information associated with the universal signal field format. In some examples, the first subset of information omits an identifier field for the second wireless node, the signal field includes three bits that jointly indicate at least one of a quantity of EHT LTF symbols of the first preamble or a quantity of spatial streams associated with the first PPDU, or a physical layer identifier field of the first preamble indicates a non-EHT format for the first PPDU. For example, a physical layer identifier field of the first preamble may indicate UHR. In some examples, at least one of: the first subset of information omits a physical layer identifier field, or the first subset of information omits a punctured channel information subfield. In some examples, the first subset of information includes at least one of a 2 bit spatial reuse field, a 4 bit punctured channel indication field, or a 4 bit modulation and coding scheme field.

In some examples, a first signal field within the first preamble aligns in time with a second signal field of the second preamble.

In some examples, the first PPDU includes a bandwidth field in the first preamble that indicates the secondary frequency band.

In some examples, the first PPDU includes a bandwidth field in the first preamble that indicates the primary frequency band and the secondary frequency band, or a resource allocation field in the first preamble indicates at least one of an assignment of a resource unit within the secondary frequency band for the first PPDU or that the primary frequency band is punctured for the first PPDU.

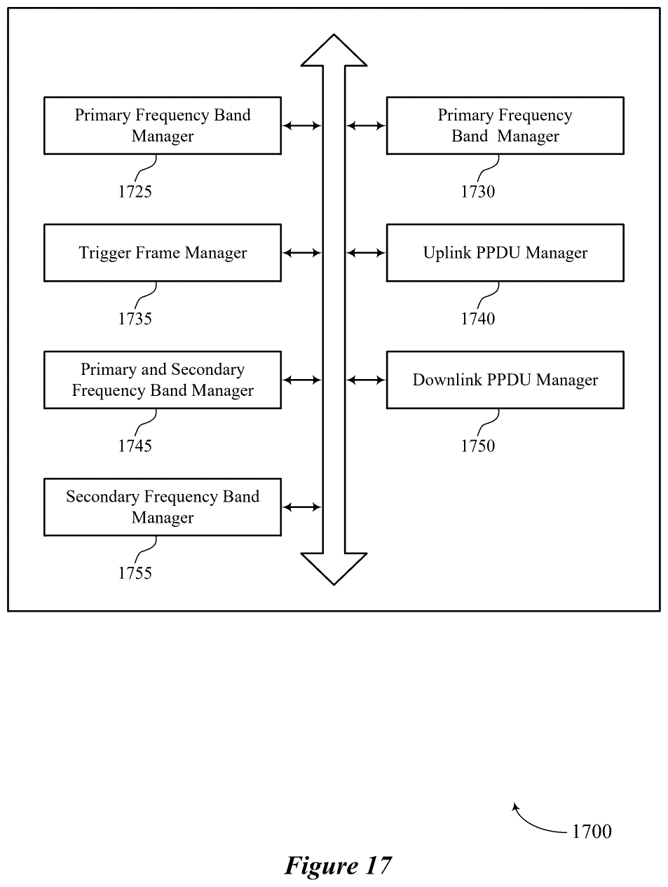

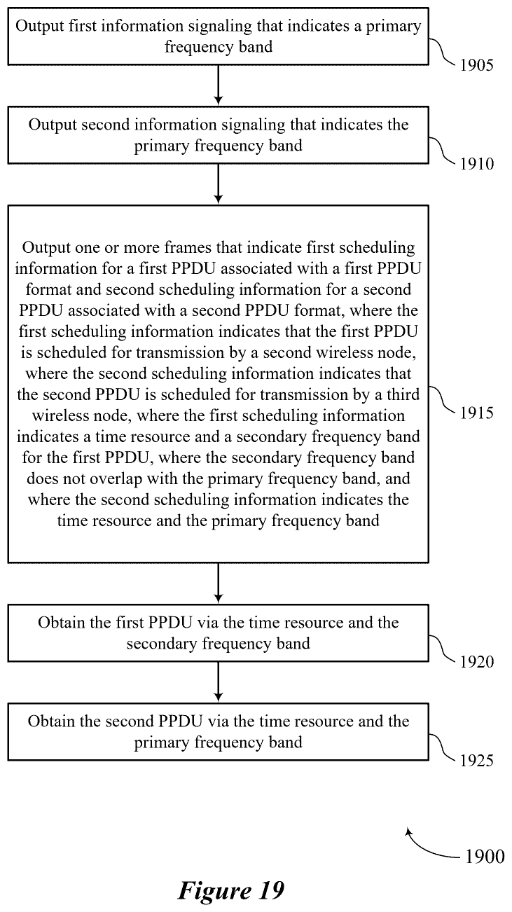

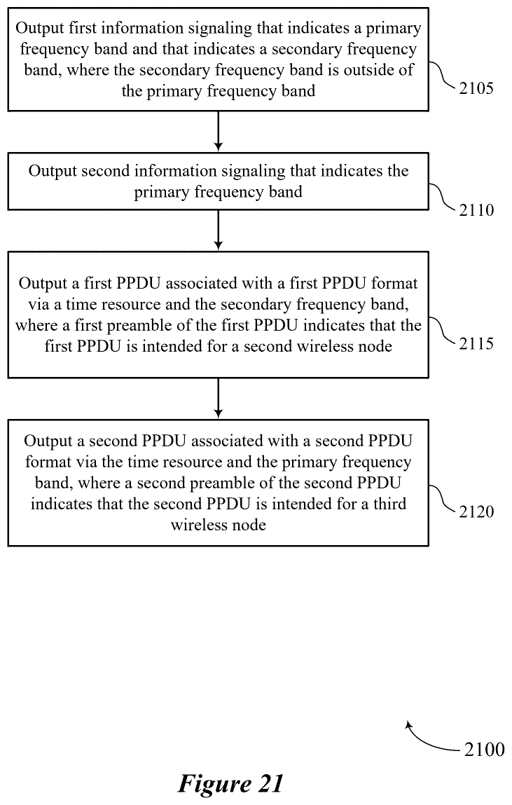

FIG. 17 shows a block diagram of an example wireless communication device 1700 that supports communication with DSO. In some examples, the wireless communication device 1700 is configured to perform the processes 1900 and 2100 described with reference to FIGS. 19 and 21, respectively. The wireless communication device 1700 may include one or more chips, SoCs, chipsets, packages, components or devices that individually or collectively constitute or include a processing system. The processing system may interface with other components of the wireless communication device 1700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1700 may transmit the information output from the chip. In such an example, the second interface may refer to an interface between the processing system of the chip and a reception component, such that the wireless communication device 1700 may receive information that is then passed to the processing system. In some such examples, the first interface also may obtain information, such as from the transmission component, and the second interface also may output information, such as to the reception component.

Further, various components of the wireless communication device 1700 may provide means for performing the methods described herein. In some examples, means for transmitting and/or receiving may include the transceivers and/or antenna(s) of the wireless communication device 1700. In some examples, means for outputting or sending (such as means for outputting for transmission) and means for obtaining (such as means for obtaining after information is received from a different device) may include one or more interfaces of the wireless communication device 1700 to output signals to other components or obtain signals from other components of the wireless communication device 1700. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for outputting, means for obtaining, means for transmitting, and means for receiving include a processing system, processor circuitry (including one or more processors), memory circuitry, and/or computer-readable media of the wireless communication device 1700.

The processing system of the wireless communication device 1700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1700 can be configurable or configured for use in an AP, such as the AP 102 described with reference to FIG. 1. In some other examples, the wireless communication device 1700 can be an AP that includes such a processing system and other components including multiple antennas. The wireless communication device 1700 is capable of transmitting and receiving wireless communications in the form of, for example, wireless packets. For example, the wireless communication device 1700 can be configurable or configured to transmit and receive packets in the form of physical layer PPDUs and MPDUs conforming to one or more of the IEEE 802.11 family of wireless communication protocol standards. In some other examples, the wireless communication device 1700 can be configurable or configured to transmit and receive signals and communications conforming to one or more 3GPP specifications including those for 5G NR or 6G. In some examples, the wireless communication device 1700 also includes or can be coupled with one or more application processors which may be further coupled with one or more other memories. In some examples, the wireless communication device 1700 further includes at least one external network interface coupled with the processing system that enables communication with a core network or backhaul network that enables the wireless communication device 1700 to gain access to external networks including the Internet.

The wireless communication device 1700 includes a primary frequency band manager 1725, a primary frequency band manager 1730, a trigger frame manager 1735, an uplink PPDU manager 1740, a primary and secondary frequency band manager 1745, a downlink PPDU manager 1750, and a secondary frequency band manager 1755. Portions of one or more of the primary frequency band manager 1725, the primary frequency band manager 1730, the trigger frame manager 1735, the uplink PPDU manager 1740, the primary and secondary frequency band manager 1745, the downlink PPDU manager 1750, and the secondary frequency band manager 1755 may be implemented at least in part in hardware or firmware. For example, one or more of the primary frequency band manager 1725, the primary frequency band manager 1730, the trigger frame manager 1735, the uplink PPDU manager 1740, the primary and secondary frequency band manager 1745, the downlink PPDU manager 1750, and the secondary frequency band manager 1755 may be implemented at least in part by at least a processor or a modem. In some examples, portions of one or more of the primary frequency band manager 1725, the primary frequency band manager 1730, the trigger frame manager 1735, the uplink PPDU manager 1740, the primary and secondary frequency band manager 1745, the downlink PPDU manager 1750, and the secondary frequency band manager 1755 may be implemented at least in part by a processor and software in the form of processor-executable code stored in memory.

The wireless communication device 1700 may support wireless communications in accordance with examples as disclosed herein. The primary frequency band manager 1725 is configurable or configured to output first information signaling that indicates a primary frequency band. The primary frequency band manager 1730 is configurable or configured to output second information signaling that indicates the primary frequency band. The trigger frame manager 1735 is configurable or configured to output one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band. The uplink PPDU manager 1740 is configurable or configured to obtain the first PPDU via the time resource and the secondary frequency band. In some examples, the uplink PPDU manager 1740 is configurable or configured to obtain the second PPDU via the time resource and the primary frequency band.

In some examples, the first PPDU includes a bandwidth field that indicates the secondary frequency band.

In some examples, the first PPDU includes a bandwidth field that indicates a total bandwidth that includes the primary frequency band and the secondary frequency band.

In some examples, the one or more frames includes a single frame that indicates the first scheduling information and the second scheduling information. In some examples, one or more fields of the single frame indicates that the first PPDU has the first PPDU format.

In some examples, to support outputting the one or more frames, the trigger frame manager 1735 is configurable or configured to output a first frame via the primary frequency band and the secondary frequency band, where the first frame indicates the first scheduling information, and where the first frame includes an indication of a first identifier associated with the second wireless node. In some examples, to support outputting the one or more frames, the trigger frame manager 1735 is configurable or configured to output a second frame via the primary frequency band and the secondary frequency band, where the second frame indicates the second scheduling information, and where the second frame includes an indication of a second identifier associated with the third wireless node.

In some examples, to support outputting the one or more frames, the trigger frame manager 1735 is configurable or configured to output a first frame via the secondary frequency band and a second time resource, where the first frame indicates the first scheduling information, and where the first information signaling includes an indication of the secondary frequency band. In some examples, to support outputting the one or more frames, the trigger frame manager 1735 is configurable or configured to output a second frame via the primary frequency band and the second time resource, where the second frame indicates the second scheduling information.

In some examples, the one or more frames includes a first frame that at least one of: includes a first set of bits in a common information field of the first frame that in combination with a second set of bits in a user information field of the first frame and a physical layer version identifier in a special user info field of the first frame indicate the first PPDU has the first PPDU format, or indicates the first scheduling information.

In some examples, the first set of bits include a common information field bit 54 and a common information field bit 55, and the second set of bits include a user information field bit 39 or a PS160 field.

In some examples, the one or more frames includes a first frame that includes a set of multiple special user info fields each indicative of a respective PPDU format. In some examples, the set of multiple special user info fields are located after a common information field of the first frame. In some examples, a first special user info field of the set of multiple special user info fields indicates that the first PPDU has the first PPDU format and is followed by a first set of user information fields that indicate stations of associated with the first PPDU format, and the first special user info field is indicative of a first format of the first set of user information fields, and a second special user info field of the set of multiple special user info fields indicates that the second PPDU has the second PPDU format and is followed by a second set of user information fields that indicate stations of associated with the second PPDU format and the second special user info field is indicative of a second format of the second set of user information fields. In some examples, one or more AID12 field values in the first frame may be indicative of a presence of the set of multiple special user info fields in the first frame. In some examples, the first frame includes at least one of: a quantity of additional special user info fields field which indicates a quantity of special user info fields of the set of multiple special user info fields after a first special user info field; or a total quantity of special user info fields field which indicates a quantify of special user info fields of the plurality of special user info fields in the first frame. In some examples, each special user info field of the set of multiple special user info fields indicates a presence or absence of a subsequent special user info field in the first frame. In some examples, each special user info field of the set of multiple special user info fields includes at least one of: a respective size of each user info field after a current special user info field and before a next special user info field if present or a Padding field if the current special user info field is a last special user info field, or a respective size of the current special user info field.

In some examples, the one or more frames includes a first frame that includes two user info fields indicative of the first PPDU format, each of the two user info fields including five octets and positioned before a trigger dependent user info field, and at least one of: both of the two user info fields include a same value in an AID12 subfield indicative of a same station; first user info field of the two user info fields carries a first subfield that is not carried in a second user info field of the two user info fields; the second user info field carries a second subfield that is not carried in the first user info field; both of the two user info fields include a same value in a PS160 subfield; both of the two user info fields include a same value in a resource unit allocation subfield indicating the secondary frequency band; or both of the two user info fields include a same value in a spatial stream allocation subfield.

In some examples, the one or more frames include a first frame that includes a set of multiple user info fields, one special user info field of the plurality of user info fields including a physical layer identifier subfield value indicative of the first PPDU format other than a high efficiency or extremely high throughput format, and one or more block octets comprising a B11 value set to 1, and a size of the block octets may be five octets plus a size of a Trigger Dependent User Info subfield if present.

In some examples, the one or more frames includes a first frame that includes a set of multiple user info fields, one user info field of set of multiple user info fields including a physical layer identifier value indicative of the first PPDU format and including an AID12 value set to 4095 or 2007, and user info fields of the set of multiple user info fields subsequent to the one user info field associated with one or more PPDU formats other than an HE or EHT format.

In some examples, the first PPDU format and the second PPDU format are a same PPDU format.

In some examples, the one or more frames includes a first frame. In some examples, the first frame includes a physical layer version identifier field that indicates the first PPDU has the first PPDU format.

In some examples, the one or more frames includes a first frame. In some examples, the first frame includes a bandwidth field and a bandwidth extension field that in combination indicate to use the secondary frequency band for the first PPDU.

In some examples, the first frame includes a user information field that indicates resource unit for the first PPDU in the secondary frequency band.

In some examples, the one or more frames includes first frame. In some examples, the first frame includes a bandwidth field and a bandwidth extension field that in combination indicate a bandwidth for the first PPDU. In some examples, the primary frequency band and the secondary frequency band each have the bandwidth. In some examples, the first information signaling indicates for the second wireless node to interpret the bandwidth field in combination with the bandwidth extension field as indicating the secondary frequency band.

In some examples, the one or more frames includes first frame. In some examples, the first frame includes a bandwidth field and a bandwidth extension field that in combination indicate a bandwidth that includes the primary frequency band and the secondary frequency band. In some examples, the first frame indicates the first scheduling information.

Additionally, or alternatively, the wireless communication device 1700 may support wireless communications in accordance with examples as disclosed herein. The primary and secondary frequency band manager 1745 is configurable or configured to output first information signaling that indicates a primary frequency band and that indicates a secondary frequency band, where the secondary frequency band is outside of the primary frequency band. In some examples, the primary frequency band manager 1725 is configurable or configured to output second information signaling that indicates the primary frequency band. The downlink PPDU manager 1750 is configurable or configured to output a first PPDU associated with a first PPDU format via a time resource and the secondary frequency band, where a first preamble of the first PPDU indicates that the first PPDU is intended for a second wireless node. In some examples, the downlink PPDU manager 1750 is configurable or configured to output a second PPDU associated with a second PPDU format via the time resource and the primary frequency band, where a second preamble of the second PPDU indicates that the second PPDU is intended for a third wireless node.

In some examples, a first legacy signal length field in the first preamble indicates a same value as a second legacy signal length field in the second preamble.

In some examples, the first information signaling includes an indication to the second wireless node to refrain from combining legacy signal length fields associated with the primary frequency band and the secondary frequency band. In some examples, the first preamble includes a first legacy signal length field that indicates a first value associated with the first PPDU format. In some examples, the second preamble includes a second legacy signal length field that indicates a second value associated with the second PPDU format.

In some examples, the first PPDU format includes an extremely high-throughput PPDU format, the second PPDU format includes a HE MU PPDU format, a signal field B of the second preamble is associated with a compression mode 1, and the second preamble indicates a quantity of one or more users is equal to one.

In some examples, the first PPDU format includes an extremely high-throughput PPDU format, a universal signal field of the first preamble indicates that a modulation and coding scheme 0 is applicable for a signal field of the first PPDU, the second PPDU format includes a HE MU PPDU format, and a signal field B of the second preamble is associated with a compression mode.

In some examples, the second PPDU format is a HE SU PPDU, the first preamble includes a signal field that spans two symbols, and the signal field includes a first subset of information associated with a universal signal field format associated with an EHT PPDU format.

In some examples, the first information signaling includes an indication of a second subset of information associated with the universal signal field format.

In some examples, the first subset of information omits an identifier field for the second wireless node, the signal field includes three bits that jointly indicate at least one of a quantity of EHT LTF symbols of the first preamble or a quantity of spatial streams associated with the first PPDU, or a physical layer identifier field of the first preamble indicates a non-EHT format for the first PPDU.

In some examples, the first subset of information omits a physical layer identifier field, or the first subset of information omits a punctured channel information subfield.

In some examples, the first subset of information includes at least one of a 2 bit spatial reuse field, a 4 bit punctured channel indication field, or a 4 bit modulation and coding scheme field.

In some examples, a first signal field within the first preamble aligns in time with a second signal field of the second preamble.

In some examples, the first PPDU includes a bandwidth field in the first preamble that indicates the secondary frequency band.

In some examples, the first PPDU includes a bandwidth field in the first preamble that indicates the primary frequency band and the secondary frequency band, or a resource allocation field in the first preamble indicates at least one of an assignment of a resource unit within the secondary frequency band for the first PPDU or that the primary frequency band is punctured for the first PPDU.

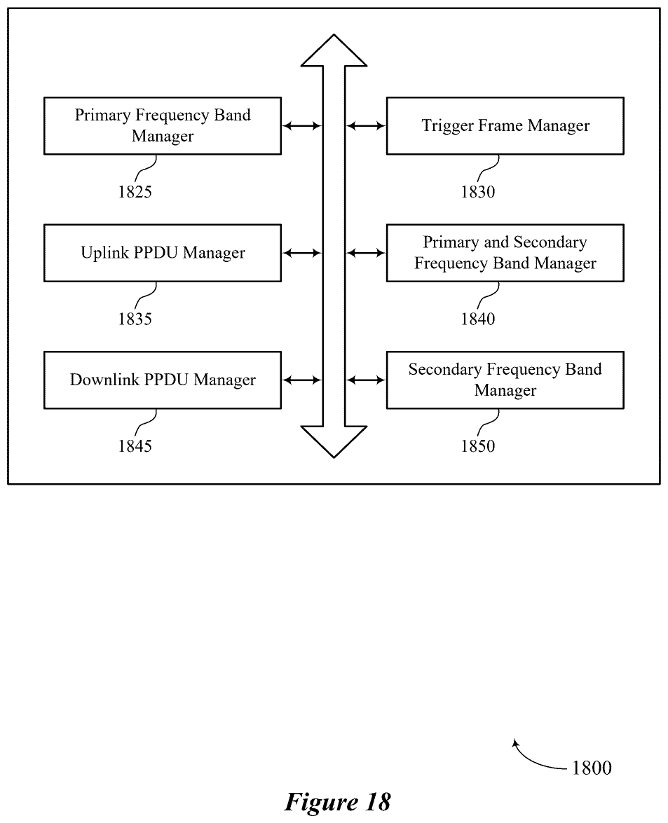

FIG. 18 shows a block diagram of an example wireless communication device 1800 that supports communication with DSO. In some examples, the wireless communication device 1800 is configured to perform the processes 1900 and 2100 described with reference to FIGS. 19 and 21, respectively. The wireless communication device 1800 may include one or more chips, SoCs, chipsets, packages, components or devices that individually or collectively constitute or include a processing system. The processing system may interface with other components of the wireless communication device 1800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1800 may transmit the information output from the chip. In such an example, the second interface may refer to an interface between the processing system of the chip and a reception component, such that the wireless communication device 1800 may receive information that is then passed to the processing system. In some such examples, the first interface also may obtain information, such as from the transmission component, and the second interface also may output information, such as to the reception component.

Further, various components of the wireless communication device 1700 may provide means for performing the methods described herein. In some examples, means for transmitting and/or receiving may include the transceivers and/or antenna(s) of the wireless communication device 1700. In some examples, means for outputting or sending (such as means for outputting for transmission) and means for obtaining (such as means for obtaining after information is received from a different device) may include one or more interfaces of the wireless communication device 1700 to output signals to other components or obtain signals from other components of the wireless communication device 1700. For example, a processor (of a processing system) may output (such as provide) signals and/or data, via a bus interface, to a radio frequency front end for transmission. Similarly, rather than actually receiving signals and/or data, a device may have an interface to obtain the signals and/or data received from another device (a means for obtaining). For example, a processor (of a processing system) may obtain (or receive) the signals and/or data, via a bus interface, from a radio frequency front end for reception. In various aspects, a radio frequency front end may include various components, including transmit and receive processors, transmit and receive MIMO processors, modulators, demodulators, and the like. Each of means for outputting, means for obtaining, means for transmitting, and means for receiving include a processing system, processor circuitry (including one or more processors), memory circuitry, and/or computer-readable media of the wireless communication device 1800.

The processing system of the wireless communication device 1800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1800 can be configurable or configured for use in a STA, such as the STA 104 described with reference to FIG. 1. In some other examples, the wireless communication device 1800 can be a STA that includes such a processing system and other components including multiple antennas. The wireless communication device 1800 is capable of transmitting and receiving wireless communications in the form of, for example, wireless packets. For example, the wireless communication device 1800 can be configurable or configured to transmit and receive packets in the form of physical layer PPDUs and MPDUs conforming to one or more of the IEEE 802.11 family of wireless communication protocol standards. In some other examples, the wireless communication device 1800 can be configurable or configured to transmit and receive signals and communications conforming to one or more 3GPP specifications including those for 5G NR or 6G. In some examples, the wireless communication device 1800 also includes or can be coupled with one or more application processors which may be further coupled with one or more other memories. In some examples, the wireless communication device 1800 further includes a user interface (UI) (such as a touchscreen or keypad) and a display, which may be integrated with the UI to form a touchscreen display that is coupled with the processing system. In some examples, the wireless communication device 1800 may further include one or more sensors such as, for example, one or more inertial sensors, accelerometers, temperature sensors, pressure sensors, or altitude sensors, that are coupled with the processing system.

The wireless communication device 1800 includes a primary frequency band manager 1825, a trigger frame manager 1830, an uplink PPDU manager 1835, a primary and secondary frequency band manager 1840, a downlink PPDU manager 1845, and a secondary frequency band manager 1850. Portions of one or more of the primary frequency band manager 1825, the trigger frame manager 1830, the uplink PPDU manager 1835, the primary and secondary frequency band manager 1840, the downlink PPDU manager 1845, and the secondary frequency band manager 1850 may be implemented at least in part in hardware or firmware. For example, one or more of the primary frequency band manager 1825, the trigger frame manager 1830, the uplink PPDU manager 1835, the primary and secondary frequency band manager 1840, the downlink PPDU manager 1845, and the secondary frequency band manager 1850 may be implemented at least in part by at least a processor or a modem. In some examples, portions of one or more of the primary frequency band manager 1825, the trigger frame manager 1830, the uplink PPDU manager 1835, the primary and secondary frequency band manager 1840, the downlink PPDU manager 1845, and the secondary frequency band manager 1850 may be implemented at least in part by a processor and software in the form of processor-executable code stored in memory.

The wireless communication device 1800 may support wireless communications in accordance with examples as disclosed herein. The primary frequency band manager 1825 is configurable or configured to obtain first information signaling that indicates a primary frequency band. The trigger frame manager 1830 is configurable or configured to obtain one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second wireless node, where the first scheduling information indicates a time resource and a secondary frequency band, where the secondary frequency band does not overlap with the primary frequency band, and where the second scheduling information indicates the time resource and the primary frequency band. The uplink PPDU manager 1835 is configurable or configured to output the first PPDU via the time resource and the secondary frequency band.

In some examples, the first PPDU includes a bandwidth field that indicates the secondary frequency band.

In some examples, the first PPDU includes a bandwidth field that indicates a total bandwidth that includes the primary frequency band and the secondary frequency band.

In some examples, the one or more frames includes a single frame that indicates the first scheduling information and the second scheduling information. In some examples, one or more fields of the single frame indicates that the first PPDU has the first PPDU format.

In some examples, to support obtaining the one or more frames, the trigger frame manager 1830 is configurable or configured to obtain a first frame via the primary frequency band and the secondary frequency band, where the first frame indicates the first scheduling information, and where the first frame includes an indication of a first identifier associated with the first wireless node. In some examples, to support obtaining the one or more frames, the trigger frame manager 1830 is configurable or configured to obtain a second frame via the primary frequency band and the secondary frequency band, where the second frame indicates the second scheduling information, and where the second frame includes an indication of a second identifier associated with the second wireless node.

In some examples, to support obtaining the one or more frames, the trigger frame manager 1830 is configurable or configured to obtain a first frame via the secondary frequency band and a second time resource, where the first frame indicates the first scheduling information, and where the first information signaling includes an indication of the secondary frequency band. In some examples, to support obtaining the one or more frames, the trigger frame manager 1830 is configurable or configured to obtain a second frame via the primary frequency band and the second time resource, where the second frame indicates the second scheduling information.

In some examples, the one or more frames includes a first frame that at least one of: includes a first set of bits in a common information field of the first frame that in combination with a second set of bits in a user information field of the first frame and a physical layer version identifier subfield in a special user info field of the first frame indicate the first PPDU has the first PPDU format, or indicates the first scheduling information.

In some examples, the first set of bits include a common information field bit 54 and a common information field bit 55. In some examples, the second set of bits include a user information field bit 39 or a PS160 field.

In some examples, the one or more frames includes a first frame that includes a set of multiple special user info fields each indicative of a respective PPDU format. In some examples, the set of multiple special user info fields are located after a common information field of the first frame. In some examples, a first special user info field of the set of multiple special user info fields indicates that the first PPDU has the first PPDU format and is followed by a first set of user information fields that indicate stations of associated with the first PPDU format, and the first special user info field is indicative of a first format of the first set of user information fields, and a second special user info field of the set of multiple special user info fields indicates that the second PPDU has the second PPDU format and is followed by a second set of user information fields that indicate stations of associated with the second PPDU format, and the second special user info field is indicative of a second format of the second set of user information fields. In some examples, one or more AID12 field values in the first frame may be indicative of a presence of the set of multiple special user info fields in the first frame. In some examples, the first frame includes at least one of: a quantity of additional special user info fields field which indicates a quantity of special user info fields of the set of multiple special user info fields after a first special user info field; or a total quantity of special user info fields field which indicates a quantify of special user info fields of the plurality of special user info fields in the first frame. In some examples, each special user info field of the set of multiple special user info fields indicates a presence or absence of a subsequent special user info field in the first frame. In some examples, each special user info field of the set of multiple special user info fields includes at least one of: a respective size of each user info field after a current special user info field and before a next special user info field if present or a Padding field if the current special user info field is a last special user info field, or a respective size of the current special user info field.

In some examples, the one or more frames includes a first frame that includes two user info fields indicative of the first PPDU format, each of the two user info fields including five octets and positioned before a trigger dependent user info field, and at least one of: both of the two user info fields include a same value in an AID12 subfield indicative of a same station; a first user info field of the two user info fields carries a first subfield that is not carried in a second user info field of the two user info fields; the second user info field carries a second subfield that is not carried in the first user info field; both of the two user info fields include a same value in a PS160 subfield; both of the two user info fields include a same value in a resource unit allocation subfield indicating the secondary frequency band; or both of the two user info fields include a same value in a spatial stream allocation subfield.

In some examples, the one or more frames include a first frame that includes a set of multiple user info fields, one special user info field of the plurality of user info fields including a physical layer identifier subfield value indicative of the first PPDU format other than a high efficiency or extremely high throughput format, and one or more block octets comprising a B11 value set to 1, and a size of the block octets may be five octets plus a size of a Trigger Dependent User Info subfield if present.

In some examples, the one or more frames includes a first frame that includes a set of multiple user info fields, one user info field of set of multiple user info fields including a physical layer identifier value indicative of the first PPDU format and including an AID12 value set to 4095 or 2007, and user info fields of the set of multiple user info fields subsequent to the one user info field associated with one or more PPDU formats other than an HE or EHT format.

In some examples, the first PPDU format and the second PPDU format are a same PPDU format.

In some examples, the one or more frames includes a first frame. In some examples, the first frame includes a physical layer version identifier field that indicates that the first PPDU has the first PPDU format.

In some examples, the one or more frames includes a first frame. In some examples, the first frame includes a bandwidth field and a bandwidth extension field that in combination indicate to use the secondary frequency band for the first PPDU.

In some examples, the first frame includes a user information field that indicates resource unit for the first PPDU in the secondary frequency band.

In some examples, the one or more frames includes a first frame. In some examples, the first frame includes a bandwidth field and a bandwidth extension field that in combination indicate a bandwidth for the first PPDU. In some examples, the primary frequency band and the secondary frequency band each have the bandwidth. In some examples, the first information signaling indicates for the first wireless node to interpret the bandwidth field in combination with the bandwidth extension field as indicating the secondary frequency band.

In some examples, the one or more frames includes a first frame. In some examples, the first frame includes a bandwidth field and a bandwidth extension field that in combination indicate a bandwidth that includes the primary frequency band and the secondary frequency band. In some examples, the first frame indicates the first scheduling information.

Additionally, or alternatively, the wireless communication device 1800 may support wireless communications in accordance with examples as disclosed herein. The primary and secondary frequency band manager 1840 is configurable or configured to obtain first information signaling that indicates a primary frequency band and that indicates a secondary frequency band, where the secondary frequency band is outside of the primary frequency band. The downlink PPDU manager 1845 is configurable or configured to obtain a first PPDU associated with a first PPDU format via a time resource and the secondary frequency band, where a first preamble of the first PPDU indicates that the first PPDU is intended for the first wireless node. In some examples, the downlink PPDU manager 1845 is configurable or configured to obtain at least a second preamble of a second PPDU associated with a second PPDU format via the time resource and the primary frequency band, where the second preamble indicates that the second PPDU is intended for a second wireless node.

In some examples, a first legacy signal length field in the first preamble indicates a same value as a second legacy signal length field in the second preamble.

In some examples, the first information signaling includes an indication to the first wireless node to refrain from combining legacy signal length fields associated with the primary frequency band and the secondary frequency band. In some examples, the first preamble includes a first legacy signal length field that indicates a first value associated with the first PPDU format. In some examples, the second preamble includes a second legacy signal length field that indicates a second value associated with the second PPDU format.

In some examples, the first PPDU format includes an extremely high-throughput PPDU format, the second PPDU format includes a HE MU PPDU format, a signal field B of the second preamble is associated with a compression mode 1, and the second preamble indicates a quantity of one or more users is equal to one.

In some examples, the first PPDU format includes an extremely high-throughput PPDU format, a universal signal field of the first preamble indicates that a modulation and coding scheme 0 is applicable for a signal field of the first PPDU, the second PPDU format includes a HE MU PPDU format, and a signal field B of the second preamble is associated with a compression mode.

In some examples, the second PPDU format is a HE SU PPDU, the first preamble includes a signal field that spans two symbols, and the signal field includes a first subset of information associated with a universal signal field format associated with an EHT PPDU format.

In some examples, the first information signaling includes an indication of a second subset of information associated with the universal signal field format.

In some examples, the first subset of information omits an identifier field for the first wireless node, the signal field includes three bits that jointly indicate at least one of a quantity of EHT LTF symbols of the first preamble or a quantity of spatial streams associated with the first PPDU, or a physical layer identifier field of the first preamble indicates a non-EHT format for the first PPDU.

In some examples, the first subset of information omits a physical layer identifier field; or the first subset of information omits a punctured channel information subfield.

In some examples, the first subset of information includes at least one of a 2 bit spatial reuse field, a 4 bit punctured channel indication field, or a 4 bit modulation and coding scheme field.

In some examples, a first signal field within the first preamble aligns in time with a second signal field of the second preamble.

In some examples, the first PPDU includes a bandwidth field in the first preamble that indicates the secondary frequency band.

In some examples, the first PPDU includes a bandwidth field in the first preamble that indicates the primary frequency band and the secondary frequency band, or a resource allocation field in the first preamble indicates at least one of an assignment of a resource unit within the secondary frequency band for the first PPDU or that the primary frequency band is punctured for the first PPDU.

FIG. 19 shows a flowchart illustrating an example process 1900 performable by or at a first wireless node that supports communication with DSO. The operations of the process 1900 may be implemented by a first wireless node or its components as described herein. For example, the process 1900 may be performed by a wireless communication device, such as the wireless communication device 1700 described with reference to FIG. 17, operating as or within a wireless AP. In some examples, the process 1900 may be performed by a wireless AP, such as one of the APs 102 described with reference to FIG. 1.

In some examples, in 1905, the first wireless node may output first information signaling that indicates a primary frequency band. The operations of 1905 may be performed in accordance with examples as disclosed herein. In some implementations, aspects of the operations of 1905 may be performed by a primary frequency band manager 1725 as described with reference to FIG. 17.

In some examples, in 1910, the first wireless node may output second information signaling that indicates the primary frequency band. The operations of 1910 may be performed in accordance with examples as disclosed herein. In some implementations, aspects of the operations of 1910 may be performed by a primary frequency band manager 1730 as described with reference to FIG. 17.

In some examples, in 1915, the first wireless node may output one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band. The operations of 1915 may be performed in accordance with examples as disclosed herein. In some implementations, aspects of the operations of 1915 may be performed by a trigger frame manager 1735 as described with reference to FIG. 17.

In some examples, in 1920, the first wireless node may obtain the first PPDU via the time resource and the secondary frequency band. The operations of 1920 may be performed in accordance with examples as disclosed herein. In some implementations, aspects of the operations of 1920 may be performed by an uplink PPDU manager 1740 as described with reference to FIG. 17.

In some examples, in 1925, the first wireless node may obtain the second PPDU via the time resource and the primary frequency band. The operations of 1925 may be performed in accordance with examples as disclosed herein. In some implementations, aspects of the operations of 1925 may be performed by an uplink PPDU manager 1740 as described with reference to FIG. 17.

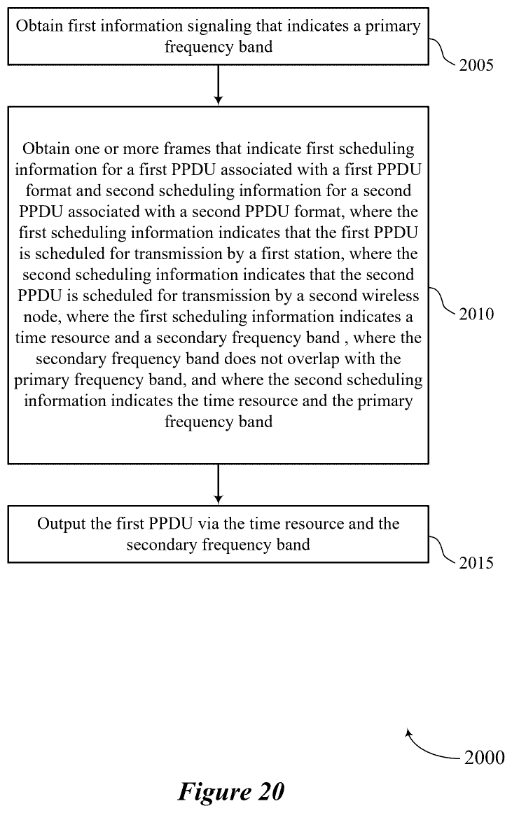

FIG. 20 shows a flowchart illustrating an example process 2000 performable by or at a first wireless node that supports communication with DSO. The operations of the process 2000 may be implemented by a first wireless node or its components as described herein. For example, the process 2000 may be performed by a wireless communication device, such as the wireless communication device 1800 described with reference to FIG. 18, operating as or within a wireless STA. In some examples, the process 2000 may be performed by a wireless STA, such as one of the STAs 104 described with reference to FIG. 1.

In some examples, in 2005, the first wireless node may obtain first information signaling that indicates a primary frequency band. The operations of 2005 may be performed in accordance with examples as disclosed herein. In some implementations, aspects of the operations of 2005 may be performed by a primary frequency band manager 1825 as described with reference to FIG. 18.

In some examples, in 2010, the first wireless node may obtain one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second wireless node, where the first scheduling information indicates a time resource and a secondary frequency band, where the secondary frequency band does not overlap with the primary frequency band, and where the second scheduling information indicates the time resource and the primary frequency band. The operations of 2010 may be performed in accordance with examples as disclosed herein. In some implementations, aspects of the operations of 2010 may be performed by a trigger frame manager 1830 as described with reference to FIG. 18.

In some examples, in 2015, the first wireless node may output the first PPDU via the time resource and the secondary frequency band. The operations of 2015 may be performed in accordance with examples as disclosed herein. In some implementations, aspects of the operations of 2015 may be performed by an uplink PPDU manager 1835 as described with reference to FIG. 18.

FIG. 21 shows a flowchart illustrating an example process 2100 performable by or at a first wireless node that supports communication with DSO. The operations of the process 2100 may be implemented by a first wireless node or its components as described herein. For example, the process 2100 may be performed by a wireless communication device, such as the wireless communication device 1700 described with reference to FIG. 17, operating as or within a wireless AP. In some examples, the process 2100 may be performed by a wireless AP, such as one of the APs 102 described with reference to FIG. 1.

In some examples, in 2105, the first wireless node may output first information signaling that indicates a primary frequency band and that indicates a secondary frequency band, where the secondary frequency band is outside of the primary frequency band. The operations of 2105 may be performed in accordance with examples as disclosed herein. In some implementations, aspects of the operations of 2105 may be performed by a primary and secondary frequency band manager 1745 as described with reference to FIG. 17.

In some examples, in 2110, the first wireless node may output second information signaling that indicates the primary frequency band. The operations of 2110 may be performed in accordance with examples as disclosed herein. In some implementations, aspects of the operations of 2110 may be performed by a primary frequency band manager 1725 as described with reference to FIG. 17.

In some examples, in 2115, the first wireless node may output a first PPDU associated with a first PPDU format via a time resource and the secondary frequency band, where a first preamble of the first PPDU indicates that the first PPDU is intended for a second wireless node. The operations of 2115 may be performed in accordance with examples as disclosed herein. In some implementations, aspects of the operations of 2115 may be performed by a downlink PPDU manager 1750 as described with reference to FIG. 17.

In some examples, in 2120, the first wireless node may output a second PPDU associated with a second PPDU format via the time resource and the primary frequency band, where a second preamble of the second PPDU indicates that the second PPDU is intended for a third wireless node. The operations of 2120 may be performed in accordance with examples as disclosed herein. In some implementations, aspects of the operations of 2120 may be performed by a downlink PPDU manager 1750 as described with reference to FIG. 17.

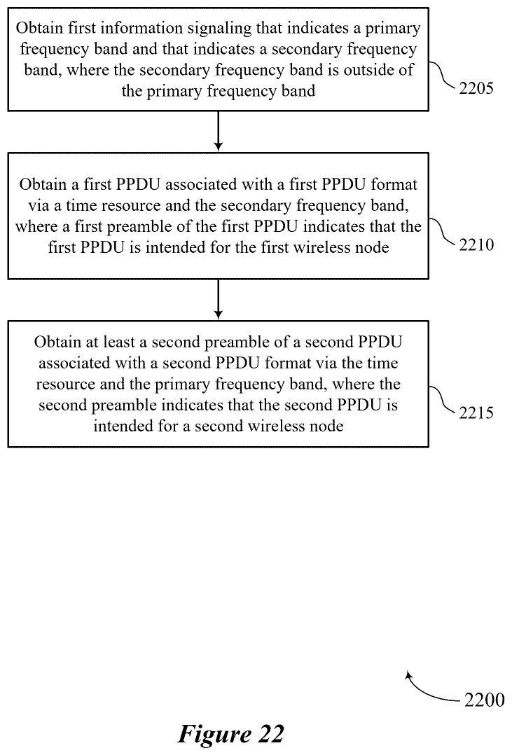

FIG. 22 shows a flowchart illustrating an example process 2200 performable by or at a first wireless node that supports communication with DSO. The operations of the process 2200 may be implemented by a first wireless node or its components as described herein. For example, the process 2200 may be performed by a wireless communication device, such as the wireless communication device 1800 described with reference to FIG. 18, operating as or within a wireless STA. In some examples, the process 2200 may be performed by a wireless STA, such as one of the STAs 104 described with reference to FIG. 1.

In some examples, in 2205, the first wireless node may obtain first information signaling that indicates a primary frequency band and that indicates a secondary frequency band, where the secondary frequency band is outside of the primary frequency band. The operations of 2205 may be performed in accordance with examples as disclosed herein. In some implementations, aspects of the operations of 2205 may be performed by a primary and secondary frequency band manager 1840 as described with reference to FIG. 18.

In some examples, in 2210, the first wireless node may obtain a first PPDU associated with a first PPDU format via a time resource and the secondary frequency band, where a first preamble of the first PPDU indicates that the first PPDU is intended for the first wireless node. The operations of 2210 may be performed in accordance with examples as disclosed herein. In some implementations, aspects of the operations of 2210 may be performed by a downlink PPDU manager 1845 as described with reference to FIG. 18.

In some examples, in 2215, the first wireless node may obtain at least a second preamble of a second PPDU associated with a second PPDU format via the time resource and the primary frequency band, where the second preamble indicates that the second PPDU is intended for a second wireless node. The operations of 2215 may be performed in accordance with examples as disclosed herein. In some implementations, aspects of the operations of 2215 may be performed by a downlink PPDU manager 1845 as described with reference to FIG. 18.

### Implementation Examples are Described in the Following Numbered Clauses:

Aspect 1: A method for wireless communications at a wireless node, including: outputting first information signaling that indicates a primary frequency band; outputting second information signaling that indicates the primary frequency band; outputting one or more frames that indicate first scheduling information for a first PPDU associated with a first PPDU format and second scheduling information for a second PPDU associated with a second PPDU format, where the first scheduling information indicates that the first PPDU is scheduled for transmission by a second wireless node, where the second scheduling information indicates that the second PPDU is scheduled for transmission by a third wireless node, where the first scheduling information indicates a time resource and a secondary frequency band for the first PPDU, where the secondary frequency band does not overlap with the primary frequency band, and where the second scheduling information indicates the time resource and the primary frequency band; obtaining the first PPDU via the time resource and the secondary frequency band; and obtaining the second PPDU via the time resource and the primary frequency band.

Aspect 2: The method of aspect 1, where the first PPDU includes a bandwidth field that indicates the secondary frequency band.

Aspect 3: The method of any of aspects 1-2, where the first PPDU includes a bandwidth field that indicates a total bandwidth that includes the primary frequency band and the secondary frequency band.

Aspect 4: The method of any of aspects 1-3, where the one or more frames includes a single frame that indicates the first scheduling information and the second scheduling information, and one or more fields of the single frame indicates that the first PPDU has the first PPDU format.

Aspect 5: The method of any of aspects 1-4, where at least one of a first frame of the one or more frames is output for transmission via the primary frequency band and the secondary frequency band, the first frame indicates the first scheduling information, and the first frame includes an indication of a first identifier associated with the second wireless node; or a second frame of the one or more frames is output for transmission via the primary frequency band and the secondary frequency band, the second frame indicates the second scheduling information, and the second frame includes an indication of a second identifier associated with the third wireless node.

Aspect 6: The method of any of aspects 1-5, where at least one of a first frame of the one or more frames is output for transmission via the secondary frequency band and a second time resource, the first frame indicates the first scheduling information, and the first information signaling includes an indication of the secondary frequency band; or a second frame of the one or more frames is output for transmission via the primary frequency band and the second time resource, and the second frame indicates the second scheduling information.

Aspect 7: The method of any of aspects 1-6, where the one or more frames includes a first frame that at least one of: includes a first set of bits in a common information field of the first frame that in combination with a second set of bits in a user information field of the first frame and a physical layer version identifier subfield in a special user info field of the first frame indicate the first PPDU has the first PPDU format, or indicates the first scheduling information.

Aspect 8: The method of aspect 7, where the first set of bits include a common information field bit 54 and a common information field bit 55, and the second set of bits include a user information field bit 39 or a PS160 field.

Aspect 9: The method of any of aspects 7-8, where the one or more frames includes a plurality of special user info fields each indicative of a respective PPDU format.

Aspect 10: The method of aspect 9, where the plurality of special user info fields are located after the common information field of the first frame and before other user info fields that are not special user info fields.

Aspect 11: The method of any of aspects 9-10, where a first special user info field of the plurality of special user info fields indicates that the first PPDU has the first PPDU format and is followed by a first set of user information fields that indicate stations associated with the first PPDU format, and the first special user info field is indicative of a first format of the first set of user information fields, and a second special user info field of the plurality of special user info fields indicates that the second PPDU has the second PPDU format and is followed by a second set of user information fields that indicate stations associated with the second PPDU format, and the second special user info field is indicative of a second format of the second set of user information fields.

Aspect 12: The method of any of aspects 1-11, where one or more AID12 field values in a first frame are indicative of a presence of one or more special user info fields of in the first frame.

Aspect 13: The method of any of aspects 1-12, where the one or more frames includes a first frame that includes at least one of: a quantity of additional special user info fields subfield which indicates a quantity of special user info fields of a plurality of special user info fields after a first special user info field, or a quantity of special user info fields subfield which indicates a quantify of special user info fields of the plurality of special user info fields in the first frame.

Aspect 14: The method of any of aspects 1-13, where each special user info field of one or more special user info fields indicates a presence or absence of a subsequent special user info field in a first frame of the one or more frames.

Aspect 15: The method of any of aspects 1-14, where each special user info field of one or more special user info fields includes a respective subfield that indicates at least one of a respective size of each user info field after a current special user info field and before a next special user info field if present or a Padding field if the current special user info field is a last special user info field, or a respective size of the current special user info field.

Aspect 16: The method of any of aspects 1-15, where the one or more frames includes a first frame that includes two user info fields indicative of the first PPDU format, each of the two user info fields including five octets positioned before a trigger dependent user info subfield if present, and where at least one of: both of the two user info fields include a same value in an AID12 subfield indicative of a same station; a first user info field of the two user info fields carries a first subfield that is not carried in a second user info field of the two user info fields; the second user info field carries a second subfield that is not carried in the first user info field; both of the two user info fields include a same value in a PS160 subfield; both of the two user info fields include a same value in a resource unit allocation subfield indicating the secondary frequency band; or both of the two user info fields include a same value in a spatial stream allocation subfield.

Aspect 17: The method of any of aspects 1-16, where the one or more frames includes a first frame that includes a plurality of user info fields, one special user info field of the plurality of user info fields including a physical layer identifier subfield value indicative of the first PPDU format other than a high efficiency or EHT format, and one or more block octets including a B11 value set to 1, a size of block octets may be five octets plus a size of a Trigger Dependent User Info subfield if present.

Aspect 18: The method of any of aspects 1-17, where the one or more frames includes a first frame that includes a plurality of user info fields, one special user info field of the plurality of user info fields including a physical layer identifier subfield value indicative of the first PPDU format and including an AID12 value set to 4095, 2006, 2007, or 2008 and user info fields of the plurality of user info fields subsequent to the one special user info field associated with one or more PPDU formats other than a high efficiency or EHT format.

Aspect 19: The method of any of aspects 1-18, where the first PPDU format and the second PPDU format are a same PPDU format.

Aspect 20: The method of any of aspects 1-19, where the one or more frames includes a first frame, and the first frame includes a physical layer version identifier field that indicates the first PPDU has the first PPDU format.

Aspect 21: The method of any of aspects 1-20, where the one or more frames includes a first frame, and the first frame includes a bandwidth field and a bandwidth extension field that in combination indicate to use the secondary frequency band for the first PPDU.

Aspect 22: The method of aspect 21, where the first frame includes a user information field that indicates a resource unit for the first PPDU in the secondary frequency band.

Aspect 23: The method of any of aspects 1-22, where the one or more frames includes a first frame, the first frame includes a bandwidth field and a bandwidth extension field that in combination indicate a bandwidth for the first PPDU, the primary frequency band and the secondary frequency band each have the bandwidth, and the first information signaling indicates for the second wireless node to interpret the bandwidth field in combination with the bandwidth extension field as indicating the secondary frequency band.

Aspect 24: The method of any of aspects 1-23, where the one or more frames includes a first frame, the first frame includes a bandwidth field and a bandwidth extension field that in combination indicate a bandwidth that includes the primary frequency band and the secondary frequency band, and the first frame indicates the first scheduling information.

Aspect 25: A method for wireless communications at a wireless node, including: obtaining first information signaling that indicates a primary frequency band; obtaining one or more frames that indicate first scheduling information for a first PPDU associated with a first PPDU format and second scheduling information for a second PPDU associated with a second PPDU format, where the first scheduling information indicates that the first PPDU is scheduled for transmission by a first station, where the second scheduling information indicates that the second PPDU is scheduled for transmission by a second apparatus, where the first scheduling information indicates a time resource and a secondary frequency band, where the secondary frequency band does not overlap with the primary frequency band, and where the second scheduling information indicates the time resource and the primary frequency band; and outputting the first PPDU via the time resource and the secondary frequency band.

Aspect 26: The method of aspect 25, where the first PPDU includes a bandwidth field that indicates the secondary frequency band.

Aspect 27: The method of any of aspects 25-26, where the first PPDU includes a bandwidth field that indicates a total bandwidth that includes the primary frequency band and the secondary frequency band.

Aspect 28: The method of any of aspects 25-27, where the one or more frames includes a single frame that indicates the first scheduling information and the second scheduling information, and one or more fields of the single frame indicates that the first PPDU has the first PPDU format.

Aspect 29: The method of any of aspects 25-28, where at least one of a first frame of the one or more frames is obtained via the primary frequency band and the secondary frequency band, the first frame indicates the first scheduling information, and the first frame includes an indication of a first identifier associated with the apparatus; or a second frame of the one or more frames is obtained via the primary frequency band and the secondary frequency band, the second frame indicates the second scheduling information, and the second frame includes an indication of a second identifier associated with the second apparatus.

Aspect 30: The method of any of aspects 25-29, where at least one of a first frame of the one or more frames is obtained via the secondary frequency band and a second time resource, the first frame indicates the first scheduling information, and the first information signaling includes an indication of the secondary frequency band; and a second frame of the one or more frames is obtained via the primary frequency band and the second time resource, and the second frame indicates the second scheduling information.

Aspect 31: The method of any of aspects 25-30, where the one or more frames includes a first frame that at least one of: includes a first set of bits in a common information field of the first frame that in combination with a second set of bits in a user information field of the first frame and a physical layer version identifier of the first frame indicate the first PPDU has the first PPDU format, or indicates the first scheduling information.

Aspect 32: The method of aspect 31, where the first set of bits include a common information field bit 54 and a common information field bit 55, and the second set of bits include a user information field bit 39 or a PS160 field.

Aspect 33: The method of any of aspects 31-32, where the one or more frames includes a plurality of special user info fields each indicative of a respective PPDU format.

Aspect 34: The method of aspect 33, where the plurality of special user info fields are located after the common information field of the first frame and before other user info fields that are not special user info fields.

Aspect 35: The method of any of aspects 33-34, where a first special user info field of the plurality of special user info fields indicates that the first PPDU has the first PPDU format and is followed by a first set of user information fields that indicate stations associated with the first PPDU format, and the first special user info field is indicative of a first format of the first set of user information fields, and a second special user info field of the plurality of special user info fields indicates that the second PPDU has the second PPDU format and is followed by a second set of user information fields that indicate stations associated with the second PPDU format, and the second special user info field is indicative of a second format of the second set of user information fields.

Aspect 36: The method of any of aspects 25-35, where one or more AID12 field values in a first frame are indicative of a presence of one or more special user info fields of in the first frame.

Aspect 37: The method of any of aspects 25-36, where the one or more frames includes a first frame that includes at least one of: a quantity of additional special user info fields subfield which indicates a quantity of special user info fields of a plurality of special user info fields after a first special user info field, or a quantity of special user info fields subfield which indicates a quantify of special user info fields of the plurality of special user info fields in the first frame.

Aspect 38: The method of any of aspects 25-37, where each special user info field of one or more special user info fields indicates a presence or absence of a subsequent special user info field in a first frame of the one or more frames.

Aspect 39: The method of any of aspects 25-38, where each special user info field of one or more special user info fields includes a respective subfield that indicates at least one of a respective size of each user info field after a current special user info field and before a next special user info field if present or a Padding field if the current special user info field is a last special user info field, or a respective size of the current special user info field.

Aspect 40: The method of any of aspects 25-39, where the one or more frames includes a first frame that includes two user info fields indicative of the first PPDU format, each of the two user info fields including five octets and positioned before a trigger dependent user info field, and where at least one of: both of the two user info fields include a same value in an AID12 subfield indicative of a same station; first user info field of the two user info fields carries a first subfield that is not carried in a second user info field of the two user info fields; the second user info field carries a second subfield that is not carried in the first user info field; both of the two user info fields include a same value in a PS160 subfield; both of the two user info fields include a same value in a resource unit allocation subfield indicating the secondary frequency band; or both of the two user info fields include a same value in a spatial stream allocation subfield.

Aspect 41: The method of any of aspects 25-40, where the one or more frames includes a first frame that includes a plurality of user info fields, one special user info field of the plurality of user info fields including a physical layer identifier subfield value indicative of the first PPDU format other than a high efficiency or EHT format, and one or more block octets including a B11 value set to 1, a size of block octets may be five octets plus a size of a Trigger Dependent User Info subfield if present.

Aspect 42: The method of any of aspects 25-41, where the one or more frames includes a first frame that includes a plurality of user info fields, one user info field of the plurality of user info fields including a physical layer identifier value indicative of the first PPDU format and including an AID12 value set to 4095 or 2007, and user info fields of the plurality of user info fields subsequent to the one user info field associated with one or more PPDU formats other than a high efficiency or EHT format.

Aspect 43: The method of any of aspects 25-42, where the first PPDU format and the second PPDU format are a same PPDU format.

Aspect 44: The method of any of aspects 25-43, where the one or more frames includes a first frame, and the first frame includes a physical layer version identifier field that indicates that the first PPDU has the first PPDU format.

Aspect 45: The method of any of aspects 25-44, where the one or more frames includes a first frame, and the first frame includes a bandwidth field and a bandwidth extension field that in combination indicate to use the secondary frequency band for the first PPDU.

Aspect 46: The method of any of aspects 25-45, where the one or more frames includes a first frame, the first frame includes a bandwidth field and a bandwidth extension field that in combination indicate a bandwidth for the first PPDU, the primary frequency band and the secondary frequency band each have the bandwidth, and the first information signaling indicates for the apparatus to interpret the bandwidth field in combination with the bandwidth extension field as indicating the secondary frequency band.

Aspect 47: The method of any of aspects 25-46, where the one or more frames includes a first frame, the first frame includes a bandwidth field and a bandwidth extension field that in combination indicate a bandwidth that includes the primary frequency band and the secondary frequency band, and the first frame indicates the first scheduling information.

Aspect 48: An apparatus for wireless communications, including one or more memories storing processor-executable code, and one or more processors coupled with the one or more memories and individually or collectively operable to execute the code to cause the apparatus to perform a method of any of aspects 1-24.

Aspect 49: An apparatus for wireless communications, including at least one means for performing a method of any of aspects 1-24.

Aspect 50: A wireless node (e.g., an AP), including at least one transceiver; and a processing system that includes processor circuitry and memory circuitry that stores code, the processing system configured to cause the wireless node to perform a method of any of aspects 1-24, where the at least one transceiver is configured to transmit the first information signaling, transmit the second information signaling, transmit the one or more frames, receive the first PPDU, and receive the second PPDU.

Aspect 51: A non-transitory computer-readable medium storing code for wireless communications, the code including instructions executable by one or more processors to perform a method of any of aspects 1-24.

Aspect 52: An apparatus for wireless communications, including one or more memories storing processor-executable code, and one or more processors coupled with the one or more memories and individually or collectively operable to execute the code to cause the apparatus to perform a method of any of aspects 25-47.

Aspect 53: An apparatus for wireless communications, including at least one means for performing a method of any of aspects 25-47.

Aspect 54: A STA, including at least one transceiver; and a processing system that includes processor circuitry and memory circuitry that stores code, the processing system configured to cause the STA to perform a method of any of aspects 25-47, where the at least one transceiver is configured to receive the first information signaling, receive the one or more frames, and transmit the first PPDU.

Aspect 55: A non-transitory computer-readable medium storing code for wireless communications, the code including instructions executable by one or more processors to perform a method of any of aspects 25-47.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
a processing system that includes processor circuitry and memory circuitry that stores code, the processing system configured to cause the apparatus to:
output first information signaling that indicates a primary frequency band;
output second information signaling that indicates the primary frequency band;
output one or more frames that indicate first scheduling information for a first physical layer protocol data unit (PPDU) associated with a first PPDU format and second scheduling information for a second PPDU associated with a second PPDU format, wherein the first scheduling information indicates that the first PPDU is scheduled for transmission by a second wireless node, wherein the second scheduling information indicates that the second PPDU is scheduled for transmission by a third wireless node, wherein the first scheduling information indicates a time resource and a secondary frequency band for the first PPDU, wherein the secondary frequency band does not overlap with the primary frequency band, and wherein the second scheduling information indicates the time resource and the primary frequency band;
obtain the first PPDU via the time resource and the secondary frequency band; and
obtain the second PPDU via the time resource and the primary frequency band.

2. The apparatus of claim 1, wherein at least one of:
the first PPDU comprises a bandwidth field that indicates the secondary frequency band, or
the first PPDU includes a bandwidth field that indicates a total bandwidth that includes the primary frequency band and the secondary frequency band.

3. The apparatus of claim 1, wherein:
the one or more frames comprises a single frame that indicates the first scheduling information and the second scheduling information, and
one or more fields of the single frame indicates that the first PPDU has the first PPDU format.

4. The apparatus of claim 1, wherein at least one of:
a first frame of the one or more frames is output for transmission via the primary frequency band and the secondary frequency band, the first frame indicates the first scheduling information, and the first frame includes an indication of a first identifier associated with the second wireless node; or
a second frame of the one or more frames is output for transmission via the primary frequency band and the secondary frequency band, the second frame indicates the second scheduling information, and the second frame includes an indication of a second identifier associated with the third wireless node.

5. The apparatus of claim 1, wherein at least one of:
a first frame of the one or more frames is output for transmission via the secondary frequency band and a second time resource, the first frame indicates the first scheduling information, and the first information signaling includes an indication of the secondary frequency band; or
a second frame of the one or more frames is output for transmission via the primary frequency band and the second time resource, and the second frame indicates the second scheduling information.

6. The apparatus of claim 1, wherein the one or more frames comprises a first frame that at least one of:
includes a first set of bits in a common information field of the first frame that in combination with a second set of bits in a user information field of the first frame and a physical layer version identifier subfield in a special user info field of the first frame indicate the first PPDU has the first PPDU format, or
indicates the first scheduling information.

7. The apparatus of claim 6, wherein the one or more frames comprises a plurality of special user info fields each indicative of a respective PPDU format, and wherein at least one of:
the plurality of special user info fields are located after the common information field of the first frame and before other user info fields that are not special user info fields; or
a first special user info field of the plurality of special user info fields indicates that the first PPDU has the first PPDU format and is followed by a first set of user information fields that indicate stations associated with the first PPDU format, and the first special user info field is indicative of a first format of the first set of user information fields, and
a second special user info field of the plurality of special user info fields indicates that the second PPDU has the second PPDU format and is followed by a second set of user information fields that indicate stations associated with the second PPDU format, and the second special user info field is indicative of a second format of the second set of user information fields.

8. The apparatus of claim 1, wherein the one or more frames comprises a first frame that includes at least one of:
a quantity of additional special user info fields subfield which indicates a quantity of special user info fields of a plurality of special user info fields after a first special user info field,
a quantity of special user info fields subfield which indicates a quantify of special user info fields of the plurality of special user info fields in the first frame, or
one or more AID12 field values indicative of a presence of one or more special user info fields of in the first frame.

9. The apparatus of claim 1, wherein each special user info field of one or more special user info fields at least one of:
indicates a presence or absence of a subsequent special user info field in a first frame of the one or more frames; or
includes a respective subfield that indicates at least one of:
a respective size of each user info field after a current special user info field and before a next special user info field if present or a Padding field if the current special user info field is a last special user info field, or
a respective size of the current special user info field.

10. The apparatus of claim 1, wherein the one or more frames comprises a first frame that comprises two user info fields indicative of the first PPDU format, each of the two user info fields comprising five octets positioned before a trigger dependent user info subfield if present, and wherein at least one of:
both of the two user info fields include a same value in an AID12 subfield indicative of a same station;
a first user info field of the two user info fields carries a first subfield that is not carried in a second user info field of the two user info fields;
the second user info field carries a second subfield that is not carried in the first user info field;
both of the two user info fields include a same value in a PS160 subfield;
both of the two user info fields include a same value in a resource unit allocation subfield indicating the secondary frequency band; or
both of the two user info fields include a same value in a spatial stream allocation subfield.

11. The apparatus of claim 1, wherein the one or more frames comprises a first frame that comprises a plurality of user info fields, and at least on of:
one special user info field of the plurality of user info fields including a physical layer identifier subfield value indicative of the first PPDU format other than a high efficiency or extremely high throughput format, and one or more block octets comprising a B11 value set to 1, wherein a size of block octets may be five octets plus a size of a Trigger Dependent User Info subfield if present; or
one special user info field of the plurality of user info fields including a physical layer identifier subfield value indicative of the first PPDU format and including an AID12 value set to 4095, 2006, 2007, or 2008 and user info fields of the plurality of user info fields subsequent to the one special user info field associated with one or more PPDU formats other than a high efficiency or extremely high throughput format.

12. The apparatus of claim 1, wherein the first PPDU format and the second PPDU format are a same PPDU format.

13. The apparatus of claim 1, wherein:
the one or more frames comprises a first frame, and at least one of:
the first frame includes a physical layer version identifier field that indicates the first PPDU has the first PPDU format;
the first frame includes a bandwidth field and a bandwidth extension field that in combination indicate to use the secondary frequency band for the first PPDU; or
the first frame includes the bandwidth field and the bandwidth extension field that in combination indicate a bandwidth for the first PPDU,
the primary frequency band and the secondary frequency band each have the bandwidth, and
the first information signaling indicates for the second wireless node to interpret the bandwidth field in combination with the bandwidth extension field as indicating the secondary frequency band.

14. The apparatus of claim 1, wherein:
the one or more frames comprises a first frame,
the first frame includes a bandwidth field and a bandwidth extension field that in combination indicate a bandwidth that comprises the primary frequency band and the secondary frequency band, and
the first frame indicates the first scheduling information.

15. The apparatus of claim 1, further comprising at least one transceiver configured to:
transmit the first information signaling;
transmit the second information signaling;
transmit the one or more frames;
receive the first PPDU; and
receive the second PPDU, wherein the apparatus comprises an access point.

16. An apparatus for wireless communication, comprising:
a processing system that includes processor circuitry and memory circuitry that stores code, the processing system configured to cause the apparatus to:
obtain first information signaling that indicates a primary frequency band;
obtain one or more frames that indicate first scheduling information for a first physical layer protocol data unit (PPDU) associated with a first PPDU format and second scheduling information for a second PPDU associated with a second PPDU format, wherein the first scheduling information indicates that the first PPDU is scheduled for transmission by a first station, wherein the second scheduling information indicates that the second PPDU is scheduled for transmission by a second apparatus, wherein the first scheduling information indicates a time resource and a secondary frequency band, wherein the secondary frequency band does not overlap with the primary frequency band, and wherein the second scheduling information indicates the time resource and the primary frequency band; and
output the first PPDU via the time resource and the secondary frequency band.

17. The apparatus of claim 16, wherein at least one of:
the first PPDU comprises a bandwidth field that indicates the secondary frequency band, or
the first PPDU includes a bandwidth field that indicates a total bandwidth that includes the primary frequency band and the secondary frequency band.

18. The apparatus of claim 16, wherein:
the one or more frames comprises a single frame that indicates the first scheduling information and the second scheduling information, and
one or more fields of the single frame indicates that the first PPDU has the first PPDU format.

19. The apparatus of claim 16, wherein at least one of:
a first frame of the one or more frames is obtained via the primary frequency band and the secondary frequency band, the first frame indicates the first scheduling information, and the first frame includes an indication of a first identifier associated with the apparatus; or
a second frame of the one or more frames is obtained via the primary frequency band and the secondary frequency band, the second frame indicates the second scheduling information, and the second frame includes an indication of a second identifier associated with the second apparatus.

20. The apparatus of claim 16, wherein at least one of:
a first frame of the one or more frames is obtained via the secondary frequency band and a second time resource, the first frame indicates the first scheduling information, and the first information signaling includes an indication of the secondary frequency band; or
a second frame of the one or more frames is obtained via the primary frequency band and the second time resource, and the second frame indicates the second scheduling information.

21. The apparatus of claim 16, wherein the one or more frames comprises a first frame that at least one of:
includes a first set of bits in a common information field of the first frame that in combination with a second set of bits in a user information field of the first frame and a physical layer version identifier of the first frame indicate the first PPDU has the first PPDU format, or
indicates the first scheduling information.

22. The apparatus of claim 21, wherein the one or more frames comprises a plurality of special user info fields each indicative of a respective PPDU format, and wherein at least one of:
the plurality of special user info fields are located after the common information field of the first frame and before other user info fields that are not special user info fields; or
a first special user info field of the plurality of special user info fields indicates that the first PPDU has the first PPDU format and is followed by a first set of user information fields that indicate stations associated with the first PPDU format, and the first special user info field is indicative of a first format of the first set of user information fields, and
a second special user info field of the plurality of special user info fields indicates that the second PPDU has the second PPDU format and is followed by a second set of user information fields that indicate stations associated with the second PPDU format, and the second special user info field is indicative of a second format of the second set of user information fields.

23. The apparatus of claim 16, wherein the one or more frames comprises a first frame that includes at least one of:
a quantity of additional special user info fields subfield which indicates a quantity of special user info fields of a plurality of special user info fields after a first special user info field,
a quantity of special user info fields subfield which indicates a quantify of special user info fields of the plurality of special user info fields in the first frame, or
one or more AID12 field values indicative of a presence of one or more special user info fields of in the first frame.

24. The apparatus of claim 16, wherein each special user info field of one or more special user info fields at least one of:
indicates a presence or absence of a subsequent special user info field in a first frame of the one or more frames; or
includes a respective subfield that indicates at least one of:
a respective size of each user info field after a current special user info field and before a next special user info field if present or a Padding field if the current special user info field is a last special user info field, or
a respective size of the current special user info field.

25. The apparatus of claim 16, wherein the one or more frames comprises a first frame that comprises two user info fields indicative of the first PPDU format, each of the two user info fields comprising five octets and positioned before a trigger dependent user info field, and wherein at least one of:
both of the two user info fields include a same value in an AID12 subfield indicative of a same station;
first user info field of the two user info fields carries a first subfield that is not carried in a second user info field of the two user info fields;
the second user info field carries a second subfield that is not carried in the first user info field;
both of the two user info fields include a same value in a PS160 subfield;
both of the two user info fields include a same value in a resource unit allocation subfield indicating the secondary frequency band; or
both of the two user info fields include a same value in a spatial stream allocation subfield.

26. The apparatus of claim 16, wherein the one or more frames comprises a first frame that comprises a plurality of user info fields, and at least one of:
one special user info field of the plurality of user info fields including a physical layer identifier subfield value indicative of the first PPDU format other than a high efficiency or extremely high throughput format, and one or more block octets including a B11 value set to 1, wherein a size of block octets may be five octets plus a size of a Trigger Dependent User Info subfield if present, or
one user info field of the plurality of user info fields including a physical layer identifier value indicative of the first PPDU format and including an AID12 value set to 4095 or 2007, and user info fields of the plurality of user info fields subsequent to the one user info field associated with one or more PPDU formats other than a high efficiency or extremely high throughput format.

27. The apparatus of claim 16, wherein:
the one or more frames comprises a first frame, and at least one of:
the first frame includes a physical layer version identifier field that indicates that the first PPDU has the first PPDU format;
the first frame includes a bandwidth field and a bandwidth extension field that in combination indicate to use the secondary frequency band for the first PPDU; or
the first frame includes the bandwidth field and the bandwidth extension field that in combination indicate a bandwidth for the first PPDU,
the primary frequency band and the secondary frequency band each have the bandwidth, and
the first information signaling indicates for the apparatus to interpret the bandwidth field in combination with the bandwidth extension field as indicating the secondary frequency band.

28. The apparatus of claim 16, wherein:
the one or more frames comprises a first frame,
the first frame includes a bandwidth field and a bandwidth extension field that in combination indicate a bandwidth that comprises the primary frequency band and the secondary frequency band, and
the first frame indicates the first scheduling information.

29. The apparatus of claim 16, further comprising at least one transceiver configured to:
receive the first information signaling;
receive the one or more frames; and
transmit the first PPDU, wherein the apparatus comprises a station.

30. A method for wireless communications at a wireless node, comprising:
obtaining first information signaling that indicates a primary frequency band;
obtaining one or more frames that indicate first scheduling information for a first physical layer protocol data unit (PPDU) associated with a first PPDU format and second scheduling information for a second PPDU associated with a second PPDU format, wherein the first scheduling information indicates that the first PPDU is scheduled for transmission by a first station, wherein the second scheduling information indicates that the second PPDU is scheduled for transmission by a second wireless node, wherein the first scheduling information indicates a time resource and a secondary frequency band, wherein the secondary frequency band does not overlap with the primary frequency band, and wherein the second scheduling information indicates the time resource and the primary frequency band; and
outputting the first PPDU via the time resource and the secondary frequency band.
